(19) United States
(12) Patent Application Publication
(10) Pub. No.: US 2026/0126357 A1
(43) Pub. Date: May 7, 2026

(54) FILTRATION SAMPLING DEVICES

(71) Applicant: HERO SCIENTIFIC LTD., Jerusalem (IL)

(72) Inventors: Robert Eric LEVITZ, Beit Shemesh (IL); Zvi FELDMAN, Sde Zvi (IL)

(73) Assignee: HERO SCIENTIFIC LTD., Jerusalem (IL)

(21) Appl. No.: 19/439,551

(22) Filed: Jan. 5, 2026

Related U.S. Application Data
(63) Continuation of application No. PCT/IL2024/050679, filed on Jul. 11, 2024.
Application No. PCT/IL2024/050679 is a continuation-in-part of application No. PCT/IL2023/050728, filed on Jul. 12, 2023.
(63) Continuation-in-part of application No. 19/012,335, filed on Jan. 7, 2025.
Application No. 19/012,335 is a continuation of application No. PCT/IL2023/050728, filed on Jul. 12, 2023.
(60) Provisional application No. 63/388,851, filed on Jul. 13, 2022.
(60) Provisional application No. 63/432,231, filed on Dec. 13, 2022.
(60) Provisional application No. 63/621,875, filed on Jan. 17, 2024.

(51) Int. Cl. G01N 1/40

(52) U.S. Cl. CPC G01N 1/4077; G01N 2001/4088

(57) ABSTRACT

A sampling device (2220F, 2620, 2720) is provided for concentrating a liquid specimen sample (22), including a filtration assembly (2224F, 2624, 2724) which includes a tubular container (1630, 2030), a filter (60), a filter support (1662, 2362), and an inflatable chamber (2700). The filter support (1662, 2362) defines a support surface on which the filter (60) is removably disposed. The inflatable chamber (2700) includes a flexible wall (2702). An interior of the inflatable chamber (2700) is shaped so as to define a space (2733) having an initial volume. A source of gas (2204) is configured to provide gas (2208) into the space (2733). The filtration assembly (2224F, 2624, 2724) is configured such that providing of the gas (2208) into the space (2733), when the liquid specimen sample (22) is contained in the tubular container (1630, 2030) and the filter (60) is disposed on the support surface, increases the initial volume to an inflated volume, so as to push at least a portion of the liquid specimen sample (22) through the filter (60). Other embodiments are also described.

### CROSS-REFERENCE TO RELATED APPLICATIONS

The present application:
(i) is a continuation of International Application PCT/IL2024/050679, filed Jul. 11, 2024, which published as PCT Publication WO 2025/012908 to Feldman et al., which (a) claims the benefit of U.S. Provisional Application 63/621,875, filed Jan. 17, 2024, and (b) claims priority from and is a continuation-in-part of International Application PCT/IL2023/050728, filed Jul. 12, 2023, which published as PCT Publication WO 2024/013747 to Feldman et al., and
(ii) is a continuation-in-part (CIP) of U.S. application Ser. No. 19/012,335, filed Jan. 7, 2025, which published as US Patent Application Publication 2025/0144616 to Feldman et al., which is a continuation of International Application PCT/IL2023/050728, filed Jul. 12, 2023, which published as PCT Publication WO 2024/013747 to Feldman et al.; International Application PCT/IL2023/050728, filed Jul. 12, 2023, claims the benefit of US Provisional Application 63/388,851, filed Jul. 13, 2022, and U.S. Provisional Application 63/432,231, filed Dec. 13, 2022.

All of the above-mentioned applications are assigned to the assignee of the present application and incorporated herein by reference.

### FIELD OF THE APPLICATION

Applications of the present invention relate to sampling biological liquids.

### BACKGROUND OF THE APPLICATION

Many techniques exist for testing for the presence of bacteria and viruses for aiding in disease diagnosis. For example, testing for the influenza virus includes molecular-based detection methods, viral culture methods, and immunoassay methods. Influenza virus testing includes the testing of nasal swabs, nasopharyngeal swabs, nasal aspirates, nasopharyngeal aspirates, nasal washes, nasopharyngeal washes, throat swabs, and a combination of samples.

PCT Publication WO 2018/158768 to Fruchter et al. describes inter alia a method for testing for presence of a particulate selected from the group consisting of: a microorganism, a fungus, a bacteria, a spore, a virus, a mite, a biological cell, a biological antigen, a protein, a protein antigen, and a carbohydrate antigen. The method includes (a) collecting, in a tube, fluid that potentially contains the particulate, (b) using a plunger to push the fluid through a filter removably disposed at a distal portion of the tube or at a distal end of the plunger, and subsequently, (c) while the filter is inside the tube, ascertaining if any of the particulate was trapped by the filter by applying a particulate-presence-testing-facilitation solution to the filter.

PCT Publication WO 2022/149135 to Feldman et al. describes inter alia a sampling device for concentrating a liquid specimen sample, including a filtration assembly, which includes a tubular container and a plunger. The plunger includes a plunger head and a plunger rod that is shaped so as to define an internal plunger space having a plunger-space proximal opening through a proximal end of the plunger rod. The sampling device is configured such that a filter is removable from the tubular container via the plunger-space proximal opening while the plunger head is within the tubular container.

PCT Publication WO 2023/131948 to Levitz et al., which is incorporated herein by reference, described inter alia a kit that includes an extraction tube or a transport tube; a filter; a liquid for bathing the filter within the tube; and a filter shaft. The filter shaft includes a distal portion that is coupled to a central portion of the filter. The filter shaft is configured to insert the filter into the tube for bathing the filter in the liquid.

PCT Publication WO 2024/013747 to Feldman et al., which is incorporated herein by reference, describes inter alia a filtration assembly that includes a tubular container shaped so as to define a proximal container opening for receiving a liquid specimen sample. A plunger includes a plunger head and a plunger rod, and is insertable into the tubular container via the proximal container opening. A filter support is shaped so as to define a support surface on which a filter is removably disposed, and a plurality of filtrate-passage openings through the filter support into a waste liquid receptacle. The filtration assembly is configured such that release of energy from a pre-loaded energy storage element, when the liquid specimen sample is contained in the tubular container and the filter is disposed on the support surface, pushes at least a portion of the liquid specimen sample through the filter and the filtrate-passage openings and into the waste liquid receptacle.

US Patent Application Publication 2011/0318814 to Kshirsagar et al. describes inter alia a method for isolating microorganisms from a sample, the sample including sample matrix and microorganisms, the method including the steps of providing a receptacle, the receptacle configured to allow filtering of the sample and to reversibly contain the sample and a concentration agent; adding the sample to the receptacle, wherein a microorganism-bound composition will be formed in the receptacle, the microorganism-bound composition including concentration agent-bound microorganisms and sample matrix; and filtering the microorganism-bound composition through a filter to collect the concentration agent-bound microorganisms on the filter. The filter has an average pore size that is greater than the average size of the microorganisms. Kits and systems are also described.

U.S. Pat. No. 5,077,012 to Guirguis describes an apparatus for collecting biological fluids and holding samples taken from a biological fluid for qualitative and quantitative testing. The apparatus comprises a tubular container open at both ends with a quantitative test storage unit removably secured to one of said tubular container ends. The quantitative test storage unit has an open end, a cytology membrane mounted in the storage unit and a retaining rib. A shuttle assembly is slidably mounted in the tubular container comprising a cylindrical hollow piston defining a chamber, a thumb cover covering one end of the piston and a fluid flow aperture formed in the piston and a qualitative sample container assembly removable secured to the piston. The qualitative sample container assembly comprises a clip on membrane assembly including a membrane containing immobilized antibodies and a filter housing mounted to the clip on membrane assembly. The filter housing is adapted to be seated in the quantitative test storage unit after being slidably transported along the tubular container by the piston.

### SUMMARY OF THE APPLICATION

Some applications of the present invention provide sampling devices for concentrating a liquid specimen sample. Some of the sampling devices comprise a filtration assembly, which comprises a tubular container for receiving the liquid specimen sample, a plunger, and a filter disposed in the tubular container. The filtration assembly is configured such that movement of a plunger head within the tubular container, when the liquid specimen sample is contained in the tubular container and the filter is disposed in the tubular container, pushes at least a portion of the liquid specimen sample through the filter.

In some configurations, the sampling devices comprise a source of gas, configured to provide gas into a space defined within the filtration assembly. The filtration assembly is configured such that providing of the gas into the space, when the liquid specimen sample is contained in the tubular container and the filter is disposed on the support surface, pushes at least a portion of the liquid specimen sample through the filter and the filtrate-passage openings and into a waste liquid receptacle of the filtration assembly. Typically, the filtration assembly is configured to limit a pressure within the space to a pre-configured maximum pressure.

Limiting the pressure may be beneficial if the filter becomes overly clogged during an early portion of the filtration, such as if the liquid specimen sample is more viscous than typical samples. For example, for applications in which the liquid specimen sample is gargled fluid, the sample may include more mucus than typical gargled fluid samples. If the filter becomes overly clogged during the early portion of the filtration, the pressure within the space may exceed desired values, because the gas builds up as the source of gas continuously provides more gas into the space, and the gas has reduced ability to push the at least a portion of the liquid specimen sample through the filter and the filtrate-passage openings and into the waste liquid receptacle. The excessive pressure may undesirably force the liquid specimen sample through the clogged filter (e.g., exceeding the operating pressure of the filter), resulting in tearing of the filter and/or an increased rate of undesired passage of biological particulate through the filter, rather than the filter trapping the biological particulate. The limiting of the pressure within the space by the pressure-responsive valve prevents the pressure within the space from increasing undesirably, thereby solving this problem.

For some applications, the source of gas comprises a substance that releases gas when combined with a liquid, while in others of these applications, the source of gas comprises a compressed gas container.

There is therefore provided, in accordance with an Inventive Concept 1 of the present invention, a sampling device for concentrating a liquid specimen sample, the sampling device including a filtration assembly, which includes:
a tubular container, which is shaped so as to define an inner wall and a proximal container opening for receiving the liquid specimen sample;
a waste liquid receptacle;
a filter;
a filter support, which is shaped so as to define (a) a support surface on which the filter is removably disposed, and (b) a plurality of filtrate-passage openings through the filter support into the waste liquid receptacle;
an inflatable chamber, which includes a flexible wall, wherein an interior of the inflatable chamber is shaped so as to define a space having an initial volume; and
a source of gas, configured to provide gas into the space defined by the interior of the inflatable chamber,
wherein the filtration assembly is configured such that providing of the gas into the space, when the liquid specimen sample is contained in the tubular container and the filter is disposed on the support surface, increases the initial volume to an inflated volume, so as to push at least a portion of the liquid specimen sample through the filter and the filtrate-passage openings and into the waste liquid receptacle.

Inventive Concept 2. The sampling device according to Inventive Concept 1, wherein the source of gas includes one or more substances that generate the gas.

Inventive Concept 3. The sampling device according to Inventive Concept 1, wherein the source of gas includes a compressed gas container containing the gas.

Inventive Concept 4. The sampling device according to Inventive Concept 1, wherein the source of gas is configured to provide the gas upon manual activation of the source of gas.

Inventive Concept 5. The sampling device according to Inventive Concept 4, wherein the filtration assembly includes a user control, which is configured, upon actuation thereof, to manually activate the source of gas to provide the gas.

Inventive Concept 6. The sampling device according to Inventive Concept 1, wherein the providing of the gas into the space expands the inflatable chamber toward the filter.

Inventive Concept 7. The sampling device according to Inventive Concept 6, wherein the providing of the gas into the space expands the inflatable chamber into contact with the filter.

Inventive Concept 8. The sampling device according to Inventive Concept 6, wherein the inflatable chamber, when the space has the initial volume, is disposed away from the filter.

Inventive Concept 9. The sampling device according to Inventive Concept 1, wherein the providing of the gas into the space increases an area of contact between the inflatable chamber and the filter.

Inventive Concept 10. The sampling device according to any one of Inventive Concepts 1-9,
wherein an internal distal bottom surface of the tubular container includes the filter support, and
wherein the providing of the gas into the space expands the inflatable chamber when the inflatable chamber is disposed at least partially in the tubular container.

Inventive Concept 11. The sampling device according to Inventive Concept 10,
wherein the filtration assembly further includes a proximal cap, which is configured to sealably close the proximal container opening, and
wherein the inflatable chamber is coupled to the proximal cap, such that the inflatable chamber is disposed at least partially in the tubular container when the proximal cap sealably closes the proximal container opening.

Inventive Concept 12. The sampling device according to any one of Inventive Concepts 1-9,
wherein the filtration assembly further includes a proximal cap, which is configured to sealably close the proximal container opening,
wherein the proximal cap is shaped so as to define the waste liquid receptacle within the proximal cap,
wherein the proximal cap includes the filter support, and
wherein the inflatable chamber is disposed at least partially in the tubular container.

Inventive Concept 13. The sampling device according to any one of Inventive Concepts 1-9,
wherein the filtration assembly further includes a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container,
wherein the plunger rod is shaped so as to define the waste liquid receptacle within the plunger rod,
wherein the plunger head includes the filter support,
wherein the sampling device further includes a container housing,
wherein the tubular container is disposed at least partially within the container housing, such that the tubular container is moveable with respect to the container housing,
wherein the inflatable chamber is disposed between (a) a proximally-facing internal surface of the container housing and (b) an external surface of the tubular container that is defined by a distal end of the tubular container, and
wherein the filtration assembly is configured such that the providing of the gas into the space increases the initial volume to the inflated volume, thereby proximally moving the tubular container with respect to the plunger head, thereby pushing the at least a portion of the liquid specimen sample through the filter and the filtrate-passage openings and into the waste liquid receptacle.

Inventive Concept 14. The sampling device according to any one of Inventive Concepts 1-9, wherein the filtration assembly includes one or more sharp surfaces, which are positioned to puncture the inflatable chamber upon the space increasing to the inflated volume.

Inventive Concept 15. The sampling device according to any one of Inventive Concepts 1-9, wherein the filtration assembly further includes a pressure-responsive valve that is configured to limit a pressure within the space.

Inventive Concept 16. The sampling device according to Inventive Concept 15, wherein the pressure-responsive valve is configured to limit the pressure in the space by blocking flow of the gas into the space responsively to the pressure in the space.

Inventive Concept 17. The sampling device according to Inventive Concept 16,
wherein the filtration assembly is shaped so as to define a gas-release regulation chamber, which is in fluid communication with the space only by one or more openings,
wherein the source of gas is disposed in fluid communication with the gas-release regulation chamber, and
wherein the pressure-responsive valve is configured to block the flow of the gas into the space by blocking the one or more openings.

Inventive Concept 18. The sampling device according to Inventive Concept 16,
wherein the source of gas includes a compressed gas container containing the gas and defining an opening in fluid communication with the space, and
wherein the pressure-responsive valve is configured to block the flow of the gas into the space by blocking the opening.

Inventive Concept 19. The sampling device according to Inventive Concept 15, wherein the pressure-responsive valve includes a pressure relief valve, which is configured to release a portion of the gas from the space when the pressure within the space exceeds a threshold pressure.

Inventive Concept 20. The sampling device according to Inventive Concept 19, wherein the pressure relief valve is located so as to release the portion of the gas from the space to the atmosphere outside the filtration assembly when the pressure within the space exceeds the threshold pressure.

There is further provided, in accordance with an Inventive Concept 21 of the present invention, a method for concentrating a liquid specimen sample, the method including:
placing, via a proximal container opening, the liquid specimen sample in a tubular container of a filtration assembly of a sampling device, wherein the filtration assembly further includes an inflatable chamber, which includes a flexible wall, wherein an interior of the inflatable chamber is shaped so as to define a space having an initial volume; and
causing a source of gas of the filtration assembly to provide gas into the space defined by the interior of the inflatable chamber, so as to increase the initial volume to an inflated volume, so as to push at least a portion of the liquid specimen sample through a filter removably disposed in the tubular container on a support surface of a filter support, wherein the filter support is shaped so as to define a plurality of filtrate-passage openings through the filter support into a waste liquid receptacle of the filtration assembly.

Inventive Concept 22. The method according to Inventive Concept 21, wherein the source of gas includes one or more substances that generate the gas.

Inventive Concept 23. The method according to Inventive Concept 21, wherein the source of gas includes a compressed gas container containing the gas.

Inventive Concept 24. The method according to Inventive Concept 21, wherein causing the source of gas to provide the gas includes manually activating the source of gas.

Inventive Concept 25. The method according to Inventive Concept 24, wherein the filtration assembly includes a user control, and wherein manually activating the source of gas includes actuating the user control.

Inventive Concept 26. The method according to Inventive Concept 21, wherein causing the source of gas to provide the gas into the space expands the inflatable chamber toward the filter.

Inventive Concept 27. The method according to Inventive Concept 26, wherein causing the source of gas to provide the gas into the space expands the inflatable chamber into contact with the filter.

Inventive Concept 28. The method according to Inventive Concept 26, wherein the inflatable chamber, when the space has the initial volume, is disposed away from the filter.

Inventive Concept 29. The method according to Inventive Concept 21, wherein causing the source of gas to provide the gas into the space increases an area of contact between the inflatable chamber and the filter.

Inventive Concept 30. The method according to any one of Inventive Concepts 21-29,
wherein an internal distal bottom surface of the tubular container includes the filter support, and
wherein causing the source of gas to provide the gas into the space includes disposing the inflatable chamber at least partially in the tubular container.

Inventive Concept 31. The method according to Inventive Concept 30,
wherein the inflatable chamber is coupled to a proximal cap of the filtration assembly, and
wherein the method further includes sealably closing the proximal container opening with the proximal cap, such that the inflatable chamber is disposed at least partially in the tubular container.

Inventive Concept 32. The method according to any one of Inventive Concepts 21-29,
further including sealably closing the proximal container opening with a proximal cap of the filtration assembly,
wherein the proximal cap is shaped so as to define the waste liquid receptacle within the proximal cap,
wherein the proximal cap includes the filter support, and
wherein the inflatable chamber is disposed at least partially in the tubular container.

Inventive Concept 33. The method according to any one of Inventive Concepts 21-29,
further including inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further includes a plunger rod, which (a) has a distal end portion to which the plunger head is coupled, and (b) is shaped so as to define the waste liquid receptacle within the plunger rod,
wherein the plunger head includes the filter support,
wherein the sampling device further includes a container housing,
wherein the tubular container is disposed at least partially within the container housing, such that the tubular container is moveable with respect to the container housing,
wherein the inflatable chamber is disposed between (a) a proximally-facing internal surface of the container housing and (b) an external surface of the tubular container that is defined by a distal end of the tubular container, and
wherein causing the source of gas to provide the gas into the space increases the initial volume to the inflated volume, thereby proximally moving the tubular container with respect to the plunger head, thereby pushing the at least a portion of the liquid specimen sample through the filter and the filtrate-passage openings and into the waste liquid receptacle.

Inventive Concept 34. The method according to any one of Inventive Concepts 21-29, wherein the filtration assembly includes one or more sharp surfaces, which are positioned to puncture the inflatable chamber upon the space increasing to the inflated volume.

Inventive Concept 35. The method according to any one of Inventive Concepts 21-29, wherein the filtration assembly further includes a pressure-responsive valve that is configured to limit a pressure within the space.

Inventive Concept 36. The method according to Inventive Concept 35, wherein the pressure-responsive valve is configured to limit the pressure in the space by blocking flow of the gas into the space responsively to the pressure in the space.

Inventive Concept 37. The method according to Inventive Concept 36,
wherein the filtration assembly is shaped so as to define a gas-release regulation chamber, which is in fluid communication with the space only by one or more openings,
wherein the source of gas is disposed in fluid communication with the gas-release regulation chamber, and
wherein the pressure-responsive valve is configured to block the flow of the gas into the space by blocking the one or more openings.

Inventive Concept 38. The method according to Inventive Concept 36,
wherein the source of gas includes a compressed gas container containing the gas and defining an opening in fluid communication with the space, and
wherein the pressure-responsive valve is configured to block the flow of the gas into the space by blocking the opening.

Inventive Concept 39. The method according to Inventive Concept 35, wherein the pressure-responsive valve includes a pressure relief valve, which is configured to release a portion of the gas from the space when the pressure within the space exceeds a threshold pressure.

Inventive Concept 40. The method according to Inventive Concept 39, wherein the pressure relief valve is located so as to release the portion of the gas from the space to the atmosphere outside the filtration assembly when the pressure within the space exceeds the threshold pressure.

Inventive Concept 41. The method according to any one of Inventive Concepts 21-29, further including, after the filter has been removed from the tubular container, detecting the presence of a biological particulate trapped by the filter.

Inventive Concept 42. The method according to Inventive Concept 41, wherein detecting the presence of the biological particulate trapped by the filter including using a lateral flow test strip to detect the presence of the biological particulate trapped by the filter.

Inventive Concept 43. The method according to Inventive Concept 41, wherein the biological particulate is selected from the group consisting of: a virus, a bacterium, a microorganism, a fungus, a spore, a mite, a biological cell, a biological antigen, a protein, a protein antigen, and a carbohydrate antigen.

Inventive Concept 44. The method according to any one of Inventive Concepts 21-29, wherein the liquid specimen sample includes gargled fluid.

There is still further provided, in accordance with an Inventive Concept 45 of the present invention, a sampling device for concentrating a liquid specimen sample, the sampling device including a filtration assembly, which includes:
a tubular container, which is shaped so as to define an inner wall and a proximal container opening for receiving the liquid specimen sample;
a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container;
a waste liquid receptacle;
a filter;
a filter support, which is shaped so as to define (a) a support surface on which the filter is removably disposed, and (b) a plurality of filtrate-passage openings through the filter support into the waste liquid receptacle;
a container housing; and
a plunger support, which is (a) coupled to a proximal portion of the plunger, and (b) hingedly attached to the container, so as to enable a change in orientation between a central longitudinal axis of the plunger and a central longitudinal axis of the container housing,
wherein the plunger, the plunger support, and the container housing are arranged such that the change in orientation transitions the proximal container opening from an open position to a closed position, in which the plunger head covers the proximal container opening.

Inventive Concept 46. The sampling device according to Inventive Concept 45,
wherein the plunger rod is shaped so as to define the waste liquid receptacle within the plunger rod, and
wherein the plunger head includes the filter support.

Inventive Concept 47. The sampling device according to Inventive Concept 46,
wherein the tubular container is disposed at least partially within the container housing, such that the tubular container is moveable with respect to the container housing, and
wherein the filtration assembly is configured such that the tubular container is proximally moveable with respect to the plunger head, thereby pushing at least a portion of the liquid specimen sample through the filter and the filtrate-passage openings and into the waste liquid receptacle.

Inventive Concept 48. The sampling device according to Inventive Concept 47,
wherein the sampling device further includes a source of gas, which is configured to provide gas into a space by releasing or generating the gas, the space defined between (a) a proximally-facing internal surface of the container housing and (b) an external surface of the tubular container that is defined by a distal end of the tubular container, and
wherein the filtration assembly is configured such that providing the gas into the space increases pressure in the space, thereby proximally moving the tubular container with respect to the plunger head.

Inventive Concept 49. The sampling device according to Inventive Concept 45, wherein an internal distal bottom surface of the tubular container includes the filter support.

Inventive Concept 50. The sampling device according to Inventive Concept 49,
wherein the container housing includes the tubular container, and
wherein the plunger includes a plunger tube, in which the plunger rod is at least partially disposed so as to be axially moveable with respect to the plunger tube.

There is additionally provided, in accordance with an Inventive Concept 51 of the present invention, a method for concentrating a liquid specimen sample, the method including:
placing, via a proximal container opening while the proximal container opening is in an open position, the liquid specimen sample in a tubular container of a filtration assembly of a sampling device, wherein the sampling device further includes (i) a container housing, (ii) a waste liquid receptacle, (iii) a filter, and (iv) a filter support, which is shaped so as to define (a) a support surface on which the filter is removably disposed, and (b) a plurality of filtrate-passage openings through the filter support into the waste liquid receptacle;
thereafter, transitioning the proximal container opening from the open position to a closed position, in which a plunger head of a plunger of the filtration assembly covers the proximal container opening and a lateral surface of the plunger head forms a fluid-tight movable seal with an inner wall of the tubular container, wherein the plunger further includes a plunger rod, which has a distal end portion to which the plunger head is coupled; and
pushing at least a portion of the liquid specimen sample through the filter and the filtrate-passage openings and into the waste liquid receptacle,
wherein transitioning includes changing an orientation between a central longitudinal axis of the plunger and a central longitudinal axis of the container housing by moving a plunger support, which is (a) coupled to a proximal portion of the plunger, and (b) hingedly attached to the container so as to enable the change in the orientation.

Inventive Concept 52. The method according to Inventive Concept 51,
wherein the plunger rod is shaped so as to define the waste liquid receptacle within the plunger rod, and
wherein the plunger head includes the filter support.

Inventive Concept 53. The method according to Inventive Concept 52,
wherein the tubular container is disposed at least partially within the container housing, such that the tubular container is moveable with respect to the container housing, and
wherein pushing at least a portion of the liquid specimen sample through the filter includes proximally moving the tubular container with respect to the plunger head.

Inventive Concept 54. The method according to Inventive Concept 53,
wherein the sampling device further includes a source of gas, which is configured to provide gas into a space by releasing or generating the gas, the space defined between (a) a proximally-facing internal surface of the container housing and (b) an external surface of the tubular container that is defined by a distal end of the tubular container, and
wherein proximally moving the tubular container with respect to the plunger head includes causing the source of gas to provide the gas into the space to as to increases pressure in the space.

Inventive Concept 55. The method according to Inventive Concept 51, wherein an internal distal bottom surface of the tubular container includes the filter support.

Inventive Concept 56. The method according to Inventive Concept 55,
wherein the container housing includes the tubular container, and
wherein the plunger includes a plunger tube, in which the plunger rod is at least partially disposed so as to be axially moveable with respect to the plunger tube.

There is yet additionally provided, in accordance with an Inventive Concept 57 of the present invention, a sampling device for concentrating a liquid specimen sample, the sampling device including a filtration assembly, which includes:
a container housing, which (a) is shaped so as to define one or more first threads, and (b) includes a tubular container, which is shaped so as to define an inner wall and a proximal container opening for receiving the liquid specimen sample;
a plunger support, which is shaped so as to define one or more second threads, shaped so as to engage the one or more first threads;
a plunger, which (a) includes a plunger head, (b) is insertable into the tubular container via the proximal container opening, such that a lateral surface of the plunger head forms a fluid-tight movable seal with the inner wall, and (c) is coupled to the plunger support, such that rotation of the plunger support with respect to the container housing, when the one or more second threads are engaged with the one or more first threads, distally advances the plunger support with respect to the container housing and thus the plunger within the tubular container;
a filter, wherein the filtration assembly is configured such that movement of the plunger head within the tubular container, when the liquid specimen sample is contained in the tubular container and the filter is disposed in the tubular container, pushes at least a portion of the liquid specimen sample through the filter;
a torque-limiting clutch; and
a control knob, which is rotatable about a central axis of the plunger, and which is coupled to the plunger support by the torque-limiting clutch, such that rotation of the control knob by application of:
   a torque less than a threshold value rotates the plunger support, thereby rotating the plunger support with respect to the container housing, and
   a torque equal to the threshold value causes the control knob to slip with respect to the plunger support.

Inventive Concept 58. The sampling device according to Inventive Concept 57, wherein the torque-limiting clutch includes:
a first set of one or more magnets, which are coupled to the plunger support; and
a second set of one or more magnets, which are coupled to the control knob.

Inventive Concept 59. The sampling device according to Inventive Concept 57, wherein the torque-limiting clutch includes:
a first set of one or more engagement elements, which are coupled to the plunger support; and
a second set of one or more engagement elements, which are coupled to the control knob.

Inventive Concept 60. The sampling device according to Inventive Concept 59, wherein either:
the engagement members of the first set include springs, and the engagement members of the second set include protrusions, or
the engagement members of the first set include protrusions, and the engagement members of the second set include springs.

Inventive Concept 61. The sampling device according to Inventive Concept 57, wherein at least a first axial portion of the control knob surrounds at least a second axial portion of the plunger support.

Inventive Concept 62. The sampling device according to Inventive Concept 57, wherein the one or more first threads of the container housing face radially outward, away from a central axis of the plunger, and the one or more second threads of the plunger support face radially inward, toward the central axis of the plunger.

Inventive Concept 63. The sampling device according to Inventive Concept 57,
wherein the container housing is shaped so as to define a cylindrical space within the container housing, and the tubular container is disposed at least partially within the cylindrical space of the container housing, such that the tubular container is rotatable with respect to the cylindrical space, and
wherein the sampling device is configured such that the rotation of the plunger support with respect to the container housing, when the one or more second threads are engaged with the one or more first threads, distally advances the plunger support with respect to the container housing and thus the plunger within the tubular container as the tubular container rotates with respect to the container housing.

Inventive Concept 64. The sampling device according to Inventive Concept 57,
wherein the sampling device further includes:
   a waste liquid receptacle; and
   a filter support, which is shaped so as to define (a) a support surface on which the filter is removably disposed, and (b) a plurality of filtrate-passage openings through the filter support into the waste liquid receptacle, and
wherein the filtration assembly is configured such that movement of the plunger head within the tubular container, when the liquid specimen sample is contained in the tubular container and the filter is removably disposed on the filter support, pushes the at least a portion of the liquid specimen sample through the filter and the filtrate-passage openings and into the waste liquid receptacle.

There is also provided, in accordance with an Inventive Concept 65 of the present invention, a method for concentrating a liquid specimen sample, the method including:
placing, via a proximal container opening, the liquid specimen sample in a tubular container of a container housing of a filtration assembly of a sampling device, wherein the container housing is shaped so as to define one or more first threads;
inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further includes a plunger rod, which has a distal end portion to which the plunger head is coupled;
engaging the one or more first threads with one or more second threads defined by a plunger support coupled to the plunger; and
rotating, about a central axis of the plunger, a control knob that is coupled to the plunger support by a torque-limiting clutch, such that rotation of the control knob by application of:
   a torque less than a threshold value rotates the plunger support, thereby rotating the plunger support with respect to the container housing and advancing the plunger support with respect to the container housing and thus the plunger within the tubular container, so as to push at least a portion of the liquid specimen sample through a filter disposed in the tubular container, and
   a torque equal to the threshold value causes the control knob to slip with respect to the plunger support.

Inventive Concept 66. The method according to Inventive Concept 65, wherein the torque-limiting clutch includes:
a first set of one or more magnets, which are coupled to the plunger support; and a second set of one or more magnets, which are coupled to the control knob.

Inventive Concept 67. The method according to Inventive Concept 65, wherein the torque-limiting clutch includes:
a first set of one or more engagement elements, which are coupled to the plunger support; and
a second set of one or more engagement elements, which are coupled to the control knob.

Inventive Concept 68. The method according to Inventive Concept 67, wherein either:
the engagement members of the first set include springs, and the engagement members of the second set include protrusions, or
the engagement members of the first set include protrusions, and the engagement members of the second set include springs.

Inventive Concept 69. The method according to Inventive Concept 65, wherein at least a first axial portion of the control knob surrounds at least a second axial portion of the plunger support.

Inventive Concept 70. The method according to Inventive Concept 65, wherein the one or more first threads of the container housing face radially outward, away from a central axis of the plunger, and the one or more second threads of the plunger support face radially inward, toward the central axis of the plunger.

Inventive Concept 71. The method according to Inventive Concept 65,
wherein the container housing is shaped so as to define a cylindrical space within the container housing, and the tubular container is disposed at least partially within the cylindrical space of the container housing, such that the tubular container is rotatable with respect to the cylindrical space, and
wherein rotating the control knob by application of the torque less than the threshold value rotates the plunger support, thereby rotating the plunger support with respect to the container housing and advancing the plunger support with respect to the container housing and thus the plunger within the tubular container as the tubular container rotates with respect to the container housing, so as to push the at least a portion of the liquid specimen sample through the filter.

Inventive Concept 72. The method according to Inventive Concept 65,
wherein the sampling device further includes (i) a waste liquid receptacle and (ii) a filter support, which is shaped so as to define (a) a support surface on which the filter is removably disposed, and (b) a plurality of filtrate-passage openings through the filter support into the waste liquid receptacle, and
wherein rotating the control knob by application of the torque less than the threshold value rotates the plunger support, thereby rotating the plunger support with respect to the container housing and advancing the plunger support with respect to the container housing and thus the plunger within the tubular container, so as to push the at least a portion of the liquid specimen sample through the filter and the filtrate-passage openings and into the waste liquid receptacle.

There is further provided, in accordance with an Inventive Concept 73 of the present invention, a sampling device for concentrating a liquid specimen sample, the sampling device including a filtration assembly, which includes:
a tubular container, which is shaped so as to define an inner wall and a proximal container opening for receiving the liquid specimen sample;
a waste liquid receptacle;
a filter;
a filter support, which is shaped so as to define (a) a support surface on which the filter is removably disposed, and (b) a plurality of filtrate-passage openings through the filter support into the waste liquid receptacle; and
a source of gas, configured to provide gas into a space defined within the filtration assembly,
wherein the filtration assembly is configured such that providing of the gas into the space, when the liquid specimen sample is contained in the tubular container and the filter is disposed on the support surface, pushes at least a portion of the liquid specimen sample through the filter and the filtrate-passage openings and into the waste liquid receptacle.

Inventive Concept 74. The sampling device according to Inventive Concept 73, wherein the source of gas includes one or more substances that generate the gas.

Inventive Concept 75. The sampling device according to Inventive Concept 73, wherein the source of gas includes a compressed gas container containing the gas.

Inventive Concept 76. The sampling device according to Inventive Concept 73,
wherein the filtration assembly is shaped so as to define a gas-release regulation chamber, which is in fluid communication with the space only by one or more narrow openings having a total area of 75-8,000 square microns, and
wherein the source of gas is disposed in the gas-release regulation chamber.

Inventive Concept 77. The sampling device according to Inventive Concept 73, wherein the source of gas is configured to provide the gas upon manual activation of the source of gas.

Inventive Concept 78. The sampling device according to Inventive Concept 77, wherein the filtration assembly includes a user control, which is configured, upon actuation thereof, to manually activate the source of gas to provide the gas.

Inventive Concept 79. The sampling device according to any one of Inventive Concepts 73-78, wherein the filtration assembly further includes a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container.

Inventive Concept 80. The sampling device according to Inventive Concept 79,
wherein the sampling device further includes a container housing, and
wherein the filtration assembly further includes a plunger support, which is (a) coupled to a proximal portion of the plunger and (b) hingedly attached to the container housing.

Inventive Concept 81. The sampling device according to Inventive Concept 79, wherein the filtration assembly is configured such that movement of the plunger head within the tubular container causes the source of gas to provide the gas.

Inventive Concept 82. The sampling device according to Inventive Concept 81,
wherein the movement is non-rotational movement,
wherein the sampling device further includes a container housing, and
wherein the filtration assembly further includes a plunger support, which is (a) coupled to a proximal portion of the plunger and (b) hingedly attached to the container housing.

Inventive Concept 83. The sampling device according to Inventive Concept 79,
wherein the source of gas is configured to provide the gas upon manual activation of the source of gas, and
wherein the filtration assembly includes a safety, which prevents the manual activation of the source of gas prior to a threshold amount of movement of the plunger head within the tubular container.

Inventive Concept 84. The sampling device according to Inventive Concept 79,
wherein the plunger rod is shaped so as to define the waste liquid receptacle within the plunger rod,
wherein the plunger head includes the filter support,
wherein the sampling device further includes a container housing,
wherein the tubular container is disposed at least partially within the container housing, such that the tubular container is moveable with respect to the container housing,
wherein the space within the filtration assembly is defined between (a) a proximally-facing internal surface of the container housing and (b) an external surface of the tubular container that is defined by a distal end of the tubular container, and
wherein the filtration assembly is configured such that the providing of the gas into the space increases the pressure in the space, thereby proximally moving the tubular container with respect to the plunger head, thereby pushing the at least a portion of the liquid specimen sample through the filter and the filtrate-passage openings and into the waste liquid receptacle.

Inventive Concept 85. The sampling device according to Inventive Concept 79,
wherein an internal distal bottom surface of the tubular container includes the filter support,
wherein the filtration assembly further includes:
   a housing, which includes the tubular container; and
   a plunger support, which is couplable to the housing, and which includes a plunger tube, in which the plunger rod is at least partially disposed so as to be axially moveable with respect to the plunger tube,
wherein the space within the filtration assembly is defined between (a) a proximal surface of the plunger rod and (b) a distally-facing internal surface of the plunger support, and
wherein the filtration assembly is configured such that the providing of the gas into the space increases the pressure in the space, thereby distally moving the plunger rod with respect to the plunger tube, thereby pushing the at least a portion of the liquid specimen sample through the filter and the filtrate-passage openings and into the waste liquid receptacle.

Inventive Concept 86. The sampling device according to Inventive Concept 85, wherein the filtration assembly is configured such that coupling of the plunger support to the housing causes proximal movement of the plunger rod within the plunger support, which causes the source of gas to provide the gas.

Inventive Concept 87. The sampling device according to any one of Inventive Concepts 73-78, wherein the space within the filtration assembly is not in fluid communication with an interior of the tubular container.

Inventive Concept 88. The sampling device according to any one of Inventive Concepts 73-78, wherein the space within the filtration assembly is defined within the tubular container at least partially by an inner wall of the tubular container.

Inventive Concept 89. The sampling device according to Inventive Concept 88,
wherein an internal distal bottom surface of the tubular container includes the filter support, and
wherein the filtration assembly further includes a proximal cap, which is configured to sealably close the proximal container opening, and which partially defines the space.

Inventive Concept 90. The sampling device according to any one of Inventive Concepts 73-78,
wherein the filtration assembly further includes an inflatable chamber, which includes a flexible wall, wherein an interior of the inflatable chamber is shaped so as to define the space having an initial volume, and
wherein the providing of the gas into the space increases the initial volume to an inflated volume, so as to push the at least a portion of the liquid specimen sample through the filter and the filtrate-passage openings and into the waste liquid receptacle.

Inventive Concept 91. The sampling device according to Inventive Concept 90, wherein the providing of the gas into the space expands the inflatable chamber toward the filter.

Inventive Concept 92. The sampling device according to Inventive Concept 91, wherein the providing of the gas into the space expands the inflatable chamber into contact with the filter.

Inventive Concept 93. The sampling device according to Inventive Concept 91, wherein the inflatable chamber, when the space has the initial volume, is disposed away from the filter.

Inventive Concept 94. The sampling device according to Inventive Concept 90, wherein the providing of the gas into the space increases an area of contact between the inflatable chamber and the filter.

Inventive Concept 95. The sampling device according to Inventive Concept 90,
wherein an internal distal bottom surface of the tubular container includes the filter support, and
wherein the providing of the gas into the space expands the inflatable chamber toward the filter when the inflatable chamber is disposed at least partially in the tubular container.

Inventive Concept 96. The sampling device according to Inventive Concept 95,
wherein the filtration assembly further includes a proximal cap, which is configured to sealably close the proximal container opening, and
wherein the inflatable chamber is coupled to the proximal cap, such that the inflatable chamber is disposed at least partially in the tubular container when the proximal cap sealably closes the proximal container opening.

Inventive Concept 97. The sampling device according to Inventive Concept 90,
wherein the filtration assembly further includes a proximal cap, which is configured to sealably close the proximal container opening,
wherein the proximal cap is shaped so as to define the waste liquid receptacle within the proximal cap,
wherein the proximal cap includes the filter support, and
wherein the inflatable chamber is disposed at least partially in the tubular container.

Inventive Concept 98. The sampling device according to Inventive Concept 90,
wherein the filtration assembly further includes a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container,
wherein the plunger rod is shaped so as to define the waste liquid receptacle within the plunger rod,
wherein the plunger head includes the filter support,
wherein the sampling device further includes a container housing,
wherein the tubular container is disposed at least partially within the container housing, such that the tubular container is moveable with respect to the container housing,
wherein the inflatable chamber is disposed between (a) a proximally-facing internal surface of the container housing and (b) an external surface of the tubular container that is defined by a distal end of the tubular container, and
wherein the filtration assembly is configured such that the providing of the gas into the space increases the initial volume to the inflated volume, thereby proximally moving the tubular container with respect to the plunger head, thereby pushing the at least a portion of the liquid specimen sample through the filter and the filtrate-passage openings and into the waste liquid receptacle.

Inventive Concept 99. The sampling device according to Inventive Concept 90, wherein the filtration assembly includes one or more sharp surfaces, which are positioned to puncture the inflatable chamber upon the space increasing to the inflated volume.

Inventive Concept 100. The sampling device according to any one of Inventive Concepts 73-78, wherein the filtration assembly further includes a pressure-responsive valve that is configured to limit a pressure within the space.

Inventive Concept 101. The sampling device according to Inventive Concept 100,
wherein the filtration assembly further includes a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container, and
wherein the space within the filtration assembly is outside the tubular container.

Inventive Concept 102. The sampling device according to Inventive Concept 100,
wherein the filtration assembly further includes a plunger, which (i) includes a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container, and
wherein the space within the filtration assembly is not in fluid communication with an interior of the tubular container.

Inventive Concept 103. The sampling device according to Inventive Concept 100, wherein the pressure-responsive valve is configured to limit the pressure in the space by blocking flow of the gas into the space responsively to the pressure in the space.

Inventive Concept 104. The sampling device according to Inventive Concept 103,
wherein the filtration assembly is shaped so as to define a gas-release regulation chamber, which is in fluid communication with the space only by one or more openings,
wherein the source of gas is disposed in fluid communication with the gas-release regulation chamber, and
wherein the pressure-responsive valve is configured to block the flow of the gas into the space by blocking the one or more openings.

Inventive Concept 105. The sampling device according to Inventive Concept 103,
wherein the source of gas includes a compressed gas container containing the gas and defining an opening in fluid communication with the space, and
wherein the pressure-responsive valve is configured to block the flow of the gas into the space by blocking the opening.

Inventive Concept 106. The sampling device according to Inventive Concept 100, wherein the pressure-responsive valve includes a pressure relief valve, which is configured to release a portion of the gas from the space when the pressure within the space exceeds a threshold pressure.

Inventive Concept 107. The sampling device according to Inventive Concept 106, wherein the pressure relief valve is located so as to release the portion of the gas from the space to the atmosphere outside the filtration assembly when the pressure within the space exceeds the threshold pressure.

There is still further provided, in accordance with an Inventive Concept 108 of the present invention, a method for concentrating a liquid specimen sample, the method including:
placing, via a proximal container opening, the liquid specimen sample in a tubular container of a filtration assembly of a sampling device; and
causing a source of gas of the filtration assembly to provide gas into a space defined within the filtration assembly, so as to push at least a portion of the liquid specimen sample through a filter removably disposed in the tubular container on a support surface of a filter support, wherein the filter support is shaped so as to define a plurality of filtrate-passage openings through the filter support into a waste liquid receptacle of the filtration assembly.

Inventive Concept 109. The method according to Inventive Concept 108, wherein the source of gas includes one or more substances that generate the gas.

Inventive Concept 110. The method according to Inventive Concept 108, wherein the source of gas includes a compressed gas container containing the gas.

Inventive Concept 111. The method according to Inventive Concept 108,
wherein the filtration assembly is shaped so as to define a gas-release regulation chamber, which is in fluid communication with the space only by one or more narrow openings having a total area of 75-8,000 square microns, and
wherein the source of gas is disposed in the gas-release regulation chamber.

Inventive Concept 112. The method according to Inventive Concept 108, wherein causing the source of gas to provide the gas includes manually activating the source of gas.

Inventive Concept 113. The method according to Inventive Concept 112, wherein the filtration assembly includes a user control, and wherein manually activating the source of gas includes actuating the user control.

Inventive Concept 114. The method according to any one of Inventive Concepts 108-113, further including inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further includes a plunger rod, which has a distal end portion to which the plunger head is coupled.

Inventive Concept 115. The method according to Inventive Concept 114,
wherein the sampling device further includes a container housing, and
wherein the filtration assembly further includes a plunger support, which is (a) coupled to a proximal portion of the plunger and (b) hingedly attached to the container housing.

Inventive Concept 116. The method according to Inventive Concept 114, wherein causing the source of gas to provide the gas includes moving the plunger head within the tubular container.

Inventive Concept 117. The method according to Inventive Concept 116,
wherein the sampling device further includes a container housing,
wherein the filtration assembly further includes a plunger support, which is (a) coupled to a proximal portion of the plunger and (b) hingedly attached to the container housing, and
wherein moving the plunger head within the tubular container includes non-rotationally moving the plunger head within the tubular container.

Inventive Concept 118. The method according to Inventive Concept 114,
wherein causing the source of gas to provide the gas includes manually activating the source of gas, and
wherein the filtration assembly includes a safety, which prevents manual activation of the source of gas prior to a threshold amount of movement of the plunger head within the tubular container.

Inventive Concept 119. The method according to Inventive Concept 114,
wherein the plunger rod is shaped so as to define the waste liquid receptacle within the plunger rod,
wherein the plunger head includes the filter support,
wherein the sampling device further includes a container housing,
wherein the tubular container is disposed at least partially within the container housing, such that the tubular container is moveable with respect to the container housing, and
wherein the space within the filtration assembly is defined between (a) a proximally-facing internal surface of the container housing and (b) an external surface of the tubular container that is defined by a distal end of the tubular container, and
wherein causing the source of gas to provide the gas into the space increases the pressure in the space, thereby proximally moving the tubular container with respect to the plunger head, thereby pushing the at least a portion of the liquid specimen sample through the filter and the filtrate-passage openings and into the waste liquid receptacle.

Inventive Concept 120. The method according to Inventive Concept 114,
wherein an internal distal bottom surface of the tubular container includes the filter support,
wherein the filtration assembly further includes:
   a housing, which includes the tubular container; and
   a plunger support, which is couplable to the housing, and which includes a plunger tube, in which the plunger rod is at least partially disposed so as to be axially moveable with respect to the plunger tube,
wherein the space within the filtration assembly is defined between (a) a proximal surface of the plunger rod and (b) a distally-facing internal surface of the plunger support, and
wherein causing the source of gas to provide the gas increases the pressure in the space, thereby distally moving the plunger rod with respect to the plunger tube, thereby pushing the at least a portion of the liquid specimen sample through the filter and the filtrate-passage openings and into the waste liquid receptacle.

Inventive Concept 121. The method according to Inventive Concept 120, wherein causing the source of gas to provide the gas includes coupling of the plunger support to the housing to cause proximal movement of the plunger rod within the plunger support.

Inventive Concept 122. The method according to any one of Inventive Concepts 108-113, wherein the space within the filtration assembly is not in fluid communication with an interior of the tubular container.

Inventive Concept 123. The method according to any one of Inventive Concepts 108-113, wherein the space within the filtration assembly is defined within the tubular container at least partially by an inner wall of the tubular container.

Inventive Concept 124. The method according to Inventive Concept 123,
wherein an internal distal bottom surface of the tubular container includes the filter support, and
wherein the method further includes sealably closing the proximal container opening with a proximal cap of the filtration assembly, such that the proximal cap partially defines the space.

Inventive Concept 125. The method according to any one of Inventive Concepts 108-113,
wherein the filtration assembly further includes an inflatable chamber, which includes a flexible wall, wherein an interior of the inflatable chamber is shaped so as to define the space having an initial volume, and
wherein the providing of the gas into the space increases the initial volume to an inflated volume, so as to push the at least a portion of the liquid specimen sample through the filter and the filtrate-passage openings and into the waste liquid receptacle.

Inventive Concept 126. The method according to Inventive Concept 125, wherein causing the source of gas to provide the gas into the space expands the inflatable chamber toward the filter.

Inventive Concept 127. The method according to Inventive Concept 126, wherein causing the source of gas to provide the gas into the space expands the inflatable chamber into contact with the filter.

Inventive Concept 128. The method according to Inventive Concept 126, wherein the inflatable chamber, when the space has the initial volume, is disposed away from the filter.

Inventive Concept 129. The method according to Inventive Concept 125, wherein causing the source of gas to provide the gas into the space increases an area of contact between the inflatable chamber and the filter.

Inventive Concept 130. The method according to Inventive Concept 125,
wherein an internal distal bottom surface of the tubular container includes the filter support, and
wherein causing the source of gas to provide the gas into the space includes disposing the inflatable chamber at least partially in the tubular container.

Inventive Concept 131. The method according to Inventive Concept 130,
wherein the inflatable chamber is coupled to a proximal cap of the filtration assembly, and
wherein the method further includes sealably closing the proximal container opening with the proximal cap, such that the inflatable chamber is disposed at least partially in the tubular container.

Inventive Concept 132. The method according to Inventive Concept 125,
further including sealably closing the proximal container opening with a proximal cap of the filtration assembly,
wherein the proximal cap is shaped so as to define the waste liquid receptacle within the proximal cap,
wherein the proximal cap includes the filter support, and
wherein the inflatable chamber is disposed at least partially in the tubular container.

Inventive Concept 133. The method according to Inventive Concept 125,
further including inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further includes a plunger rod, which (a) has a distal end portion to which the plunger head is coupled, and (b) is shaped so as to define the waste liquid receptacle within the plunger rod,
wherein the plunger head includes the filter support,
wherein the sampling device further includes a container housing,
wherein the tubular container is disposed at least partially within the container housing, such that the tubular container is moveable with respect to the container housing,
wherein the inflatable chamber is disposed between (a) a proximally-facing internal surface of the container housing and (b) an external surface of the tubular container that is defined by a distal end of the tubular container, and
wherein causing the source of gas to provide the gas into the space increases the initial volume to the inflated volume, thereby proximally moving the tubular container with respect to the plunger head, thereby pushing the at least a portion of the liquid specimen sample through the filter and the filtrate-passage openings and into the waste liquid receptacle.

Inventive Concept 134. The method according to Inventive Concept 125, wherein the filtration assembly includes one or more sharp surfaces, which are positioned to puncture the inflatable chamber upon the space increasing to the inflated volume.

Inventive Concept 135. The method according to any one of Inventive Concepts 108-113, wherein the filtration assembly further includes a pressure-responsive valve that is configured to limit a pressure within the space.

Inventive Concept 136. The method according to Inventive Concept 135,
further including inserting a plunger head of a plunger of the filtration assembly into the tubular container via the proximal container opening, such that a lateral surface of the plunger head forms a fluid-tight movable seal with an inner wall of the tubular container, wherein the plunger further includes a plunger rod, which has a distal end portion to which the plunger head is coupled, and
wherein the space within the filtration assembly is outside the tubular container.

Inventive Concept 137. The method according to Inventive Concept 135,
further including inserting a plunger head of a plunger of the filtration assembly into the tubular container via the proximal container opening, such that a lateral surface of the plunger head forms a fluid-tight movable seal with an inner wall of the tubular container, wherein the plunger further includes a plunger rod, which has a distal end portion to which the plunger head is coupled, and
wherein the space within the filtration assembly is not in fluid communication with an interior of the tubular container.

Inventive Concept 138. The method according to Inventive Concept 135, wherein the pressure-responsive valve is configured to limit the pressure in the space by blocking flow of the gas into the space responsively to the pressure in the space.

Inventive Concept 139. The method according to Inventive Concept 138,
wherein the filtration assembly is shaped so as to define a gas-release regulation chamber, which is in fluid communication with the space only by one or more openings,
wherein the source of gas is disposed in fluid communication with the gas-release regulation chamber, and
wherein the pressure-responsive valve is configured to block the flow of the gas into the space by blocking the one or more openings.

Inventive Concept 140. The method according to Inventive Concept 138,
wherein the source of gas includes a compressed gas container containing the gas and defining an opening in fluid communication with the space, and
wherein the pressure-responsive valve is configured to block the flow of the gas into the space by blocking the opening.

Inventive Concept 141. The method according to Inventive Concept 135, wherein the pressure-responsive valve includes a pressure relief valve, which is configured to release a portion of the gas from the space when the pressure within the space exceeds a threshold pressure.

Inventive Concept 142. The method according to Inventive Concept 141, wherein the pressure relief valve is located so as to release the portion of the gas from the space to the atmosphere outside the filtration assembly when the pressure within the space exceeds the threshold pressure.

Inventive Concept 143. The method according to any one of Inventive Concepts 108-113, further including, after the filter has been removed from the tubular container, detecting the presence of a biological particulate trapped by the filter.

Inventive Concept 144. The method according to Inventive Concept 143, wherein detecting the presence of the biological particulate trapped by the filter including using a lateral flow test strip to detect the presence of the biological particulate trapped by the filter.

Inventive Concept 145. The method according to Inventive Concept 143, wherein the biological particulate is selected from the group consisting of: a virus, a bacterium, a microorganism, a fungus, a spore, a mite, a biological cell, a biological antigen, a protein, a protein antigen, and a carbohydrate antigen.

Inventive Concept 146. The method according to any one of Inventive Concepts 108-113, wherein the liquid specimen sample includes gargled fluid.

There is still further provided, in accordance with an Inventive Concept 147 of the present invention, a sampling device for concentrating a liquid specimen sample, the sampling device including a filtration assembly, which includes:
a container housing, which includes a tubular container, which is shaped so as to define an inner wall and a proximal container opening for receiving the liquid specimen sample;
a plunger, which (a) includes a plunger head, and (b) is insertable into the tubular container via the proximal container opening, such that a lateral surface of the plunger head forms a fluid-tight movable seal with the inner wall; and
a filter,
wherein the filtration assembly is configured such that movement of the plunger head within the tubular container, when the liquid specimen sample is contained in the tubular container and the filter is disposed in the tubular container, pushes at least a portion of the liquid specimen sample through the filter, and
wherein the filtration assembly is configured to transiently reduce pressure that the liquid specimen sample exerts on the filter upon the plunger being advanced quickly within the tubular container.

Inventive Concept 148. The sampling device according to Inventive Concept 147,
wherein the container housing is shaped so as to define one or more first threads,
wherein the filtration assembly further a plunger support, which is shaped so as to define one or more second threads, shaped so as to engage the one or more first threads, and
wherein the plunger is coupled to the plunger support, such that rotation of the plunger support with respect to the container housing, when the one or more second threads are engaged with the one or more first threads, distally advances the plunger support with respect to the container housing and thus the plunger within the tubular container.

Inventive Concept 149. The sampling device according to Inventive Concept 147, wherein the filtration assembly includes a mechanical energy storage element that is configured to transiently reduce the pressure that the liquid specimen sample exerts on the filter upon the plunger being advanced quickly within the tubular container.

Inventive Concept 150. The sampling device according to Inventive Concept 149, wherein the mechanical storage element includes an elastic element selected from the group consisting of: a spring, a balloon, and soft beads.

Inventive Concept 151. The sampling device according to Inventive Concept 147,
wherein the sampling device further includes:
   a waste liquid receptacle; and
   a filter support, which is shaped so as to define (a) a support surface on which the filter is removably disposed, and (b) a plurality of filtrate-passage openings through the filter support into the waste liquid receptacle, and
wherein the filtration assembly is configured such that movement of the plunger head within the tubular container, when the liquid specimen sample is contained in the tubular container and the filter is removably disposed on the filter support, pushes the at least a portion of the liquid specimen sample through the filter and the filtrate-passage openings and into the waste liquid receptacle.

There is additionally provided, in accordance with an Inventive Concept 152 of the present invention, a method for concentrating a liquid specimen sample, the method including:
placing, via a proximal container opening, the liquid specimen sample in a tubular container of a container housing of a filtration assembly of a sampling device;
inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further includes a plunger rod, which has a distal end portion to which the plunger head is coupled; and
moving the plunger head within the tubular container so as to push at least a portion of the liquid specimen sample through a filter disposed in the tubular container,
wherein the filtration assembly is configured to transiently reduce pressure that the liquid specimen sample exerts on the filter upon the plunger being advanced quickly within the tubular container.

Inventive Concept 153. The method according to Inventive Concept 152,
wherein the container housing is shaped so as to define one or more first threads,
wherein moving the plunger head within the tubular container includes:
   engaging the one or more first threads with one or more second threads defined by a plunger support coupled to the plunger; and
   rotating the plunger support with respect to the container housing, thereby distally advancing the plunger support with respect to the container housing and thus the plunger within the tubular container.

Inventive Concept 154. The method according to Inventive Concept 152, wherein the filtration assembly includes a mechanical energy storage element that is configured to transiently reduce the pressure that the liquid specimen sample exerts on the filter upon the plunger being advanced quickly within the tubular container.

Inventive Concept 155. The method according to Inventive Concept 154, wherein the mechanical storage element includes an elastic element selected from the group consisting of: a spring, a balloon, and soft beads.

Inventive Concept 156. The method according to Inventive Concept 152,
wherein the sampling device further includes (i) a waste liquid receptacle and (ii) a filter support, which is shaped so as to define (a) a support surface on which the filter is removably disposed, and (b) a plurality of filtrate-passage openings through the filter support into the waste liquid receptacle, and
wherein moving the plunger head within the tubular container, when the liquid specimen sample is contained in the tubular container and the filter is removably disposed on the filter support, pushes the at least a portion of the liquid specimen sample through the filter and the filtrate-passage openings and into the waste liquid receptacle.

The present invention will be more fully understood from the following detailed description of embodiments thereof, taken together with the drawings, in which:

### BRIEF DESCRIPTION OF THE DRAWINGS

FIGS. 1A-B are schematic illustrations of a sampling device for concentrating a liquid specimen sample, and a portion of the sampling device, respectively, in accordance with an application of the present invention;

FIGS. 2A-D are schematic illustrations of the sampling device of FIGS. 1A-B and a method of using the sampling device, in accordance with respective applications of the present invention;

FIGS. 3A-I are schematic cross-sectional illustrations of the sampling device of FIGS. 1A-B and the method of using the sampling device, in accordance with respective applications of the present invention;

FIGS. 3J-K are schematic illustrations of another method of using the sampling device of FIGS. 1A-B, in accordance with an application of the present invention;

FIG. 4 is an enlarged schematic illustration of a portion of the sampling device of FIGS. 1A-B, in accordance with an application of the present invention;

FIGS. 5A-E are schematic cross-sectional illustrations of another sampling device for concentrating a liquid specimen sample and the method of using the sampling device, in accordance with respective applications of the present invention;

FIGS. 6A-E are schematic cross-sectional illustrations of still another sampling device for concentrating a liquid specimen sample and the method of using the sampling device, in accordance with respective applications of the present invention;

FIGS. 7A-D are schematic illustrations of another sampling device and a method of using the sampling device, in accordance with respective applications of the present invention;

FIGS. 8A-C are schematic cross-sectional illustrations of yet another sampling device and a method of using the sampling device, in accordance with respective applications of the present invention;

FIGS. 9A-D are schematic cross-sectional illustrations of still another sampling device and a method of using the sampling device, in accordance with respective applications of the present invention;

FIGS. 10A-E are schematic cross-sectional illustrations of another sampling device and a method of using the sampling device, in accordance with respective applications of the present invention;

FIGS. 11A-B are schematic illustrations of still another sampling device and a method of using the sampling device, in accordance with respective applications of the present invention;

FIGS. 12A-D are schematic cross-sectional illustration of the sampling device of FIG. 11A-B and the method of using the sampling device, in accordance with respective applications of the present invention;

FIGS. 13A-D are schematic illustrations of yet another sampling device and a method of using the sampling device, in accordance with respective applications of the present invention;

FIGS. 14A-D are schematic cross-sectional illustration of one configuration of the sampling device of FIG. 13A-D and the method of using the sampling device, in accordance with respective applications of the present invention;

FIGS. 15A-D are schematic cross-sectional illustration of another configuration of the sampling device of FIG. 13A-D and the method of using the sampling device, in accordance with respective applications of the present invention;

FIGS. 16A-D are schematic cross-sectional illustration of yet another configuration of the sampling device of FIG. 13A-D and the method of using the sampling device, in accordance with respective applications of the present invention;

FIGS. 17A-C are schematic illustrations of still another sampling device and a method of using the sampling device, in accordance with respective applications of the present invention;

FIGS. 18A-F are schematic cross-sectional illustrations of a sampling device for concentrating a liquid specimen sample and a method of using the sampling device, in accordance with respective applications of the present invention;

FIGS. 19A-C are schematic cross-sectional illustrations of another sampling device for concentrating a liquid specimen sample and a method of using the sampling device, in accordance with respective applications of the present invention;

FIGS. 20A-F are schematic cross-sectional illustrations of yet another sampling device for concentrating a liquid specimen sample and a method of using the sampling device, in accordance with respective applications of the present invention;

FIGS. 21A-D are schematic cross-sectional illustrations of still another sampling device for concentrating a liquid specimen sample and a method of using the sampling device, in accordance with respective applications of the present invention;

FIGS. 22A-H are schematic cross-sectional illustrations of another sampling device for concentrating a liquid specimen sample and a method of using the sampling device, in accordance with respective applications of the present invention;

FIGS. 23A-C are schematic cross-sectional illustrations of a sampling device for concentrating a liquid specimen sample and a method of using the sampling device, in accordance with an application of the present invention;

FIGS. 24A-C are schematic cross-sectional illustrations of another sampling device for concentrating a liquid specimen sample and a method of using the sampling device, in accordance with an application of the present invention;

FIGS. 25A-B are schematic cross-sectional illustrations of yet another sampling device for concentrating a liquid specimen sample and a method of using the sampling device, in accordance with an application of the present invention;

FIGS. 26A-C are schematic cross-sectional illustrations of still another sampling device for concentrating a liquid specimen sample and a method of using the sampling device, in accordance with an application of the present invention;

FIGS. 27A-B are schematic cross-sectional illustrations of another sampling device for concentrating a liquid specimen sample and a method of using the sampling device, in accordance with an application of the present invention;

FIGS. 28A-B are schematic cross-sectional illustrations of yet another sampling device for concentrating a liquid specimen sample, in accordance with an application of the present invention;

FIGS. 29A-D are schematic illustrations of a method of using the sampling device of FIGS. 28A-B, in accordance with an application of the present invention;

FIGS. 30A-B are schematic cross-sectional illustrations of still another sampling device for concentrating a liquid specimen sample, in accordance with an application of the present invention; and

FIGS. 31A-D are schematic illustrations of a method of using the sampling device of FIGS. 30A-B, in accordance with an application of the present invention.

### DETAILED DESCRIPTION OF APPLICATIONS

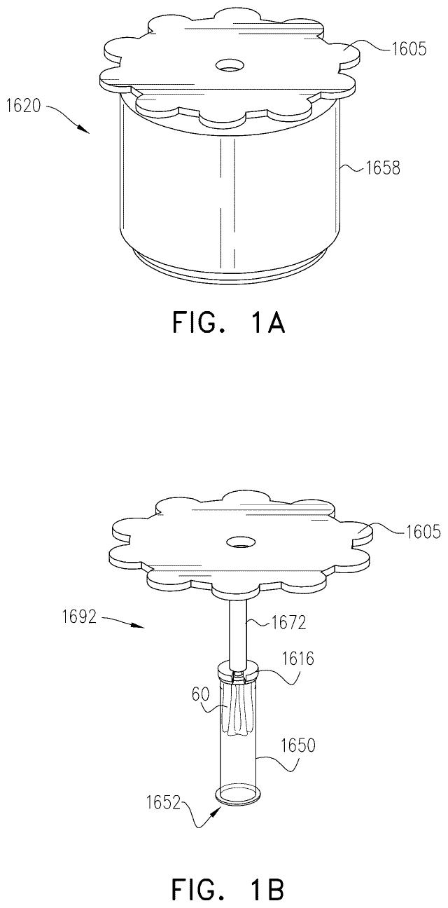

FIGS. 1A-B are schematic illustrations of a sampling device 1620 for concentrating a liquid specimen sample 22, and a portion of the sampling device, respectively, in accordance with an application of the present invention.

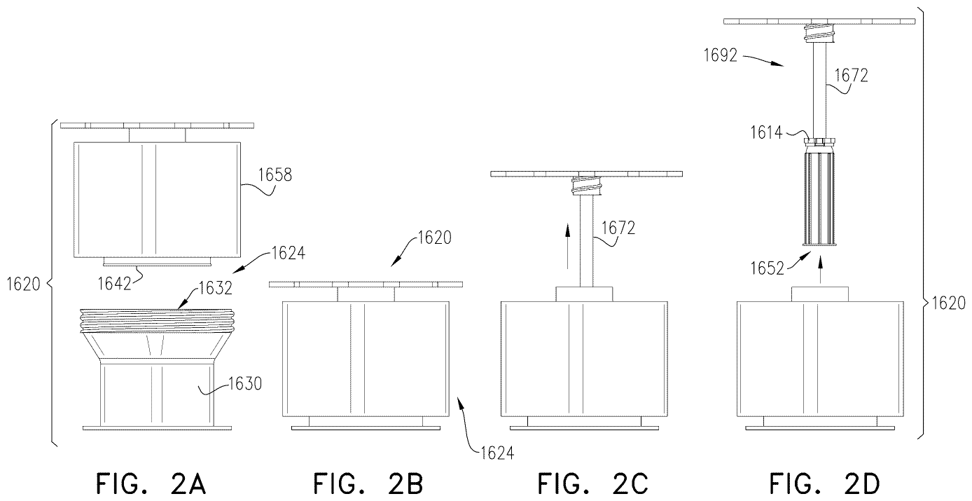

Reference is also made to FIGS. 2A-D, which are schematic illustrations of sampling device 1620 and a method of using sampling device 1620, in accordance with respective applications of the present invention.

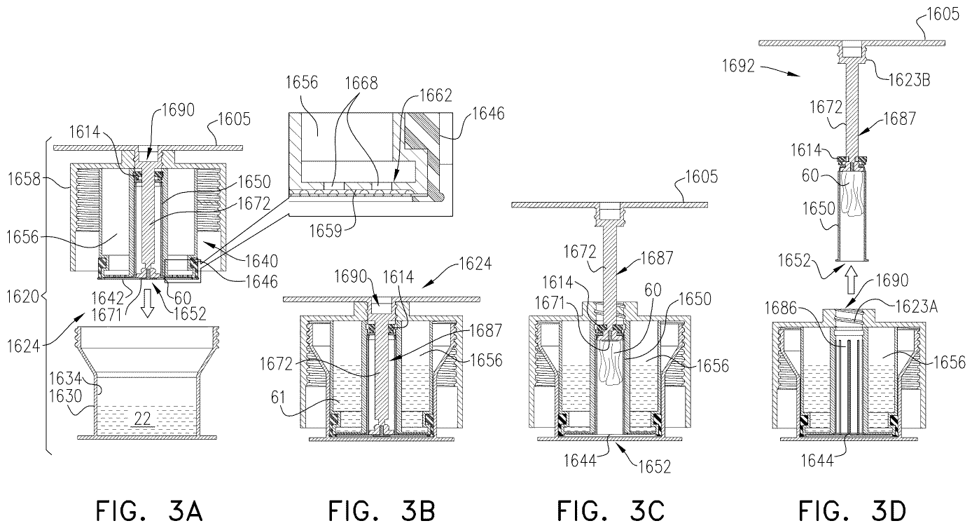

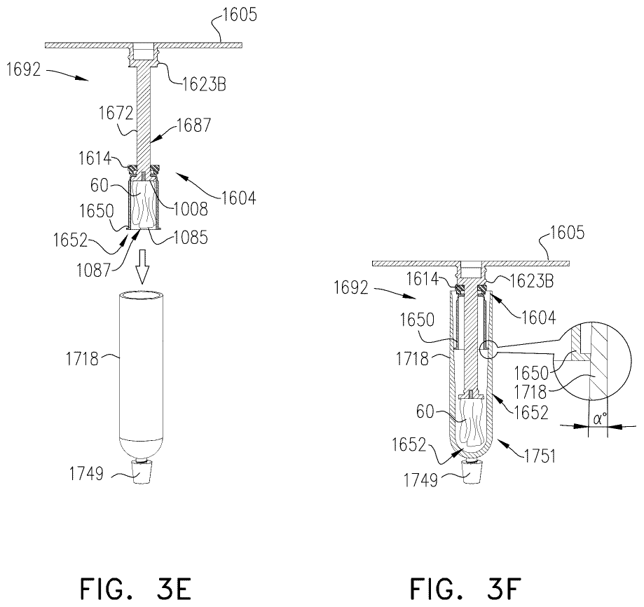

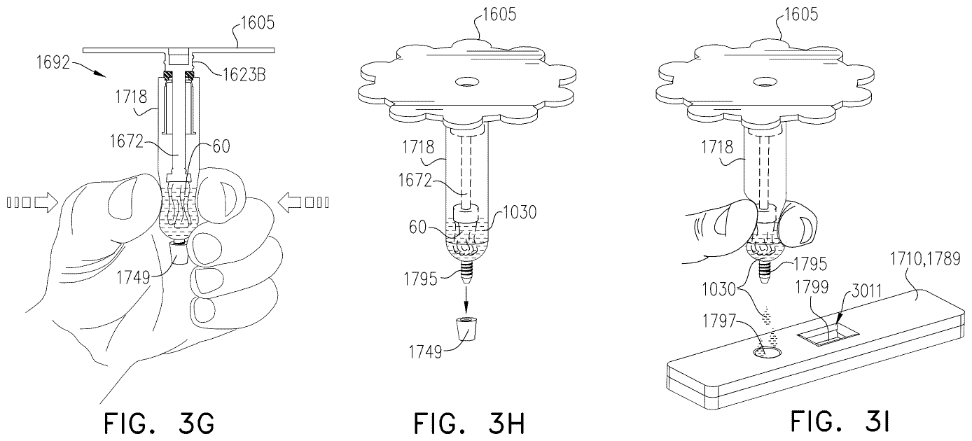

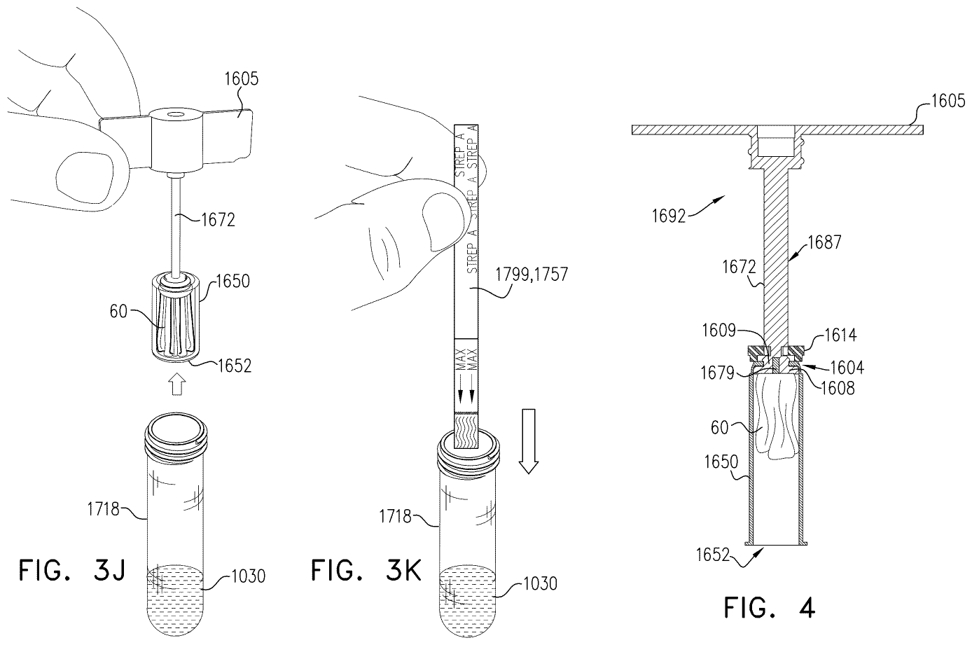

Reference is also made to FIGS. 3A-I, which are schematic cross-sectional illustrations of sampling device 1620 and a method of using sampling device 1620, in accordance with respective applications of the present invention. Reference is also made to FIGS. 3J-K, which are schematic illustrations of another method of using sampling device 1620, in accordance with an application of the present invention.

Reference is further made to FIG. 4, which is an enlarged schematic illustration of a portion of sampling device 1620 in the state shown in FIGS. 2D and 3D, in accordance with an application of the present invention.

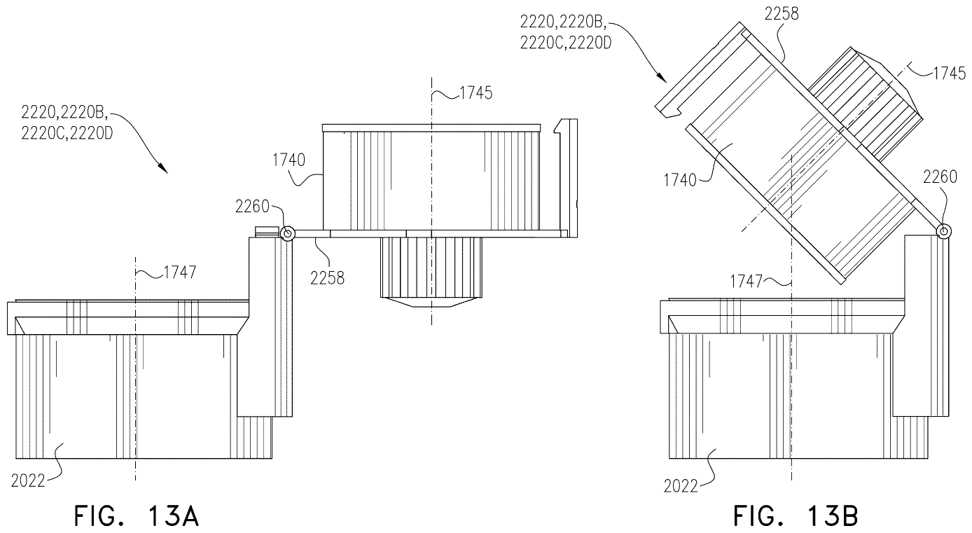

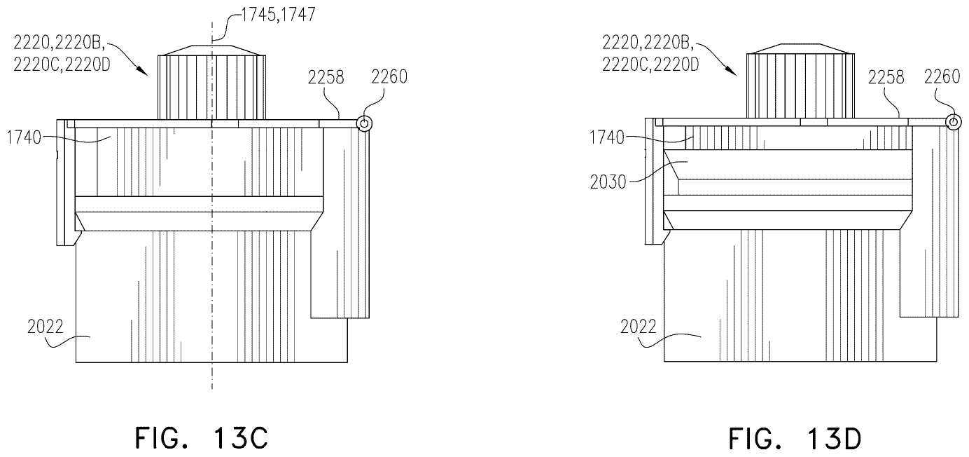

Sampling device 1620 comprises a filtration assembly 1624 and a filter-collection receptacle 1650. The features of sampling device 1620, including but not limited to filter-collection receptacle 1650, may be implemented in any of the other sampling devices described hereinbelow, mutatis mutandis. Similarly, sampling device 1620 may be implemented in combination with any of the features of the other sampling devices described herein, mutatis mutandis, including, by way of example and not limitation, the reversible filter-clamping techniques of sampling devices 1820 or 1920, described in PCT Publication WO 2023/131948 to Levitz et al., which is incorporated herein by reference, with reference to FIGS. 11A-13F and FIGS. 14A-16E thereof, respectively.

Filtration assembly 1624 comprises tubular container 1630, a plunger 1640 (labeled in FIG. 3A), and a filter 60.

Tubular container 1630 is shaped so as to define a proximal container opening 1632 (labeled in FIG. 2A) for receiving liquid specimen sample 22, after or during collection of liquid specimen sample 22 from the subject. Tubular container 1630 is also shaped so as to define an inner wall 1634 (labeled in FIG. 3A). At least a portion of tubular container 1630, such as a distal portion, may define a syringe barrel.

As labeled in FIGS. 2A and 3A, plunger 1640 comprises a plunger head 1642 and a plunger rod 1682. Plunger 1640 is insertable into tubular container 1630 via proximal container opening 1632, such that a lateral surface 1646 of plunger head 1642 (labeled in FIG. 3A) forms a fluid-tight movable seal with inner wall 1634. To this end, lateral surface 1646 may comprise an elastomeric material, such as natural rubber, synthetic rubber, a thermoplastic elastomer, or a combination thereof. Optionally, filtration assembly 1624 further comprises a plunger support 1658, which is coupled to a proximal portion of plunger 1640. Plunger support 1658 may be configured to be coupled to tubular container 1630. A portion of plunger support 1658 may serve as a handle to enable easy manipulation of plunger 1640, including insertion of plunger 1640 into tubular container 1630. Optionally, a portion of plunger support 1658 surrounds plunger 1640.

For some of these applications, plunger rod 1682 is shaped so as to define an internal plunger space 1686 (labeled in FIG. 3D). For some of these applications, a proximal end of plunger rod 1682 is shaped so as to define a plunger-space proximal opening 1690 of internal plunger space 1686. Plunger head 1642 is shaped so as to define a plunger-head opening 1644 (labeled in FIG. 3C) through plunger head 1642 and into internal plunger space 1686.

Typically, filter-collection receptacle 1650 is removably disposed at least partially within internal plunger space 1686.

Typically, filter-collection receptacle 1650 is positioned proximal to plunger head 1642.

Reference is made to FIGS. 2A and 3A. Optionally, proximal container opening 1632 is shaped as a funnel to facilitate receipt of liquid specimen sample 22 during collection of the liquid specimen sample. For example, liquid specimen sample 22 may be expressed (e.g., spit) from subject's mouth into tubular container 1630, or transferred to tubular container 1630 from a collection container. Optionally, the funnel shape of proximal container opening 1632 is similar to funnel-shaped proximal opening 36 shown in FIG. 1 of US Patent Application Publication 2019/0381498 to Fruchter et al., which is incorporated herein by reference. Tubular container 1630, as well as any of the other tubular elements described herein, may be cylindrical, as shown, or may alternatively have another, non-circular cross-sectional shape. Alternatively or additionally, tubular container 1630 may have different cross-sectional shapes along respective different longitudinal portions of the tubular container; optionally, one or more of the cross-sectional shapes is circular.

Typically, tubular container 1630 has an internal volume of at least 0.5 ml (e.g., at least 1 ml, such as at least 5 ml), no more than 500 ml (e.g., no more than 70 ml), and/or 0.5 ml (e.g., 1 ml or 5 ml)-500 ml (e.g., 70 ml).

For some applications, tubular container 1630 does not comprise a Luer lock or any other type of needle-coupling mechanism.

As shown in FIGS. 2D, 3C, and 3D, filter-collection receptacle 1650 is typically shaped so as to define a receptacle opening 1652.

For some applications, filter-collection receptacle 1650 has a volume of at least 1 ml, no more than 50 ml, and/or 1-50 ml, such as at least 2 ml, no more than 20 ml, and/or 2-20 ml, e.g., at least 3 ml (e.g., at least 5 ml), no more than 15 ml, and/or 3 (e.g., 5)-15 ml. For some applications, filter-collection receptacle 1650 has a greatest internal diameter of no more than 35 mm, e.g., no more than 20 mm, such as no more than 15 mm or no more than 10 mm.

Filter-collection receptacle 1650 typically has a greatest outer diameter that is less than (e.g., less than 80%, such as less than 70%) an inner diameter of an axial portion of tubular container 1630 in which plunger head 1642 is distally advanceable.

Filter-collection receptacle 1650 typically is not shaped so as to define any pressure-release openings and does not comprise any pressure-release valves.

Reference is made to FIGS. 3B-D. Typically, filtration assembly 1624 further comprises a waste liquid receptacle 1656 for receiving a filtrate 61. For some of these applications, plunger rod 1682 is shaped so as to define therewithin waste liquid receptacle 1656. Typically, waste liquid receptacle 1656 partially or entirely surrounds internal plunger space 1686, such as shown.

For some applications, plunger head 1642 is shaped so as to define a filter support 1662 (labeled in FIG. 3A), which is shaped so as to define:
a support surface 1659, which may be perpendicular to a central longitudinal axis of plunger head 1642 (as shown), or may be angled with respect to the central longitudinal axis (configuration not shown),
a plurality of filtrate-passage openings 1668 through filter support 1662 into waste liquid receptacle 1656, and
a central opening that defines plunger-head opening 1644 (labeled in FIGS. 3C and 3D).

Filter 60 is (removably) disposed on support surface 1659, typically on an upstream side of support surface 1659 (which, in the configuration of sampling device 1620, is a distal side of support surface 1659).

Reference is made to FIGS. 2A-B and 3A-B. Filtration assembly 1624 is configured such that movement (typically distal advancement) of plunger head 1642 within tubular container 1630, when liquid specimen sample 22 is contained in tubular container 1630 and filter 60 is disposed in tubular container 1630, pushes at least a portion of liquid specimen sample 22 through filter 60. Filter 60 is configured to concentrate at least a portion of liquid specimen sample 22 onto filter 60, while allowing filtrate 61 to pass through filter 60. Typically, distal advancement of plunger 1640 within tubular container 1630 applies pressure to drive (e.g., push) at least a portion of liquid specimen sample 22 contained in tubular container 1630 through filter 60, such as shown in the transitions between FIGS. 2A and 2B and between FIGS. 3A and 3B.

Filtration assembly 1624 is configured such that movement of plunger head 1642 within tubular container 1630, when liquid specimen sample 22 is contained in tubular container 1630 and filter 60 is disposed in tubular container 1630, pushes at least a portion of liquid specimen sample 22 through filter 60 and filtrate-passage openings 1668 and into waste liquid receptacle 1656.

Optionally, waste liquid receptacle 1656 is shaped so as to define an opening through an external wall of waste liquid receptacle 1656 to release displaced air. For example, the opening may be located on a proximal portion of the external wall, typically above the highest level that filtrate 61 is expected to reach during ordinary use of the device. For some applications, waste liquid receptacle 1656 comprises an air filter (e.g., an N98 filter) that is disposed to filter air that passes out of waste liquid receptacle 1656 through the opening. Alternatively or additionally, for some applications, waste liquid receptacle 1656 comprises a one-way pressure-sensitive valve disposed in the opening.

Filter 60 comprises synthetic or natural materials formed, for example, as a matrix, membrane, fabric, beads, or other configuration. For some applications, filter 60 comprises a mechanical filter, which is configured to mechanically filter particulate from liquid specimen sample 22 by size-based filtration. Optionally, filter 60 comprises a depth filter.

Alternatively or additionally, for some applications, filter 60 comprises fixed antibodies configured to capture the particulate (e.g., free viral particles) by affinity-based filtration.

For some applications, for example, when filter 60 is used for capturing free virus, virions, or viral particles by size-based filtration, filter 60 may have a pore size of 0.01-0.3 microns and/or a molecular weight cut off of 10 kDa-500 kDa. For some applications, filter 60 has a pore size of 0.2-5.0 microns, such as 0.2-2.0 microns (e.g., 0.8 to 1.5 microns, such as 1.2 microns), for example, when filter 60 is used for capturing bacteria by size-based filtration.

For some applications, filter 60 comprises a polyethersulfone (PES) membrane filter.

Alternatively or additionally, for some applications, filter 60 has a nominal pore size of 30 microns-1.5 mm, the nominal pore size representative of a minimum size of spherical particles necessary for the filter to retain 85% of the spherical particles when H2O containing the spherical particles is passed through the filter at 20 degrees C. under pressure supplied by a 10 cm water column. For these applications, filter 60 may implement techniques described in U.S. Provisional Application 63/117,294, filed Nov. 23, 2020, which is assigned to the assignee of the present application and incorporated herein by reference, and/or in PCT Publication WO 2021/224925 to Levitz et al., which is incorporated herein by reference.

For example, the nominal pore size may be at least 40 microns, such as at least 60 microns, e.g., at least 100 microns, at least 120 microns, at least 150 microns, at least 200 microns, or at least 500 microns. Alternatively or additionally, for example, the nominal pore size may be less than 1 mm, such as less than 750 microns, less than 500 microns, or less than 250 microns.

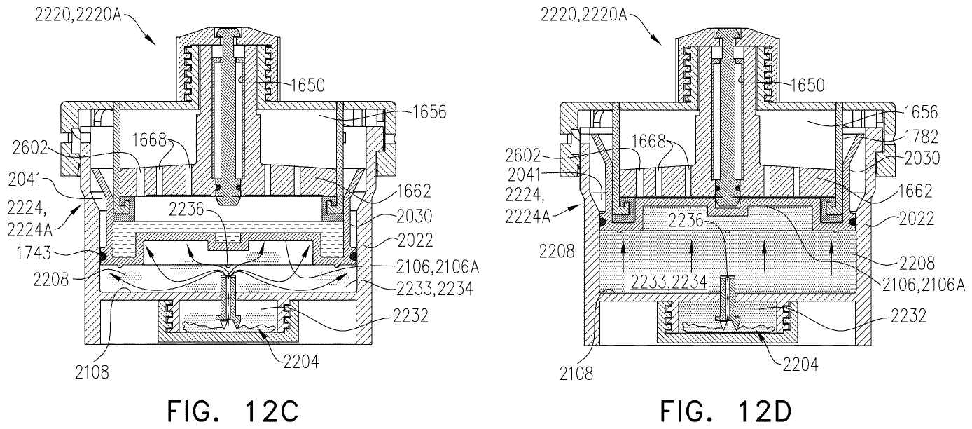

For some applications, filtration assembly 1624 comprises a plurality of filters, such as described with reference to FIGS. 10A-B in PCT Publication WO 2022/149135 to Feldman et al., which is assigned to the assignee of the present application and incorporated herein by reference. Optionally, two or more of the plurality of filters touch one another, such as shown in FIGS. 10A-B of the '024 publication, or are separated by one another by one or more thin spacers, e.g., having a thickness of at least 0.05 mm, no more than 1 mm, and/or 0.05-1 mm (configuration not shown). Alternatively or additionally, two or more of the plurality of filters are spaced apart from another, which case filtration assembly 1624 optionally comprises a corresponding number of filter supports 1662, some or all of which may have some or all of the characteristics of filter support 1662 (configuration not shown). Further alternatively or additionally, filtration assembly 1624 comprises one or more additional filters downstream of filter 60 (configuration not shown).

Reference is made to FIGS. 2D and 3D. Sampling device 1620 is typically configured such that filter 60 is removable from tubular container 1630 via a plunger-space proximal opening 1690 while plunger head 1642 of plunger 1640 (and typically filter support 1662) remains within tubular container 1630 (filter 60 is also removable from tubular container 1630 via plunger-space proximal opening 1690 if plunger head 1642 has been removed from tubular container 1630). As mentioned above, plunger head 1642 is shaped so as to define plunger-head opening 1644 through plunger head 1642 and into internal plunger space 1686 of plunger 1640.

Sampling device 1620 is configured such that filter 60 is advanceable into (e.g., entirely into) filter-collection receptacle 1650 via receptacle opening 1652 while filter-collection receptacle 1650 is disengageably coupled to filtration assembly 1624, such as shown in FIGS. 2C and 3C.

Reference is made to FIGS. 2C and 3C. For some applications, sampling device 1620 is configured such that filter 60 is advanceable into filter-collection receptacle 1650 via receptacle opening 1652 while plunger head 1642 (and typically filter support 1662) remains within tubular container 1630, such as shown in FIGS. 2C and 3C. For some of these applications, sampling device 1620 is configured such that filter 60 is advanceable into filter-collection receptacle 1650 via receptacle opening 1652 while plunger head 1642 is advanced as far as possible within tubular container 1630, such as shown in FIGS. 2C and 3C. Alternatively or additionally, for some applications, sampling device 1620 is configured such that filter 60 is advanceable into filter-collection receptacle 1650 via receptacle opening 1652 without any proximal withdrawal of plunger head 1642 within tubular container 1630, such as shown in FIGS. 2C and 3C.

Reference is made to FIGS. 2D and 3D. For some applications, sampling device 1620 is configured such that filter-collection receptacle 1650 is decouplable from filtration assembly 1624 while plunger head 1642 remains within tubular container 1630, such as shown in FIGS. 2D and 3D, typically, but not necessarily, via a proximal end of plunger 1640. For some of these applications, sampling device 1620 is configured such that filter-collection receptacle 1650 is decouplable from filtration assembly 1624 while plunger head 1642 is advanced as far as possible within tubular container 1630, such as shown in FIGS. 2D and 3D. Alternatively or additionally, for some applications, sampling device 1620 is configured such that filter-collection receptacle 1650 is decouplable from filtration assembly 1624 without any proximal withdrawal of plunger head 1642 within tubular container 1630, also such as shown in FIGS. 2D and 3D.

Filter-collection receptacle 1650 is disengageably coupled to filtration assembly 1624. Once filter-collection receptacle 1650 has been decoupled from filtration assembly 1624, a diagnostic test may be performed for the presence of particulate trapped by filter 60, which is now in filter-collection receptacle 1650. For some applications, such as for transporting filter-collection receptacle 1650 to a remote diagnostic laboratory, sampling device 1620 further comprises filter-collection receptacle cap, which is configured to seal receptacle opening 1652.

For some applications, filter-collection receptacle 1650 is disengageably coupled to plunger 1640. Such as described hereinbelow, once filter-collection receptacle 1650 has been removed from plunger 1640, a diagnostic test may be performed for the presence of particulate trapped by filter 60, which is now in filter-collection receptacle 1650. For some applications, such as for transporting filter-collection receptacle 1650 to a remote diagnostic laboratory, sampling device 1620 further comprises a filter-collection receptacle cap, which is configured to seal receptacle opening 1652.

Reference is still made to FIGS. 1A-4. For some applications, such as shown in FIGS. 3A-4, sampling device 1620 comprises a withdrawer 1692, which comprises a filter-withdrawal shaft 1672. Filter-withdrawal shaft 1672:
is disposed partially within filter-collection receptacle 1650 within internal plunger space 1686,
includes a proximal portion 1687 that is slidably disposed passing through a shaft-passage hole 1609 through an end 1604 of filter-collection receptacle 1650 opposite receptacle opening 1652 (labeled in FIG. 4), and
includes a distal portion 1608 (labeled in FIG. 4) that is coupled or couplable (directly or indirectly) to filter 60, typically via an end 1604 of filter-collection receptacle 1650 opposite a receptacle opening 1652.

Sampling device 1620 is configured such that proximal movement (e.g., withdrawal) of filter-withdrawal shaft 1672, while plunger head 1642 (and typically filter support 1662) remains within tubular container 1630, collects filter 60 in filter-collection receptacle 1650 by pulling filter 60 at least partially into (such as entirely into) filter-collection receptacle 1650 via plunger-head opening 1644 (which, as mentioned above, is defined by the central opening of filter support 1662) via receptacle opening 1652 (as shown in the transitions between FIGS. 2B and 2C and between FIGS. 3B and 3C). At least a portion of filter 60 is typically bunched up within filter-collection receptacle 1650, such as into a flower-like arrangement, from the filter's initial flat shape while disposed on filter support 1662.

Typically, sampling device 1620 is configured such that further proximal withdrawal of filter-withdrawal shaft 1672 out of internal plunger space 1686, while plunger head 1642 (and typically filter support 1662) remains within tubular container 1630, pulls filter-collection receptacle 1650 out of internal plunger space 1686 via plunger-space proximal opening 1690 (as shown in the transitions between FIGS. 2C and 2D and between FIGS. 3C and 3D). It is noted that filter-withdrawal shaft 1672 of sampling device 1620 is not an element of filtration assembly 1624, but instead is removable therefrom, as shown in FIGS. 2D and 3D.

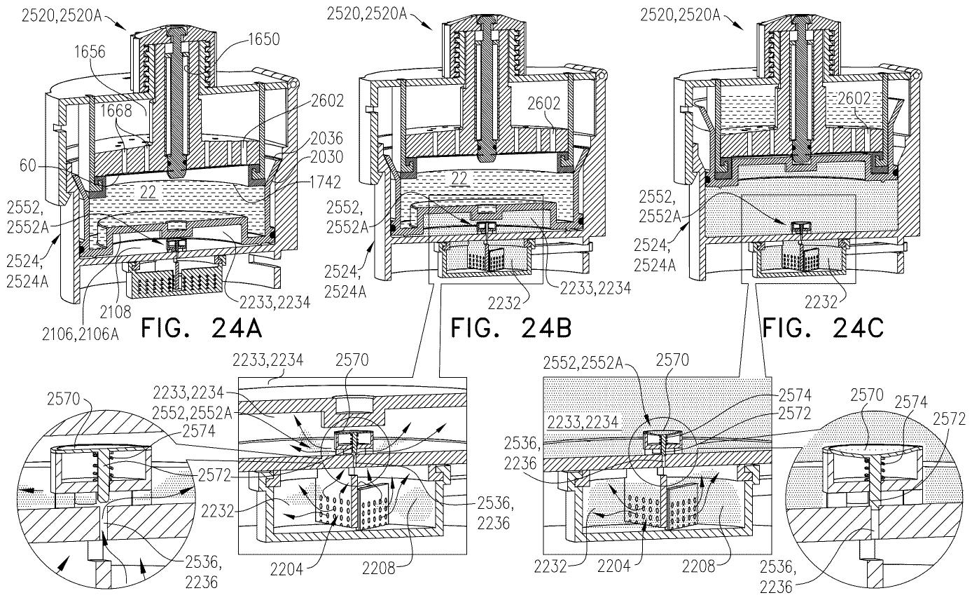

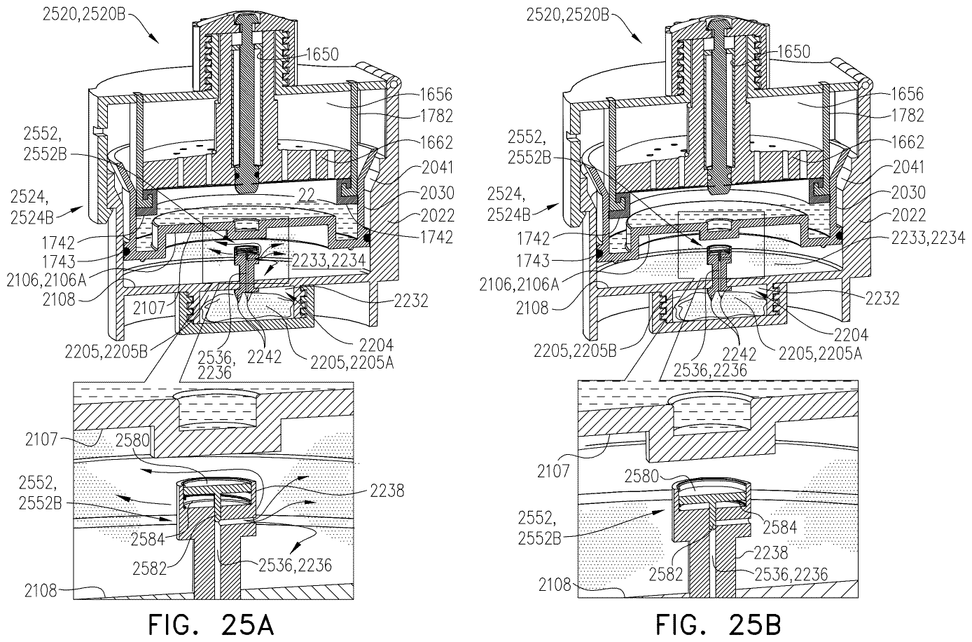

For some applications, distal portion 1608 of filter-withdrawal shaft 1672 is coupled to filter 60 before use of filter 60 (typically during manufacture), while for other applications, distal portion 1608 of filter-withdrawal shaft 1672 is couplable to filter 60 during use of filter 60, such as, by way of example and not limitation, described in above-mentioned PCT Publication WO 2023/131948 with reference to FIGS. 25A-E and 26A-E thereof.

For some applications, sampling device 1620 comprises a distal plate 1671 (labeled in FIG. 3A), which is disposed in contact with a distal surface of filter 60, and is coupled (directly or indirectly) to filter-withdrawal shaft 1672 through end 1604 of filter-collection receptacle 1650. For example, distal plate 1671 may be circular, i.e., shaped as a disc, or any other shape. Distal plate 1671 may be flexible, e.g., comprise silicone, or may be rigid, e.g., comprise metal or a polymer.

For some applications, withdrawer 1692 further comprises a shaft handle 1605, which is coupled to a proximal portion of filter-withdrawal shaft 1672. Optionally, shaft handle 1605 is shaped as a wing nut.

For some applications, filtration assembly 1624 (e.g., plunger-space proximal opening 1690 and/or plunger support 1658) and withdrawer 1692 (either shaft handle 1605 or filter-withdrawal shaft 1672) are shaped so as to define corresponding screw threads 1623A and 1623B (e.g., female and male screw threads 1623A and 1623B) (labeled in FIG. 3D), respectively, which (a) removably couple filter-withdrawal shaft 1672 to plunger rod 1682, such as shown in FIG. 3B, while filter-withdrawal shaft 1672 is disposed passing through internal plunger space 1686, and (b) prevent the premature proximal withdrawal of filter-withdrawal shaft 1672 out of internal plunger space 1686. Sampling device 1620 is configured such that rotation of filter-withdrawal shaft 1672 and plunger-space proximal opening 1690 with respect to each other (a) causes at least an initial portion of the proximal withdrawal of filter-withdrawal shaft 1672 out of internal plunger space 1686, such as shown in the transition between FIG. 3B and FIG. 3C, and (b) decouples female and male screw threads 1623A and 1623B from each other, thereby allowing the continuation of the proximal withdrawal of filter-withdrawal shaft 1672 out of internal plunger space 1686, such as shown in FIGS. 3C-D. Alternatively, shaft handle 1605 may be shaped so as to define screw thread 1623B, such as described hereinbelow regarding shaft handle 1805 and withdrawer 1892, mutatis mutandis.

Optionally, in configurations in which plunger support 1658 and/or plunger 1640 and tubular container 1630 are threadingly coupled to each other, (a) the threading between plunger-space proximal opening 1690 and filter-withdrawal shaft 1672 or shaft handle 1603 and (b) the threading between plunger 1640 and tubular container 1630 have opposite handedness.

For other applications, filtration assembly 1624 and filter-withdrawal shaft 1672 are not threadingly coupled together, and plunger-space proximal opening 1690 and shaft handle 1605 are not threadingly coupled together.

Reference is made to FIGS. 2D, 3A-F, and 4. For some applications, sampling device 1620 further comprises a seal 1614 that inhibits fluid leakage between proximal portion 1687 of filter-withdrawal shaft 1672 and shaft-passage hole 1609.

Optionally, an inner portion of seal 1614 may snap into an external circumferential groove of proximal portion 1687 of filter-withdrawal shaft 1672 upon the proximal withdrawal of most or all of filter-withdrawal shaft 1672 from filter-collection receptacle 1650, such as shown in FIG. 4.

Reference is again made to FIGS. 1A-4. As described hereinabove, filter-withdrawal shaft 1672 include distal portion 1608 that is directly or indirectly coupled to filter 60. Exemplary ways in which the distal portion of the filter-withdrawal shaft may be directly or indirectly coupled to filter 60 include, but are not limited to:
the distal portion of filter-withdrawal shaft 1672 may be directly coupled to filter 60, such as shown in FIG. 4, e.g., by an adhesive and/or by distal plate 1671 (labeled in FIG. 3A, which may be fixed, e.g., pinned, to the distal end of the distal portion of filter-withdrawal shaft 1672; in these configurations, the distal portion of the filter-withdrawal shaft passes through the end of the filter-collection receptacle opposite the receptacle opening; and
the distal portion of filter-withdrawal shaft 1672 may be indirectly coupled to the filter, such as shown in FIG. 4, e.g., by a rod 1679 (labeled in FIG. 4) that (a) is fixed to the distal end of the distal portion of filter-withdrawal shaft 1672 and (b) passes through the end of the filter-collection receptacle opposite the receptacle opening, and optionally further by an adhesive and/or by distal plate 1671 which may be integral with rod 1679 or fixed to rod 1679.

It will be appreciated by persons skilled in the art who have read the present application that the distal portions of filter-withdrawal shaft 1672 may be directly or indirectly coupled to the filter in additional ways, all of which are within the scope of the present invention.

Optionally, filter-withdrawal shaft 1672 is coupled to filter 60 in ways described hereinbelow with reference to FIGS. 36 and 37.

Reference is now made to FIGS. 3E-I. For some applications, the method optionally continues as shown in FIGS. 3E-I. By way of example and not limitation, filter-collection receptacle 1650 is shown as being shorter in FIGS. 3E-I than in FIGS. 1A-3D. In actual use, the filter-collection receptacle has the same length throughout its use, i.e., the same length in FIGS. 1A-3D as in FIGS. 3E-I. If the filter-collection receptacle is shorter than shown in FIGS. 1A-3D, the filter-collection receptacle occupies only a proximal portion of internal plunger space 1686.

As shown in FIGS. 3E-F, filter-collection receptacle 1650 is inserted at least partially into an extraction tube 1718, and distally advanced within extraction tube 1718 until bunched-up filter 60 is positioned near a distal end 1751 of extraction tube 1718 opposite a proximal end opening 1721. Extraction tube 1718 is shaped so as to prevent filter-collection receptacle 1650 from reaching distal end 1751 of extraction tube 1718, such that filter-collection receptacle 1650 slides up a portion of filter-withdrawal shaft 1672 as bunched-up filter 60 is positioned near distal end 1751, thereby ejecting bunched-up filter 60 from receptacle opening 1652 of filter-collection receptacle 1650 and exposing bunched-up filter 60 to a liquid 1030, such as described hereinbelow, within the distal portion of extraction tube 1718.

This technique may aid with the insertion of bunched-up filter 60 into extraction tube 1718. Filter-collection receptacle 1650 is readily inserted into extraction tube 1718, thereby inserting bunched-up filter 60 into extraction tube 1718 while the bunched-up filter is initially within filter-collection receptacle 1650. Filter-collection receptacle 1650 also may serve to cover and/or shield bunched-up filter 60 when filter 60 is exposed to the environment, such as before insertion into extraction tube 1718 and/or after optional removal from extraction tube 1718, such as described hereinbelow with reference to FIG. 3J, or in above-mentioned PCT Publication WO 2023/131948 with reference to FIGS. 32G and 34D thereof; in this sense, filter-collection receptacle 1650 may also function as a sleeve for covering and/or shielding bunched-up filter 60.

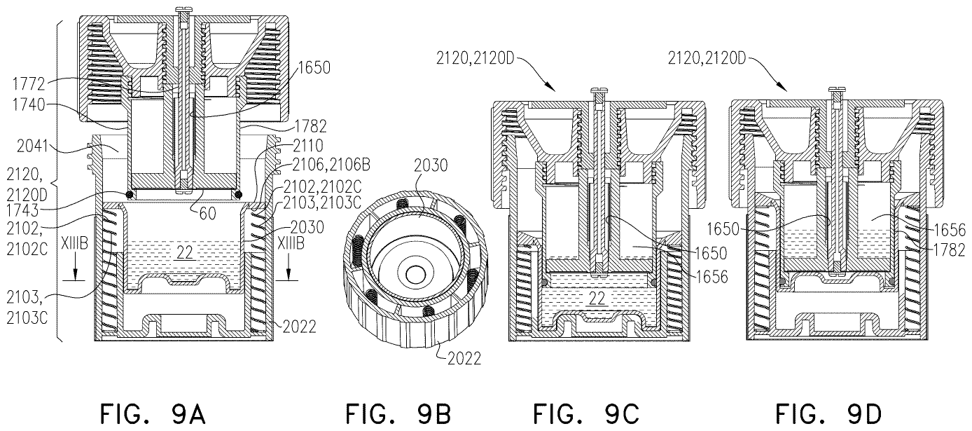

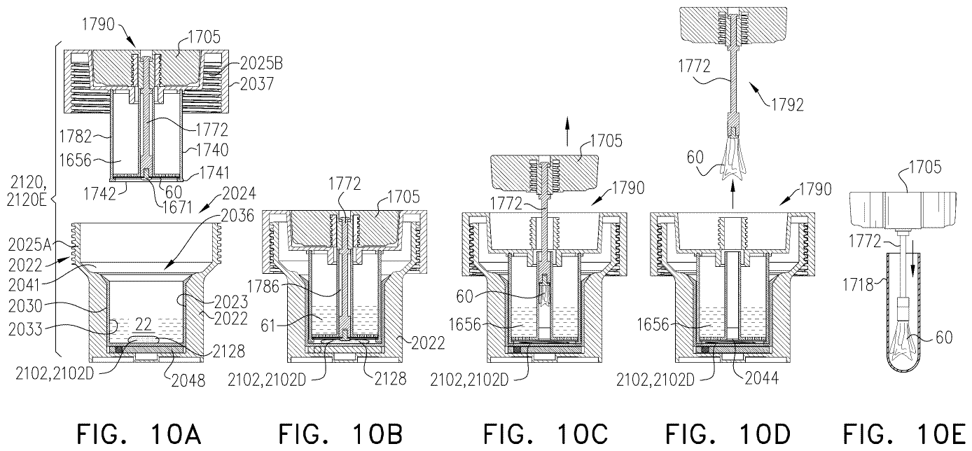

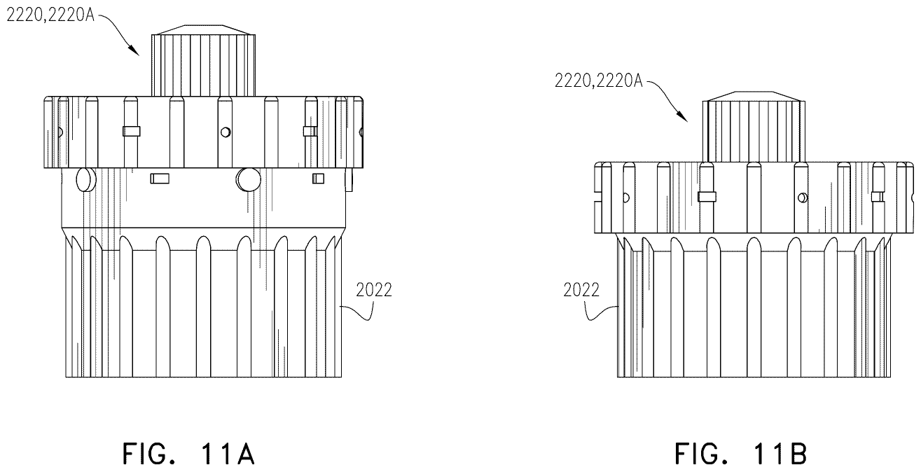

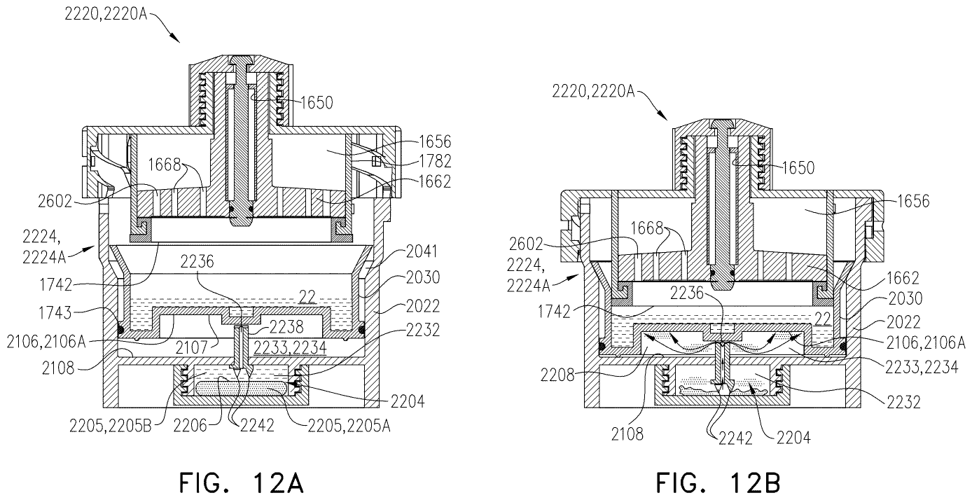

Optionally, as shown in FIGS. 3E-H, extraction tube 1718 may comprise a screw-off distal tip cap 1749 that removably seals distal end 1751 of extraction tube 1718 opposite proximal end opening 1721. The liquid within extraction tube 1718 may be expelled (e.g., squeezed or dripped out) of extraction tube 1718, such as described hereinbelow with reference to FIG. 3I, or in above-mentioned PCT Publication WO 2023/131948 with reference to FIGS. 9C-D thereof.

For some applications, such as shown in FIG. 3G, while bunched-up filter 60 is exposed to liquid 1030 in extraction tube 1718, filter 60 is squeezed (e.g., by squeezing flexible extraction tube 1718) at least one time without expelling any of liquid 1030 from extraction tube 1718. Screw-off distal tip cap 1749, if provided, is then removed from extraction tube 1718, such as shown in FIG. 3H.

For some applications, extraction tube 1718 is oriented horizontally (rather than vertically) during all or a portion of the exposure of bunched-up filter 60 to liquid 1030 in extraction tube 1718. For example, filter 60 may be rotated in extraction tube 1718, optionally while only partially immersed in liquid 1030.

As shown in FIG. 3I, liquid 1030 within extraction tube 1718 is expelled (e.g., squeezed or dripped out) from extraction tube 1718, such as onto a sample pad 1797 of a lateral flow test strip 1799, such as a lateral flow immunoassay test strip. Alternatively, lateral flow test strip 1799 may comprise another type of lateral flow test strip, such as a CRISPR/Cas9-based lateral flow assay. Optionally, liquid 1030 is expelled from extraction tube 1718 by squeezing extraction tube 1718 at least one time, so as to both squeeze a portion of liquid 1030 from filter 60 and expel the portion of the liquid from the extraction tube. In the technique illustrated in FIG. 3I, liquid 1030 within extraction tube 1718 is expelled from extraction tube 1718 while filter 60 remains within extraction tube 1718.

The techniques of FIG. 3E, FIG. 3F, FIG. 3G, FIG. 3H, and/or FIG. 3I may optionally be implemented in combination with the techniques of any of the sampling devices described herein.

For some applications, filter-collection receptacle 1650 is flexible. Bunched-up filter 60 is exposed to liquid 1030 in extraction tube 1718, as described above. The bunched-up filter is then withdrawn from extraction tube 1718 and pulled at least partially into filter-collection receptacle 1650 via receptacle opening 1652, by proximally moving filter-withdrawal shaft 1672 with respect to filter-collection receptacle 1650. Thereafter, the bunched-up portion of filter 60 is squeezed by squeezing filter-collection receptacle 1650, while at least a portion of the bunched-up filter 60 is covered and/or shielded by filter-collection receptacle 1650, to squeeze a portion of liquid 1030 from filter 60 (configuration not shown).

Reference is made to FIGS. 3J-K. The step illustrated in FIG. 3J may optionally be performed after the step illustrated in FIG. 3F or after the step illustrated in FIG. 3G (i.e., with or without squeezing filter 60 while it is in extraction tube 1718). After bunched-up filter 60 has been exposed to liquid 1030 in extraction tube 1718 (typically bathed in liquid 1030 for a certain amount of time), filter-withdrawal shaft 1672 is withdrawn from extraction tube 1718. This proximal movement of filter-withdrawal shaft 1672 with respect filter-collection receptacle 1650 pulls filter 60 at least partially into (such as entirely into) filter-collection receptacle 1650 via receptacle opening 1652.

For some applications, bunched-up filter 60 is removed from extraction tube 1718 while extraction tube 1718 is squeezed. For example, extraction tube 1718 may be squeezed before removing bunched-up filter 60, such as shown in FIG. 3G, and extraction tube 1718 may continue to be squeezed during removal of bunched-up filter 60 from extraction tube 1718.

For some applications, after removal of filter 60 from extraction tube 1718, liquid 1030 is tested for the presence of a target analyte released into liquid 1030 from particulate trapped by filter 60. For example, a lateral flow test strip, such as a lateral flow immunoassay test strip, optionally implemented as a dipstick 1757, may be inserted into liquid 1030 in extraction tube 1718, such as shown in FIG. 3K.

Alternatively, the step illustrated in FIG. 3J may be followed by the techniques of FIGS. 32H-K, 34E-F, or 35A-D of above-mentioned PCT Publication WO 2023/131948.

The techniques of FIG. 3J and/or FIG. 3K may optionally be implemented in combination with the techniques of any of the sampling devices described herein.

Alternatively, such as described in above-mentioned PCT Publication WO 2023/131948 with reference to FIG. 32H-K or 34E-F thereof, after bunched-up filter 60 is exposed to liquid 1030 in extraction tube 1718 (typically bathed in liquid 1030 for a certain amount of time), filter-collection receptacle 1650 is removed from extraction tube 1718, and filter 60 is squeezed to partially release the portion of liquid 1030 from filter 60, such as onto sample pad 1797 of lateral flow test strip 1799, such as a lateral flow immunoassay test strip. Alternatively, filter 60 is squeezed by squeezing flexible filter-collection receptacle 1650 (configuration not shown).

Reference is again made to FIG. 3J. For some applications, after bunched-up filter 60 is bathed in liquid 1030 within extraction tube (and optionally squeezed within extraction tube 1718), a portion of liquid 1030 is discarded, such as by draining the portion of liquid 1030 from extraction tube 1718. For example, extraction tube 1718 may have the configuration described hereinabove with reference to FIGS. 3E-H, and screw-off distal tip cap 1749 may be removed from extraction tube 1718, such as shown in FIG. 3H, in order to discard the portion of liquid 1030.

For some applications, liquid specimen sample 22 is received from a subject's mouth. For some applications, liquid specimen sample 22 comprises gargled fluid, i.e., a gargle fluid that the subject has gargled in his or her mouth and spit out, perhaps along with some saliva. In the present application, including in the claims and Inventive Concepts, “gargled fluid” means “gargle fluid” that has been gargled by a subject. Typically, the gargle fluid includes water, carbonated water, saline (e.g., phosphate buffered saline), pelargonium sidoides extract, tannic acid, balloon flower platycodon grandiflorus, berberine sulfate, S-carboxymethylcysteine, curcumin, coloring, flavoring, a detergent (such as Polysorbate 20 (e.g., Tween® 20)), or any combination thereof. In some applications, the gargle fluid is carbonated. Alternatively or additionally, for some applications, a detergent, such as Polysorbate 20 (e.g., Tween® 20) is added to the gargled fluid after being gargled by the subject. Alternatively, liquid specimen sample 22 may comprise another type of biological fluid, such as blood (e.g., diluted blood), urine, stool (e.g., diluted stool), gastrointestinal (GI) fluid, or bronchoalveolar lavage fluid.

Alternatively, liquid specimen sample 22 comprises saliva not swabbed from the throat of a subject (i.e., the saliva was collected without swabbing the subject's throat). (The distinction between “swab” as a verb and as a noun is noted. A “swab” (as a noun) may be used to obtain saliva without “swabbing” (as a verb) the subject's throat. For example, the subject may suck on a swab, or a swab may be dipped in a container into which gargle fluid or saliva has been placed.) By contrast, in commonly-practiced techniques for testing for strep, the tonsils are swabbed. Further alternatively, liquid specimen sample 22 comprises liquid from a cultured medium containing a biological sample which had been incubated within tubular container 30 or incubated separately from the device and then added to tubular container 30.

Liquid specimen sample 22 (e.g., saliva) may be spit directly by the subject into tubular container 30 or transferred by a healthcare worker from another container into which the subject spit. Alternatively, in the case of saliva, the saliva may be collected from the subject's mouth by having the subject suck on a swab or other absorbent collecting element, such as flocked swabs or cotton rolls.

For some applications in which the method does not comprise swabbing the throat of the subject, liquid specimen sample 22 is collected by drawing liquid specimen sample 22 out of an oral cavity of the subject via an anterior opening of the oral cavity by contacting one or more portions of the oral cavity with an absorbent material, e.g., a flocked or cotton swab, or a sponge (e.g., at a tip of a collector shaft), without swabbing the oropharynx of the subject. (For example, an ORAcollect®.RNA Saliva Collection Device (DNA Genotek Inc., a subsidiary of OraSure Technologies, Inc. (Bethlehem, PA, USA)) may be used.) Optionally, the absorbent material is located on a tip of a collector shaft, and liquid specimen sample 22 is drawn out of the oral cavity via the anterior opening of the oral cavity using the absorbent material by inserting the tip of the collector shaft into the oral cavity. For some of these applications, liquid specimen sample 22 is drawn out of the oral cavity via the anterior opening of the oral cavity using the absorbent material by the subject sucking on the absorbent material. For example, the one or more portions of the oral cavity may include one or more of buccal mucosa, the tongue (e.g., under the tongue), the gums (e.g., the lower gums), and/or the palatal mucosa. For example, for swabbing the lower gums, absorbent material (e.g., at a tip of a collector shaft) may be rubbed back and forth along the lower gums several times. (The anterior opening of the oral cavity is the opening of the mouth between the lips, between outside the oral cavity and inside the oral cavity.)

Alternatively, liquid specimen sample 22 comprises an incubated culture medium containing a biological sample.

Reference is still made to FIGS. 1A-4. In some applications of the present invention, a method for concentrating liquid specimen sample 22 is provided. The method comprises:
placing liquid specimen sample 22 in tubular container 1630 of filtration assembly 1624, such as shown in FIGS. 2A and 3A;
inserting plunger head 1642 of plunger 1640 into tubular container 1630 via proximal container opening 1632 of tubular container 1630, such as shown in the transition between FIGS. 2A and 2B and between FIGS. 3A and 3B;
distally advancing plunger head 1642 within tubular container 1630 to drive at least a portion of liquid specimen sample 22 through filter 60 disposed in tubular container 1630, such as shown in FIGS. 2B and 3B (it is noted that in this configuration, filter 60 is not initially disposed in tubular container 1630 when liquid specimen sample 22 is placed in tubular container 1630, and is inserted into tubular container 1630 as plunger head 1642 is inserted into tubular container); and
removing filter 60 from tubular container 1630 via plunger-space proximal opening 1690 while plunger head 1642 and filter support 1662 remain within tubular container 1630, as shown in FIGS. 2C-D and 3C-D.

For some applications, liquid specimen sample 22 may be acquired and/or may have any of the characteristics described hereinabove.

For some applications, the method further comprises sealing receptacle opening with a filter-collection receptacle cap after filter 60 has been advanced into filter-collection receptacle 1650.

For some applications, the method further comprises, after filter 60 has been removed from tubular container 1630, detecting the presence of a biological particulate trapped by filter 60. For example, the biological particulate may be selected from the group consisting of: a virus, a bacterium, a microorganism, a fungus, a spore, a mite, a biological cell, a biological antigen, a protein, a protein antigen, and a carbohydrate antigen.

For some applications, such as shown in FIGS. 3I and 3K, detecting the presence of the biological particulate trapped by filter 60 comprising using lateral flow test strip 1799 (e.g., a lateral flow immunoassay test strip) to detect the presence of the biological particulate trapped by filter 60. The lateral flow test strip is optionally contained in a housing 1710 (e.g., comprising a cartridge 1789 (also known as a cassette) or a card 3294, such as described hereinbelow with reference to FIGS. 34E-F of above-mentioned PCT Publication WO 2023/131948), or implemented as a dipstick 1757, as is known in the lateral flow art, such as shown in FIG. 3K.

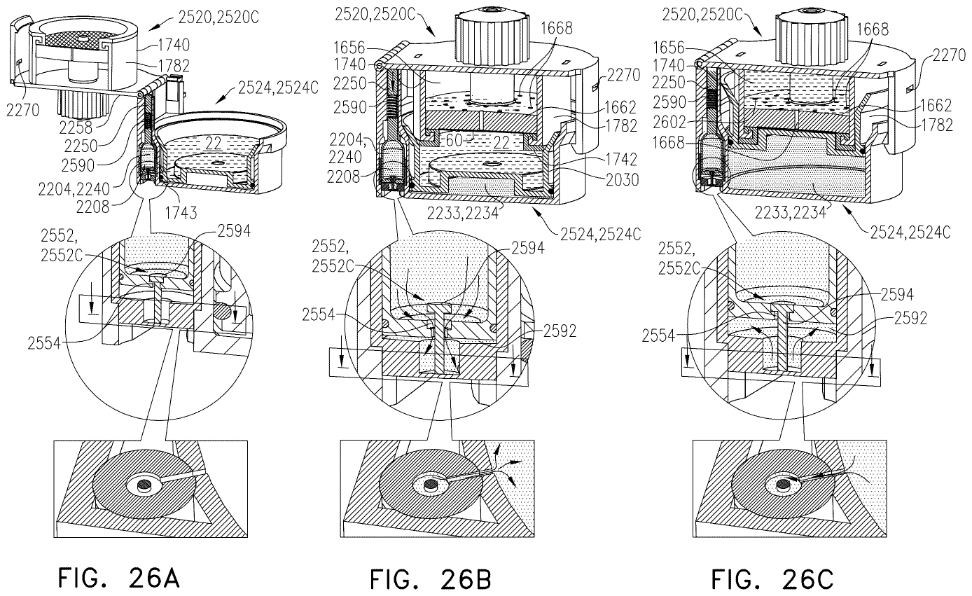

For some applications, filter-withdrawal shaft 1672 is not pre-coupled to filter 60 (configuration not shown, but optionally may be similar to the configuration described hereinbelow with reference to FIGS. 26A-E of above-mentioned PCT Publication WO 2023/131948, mutatis mutandis). Instead, the filter-withdrawal shaft is advanced within internal plunger space 1686 (and optionally inserted into internal plunger space 1686) and coupled to filter 60 after plunger 1640 has been inserted into tubular container 1630 (and optionally been moved within tubular container 1630 to push the at least a portion of liquid specimen sample 22 through filter 60).

For some applications, the method further comprises bathing filter 60 with liquid 1030 within filter-collection receptacle 1650 (or extraction tube 1718, if provided) after filter 60 has been advanced into filter-collection receptacle 1650 (and into extraction tube 1718, if provided). For example, the liquid 1030 may be selected from the group consisting of: a lysis buffer, an extraction buffer, saline solution, a transport medium, and one or more reagents, such as one or more reagents for use in a lateral flow test.

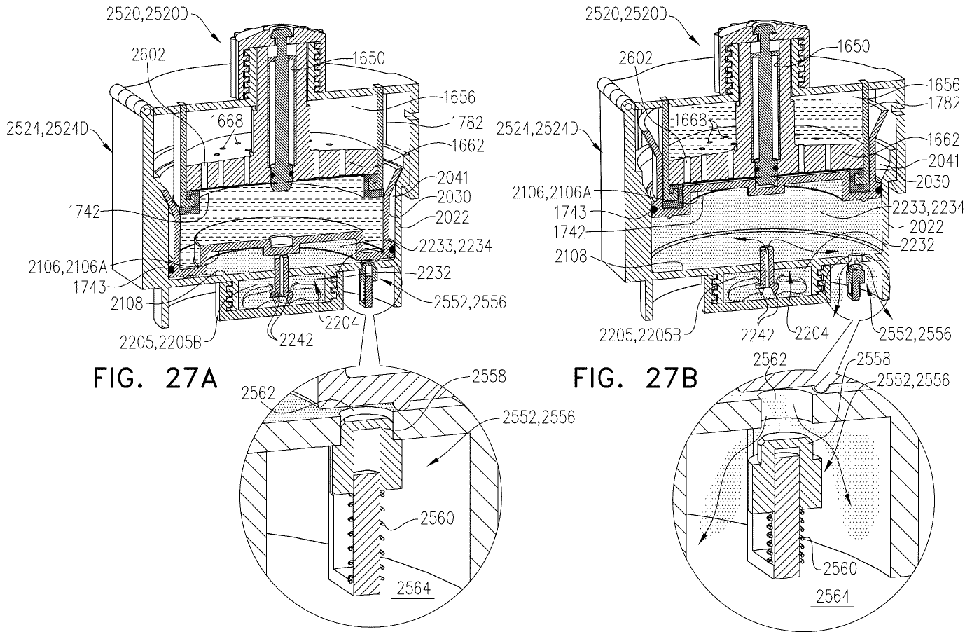

In any of the applications of the present invention described herein, liquid 1030 may comprise two or more liquids that are combined (and optionally mixed together), a solid (e.g., a powder) and a liquid that are combined (and optionally mixed together), or two solids (e.g., two powders) that are combined (and optionally mixed together), typically during the testing procedure, for example as described in above-mentioned International Application PCT/IL2023/050728 with reference to FIGS. 27A-C thereof, or as described in above-mentioned PCT Publication WO 2023/131948 with reference to FIGS. 32B and 34A thereof. In any of the applications of the present invention described herein, liquid 1030 may comprise one or more liquids that are combined with a solid, such as a powder (and optionally mixed together), typically during the testing procedure; for example, the powder may be provided contained within one of the tubes described herein, such as one of the extraction tubes described herein.

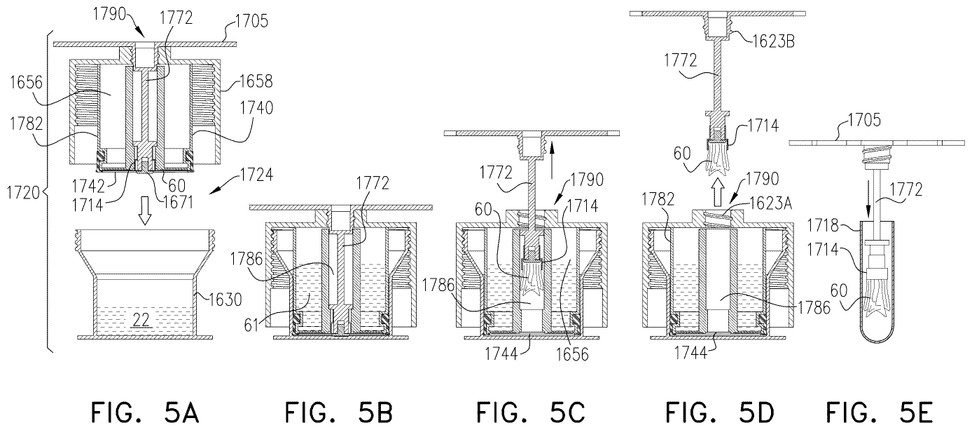

Reference is now made to FIGS. 5A-E, which are schematic cross-sectional illustrations of a sampling device 1720 for concentrating liquid specimen sample 22 and a method of using sampling device 1720, in accordance with respective applications of the present invention. Other than as described hereinbelow, sampling device 1720 is generally similar to sampling device 1620 described hereinabove with reference to FIGS. 1A-3D, and may implement any of the features thereof, mutatis mutandis. Like reference numerals refer to like parts.

Similar to sampling device 1620, sampling device 1720 typically comprises a filtration assembly 1724, which may have any of the properties described hereinabove. Filtration assembly 1724 comprises tubular container 1630, a plunger 1740, and filter 60, which may have any of the properties described hereinabove with reference to FIGS. 1A-3D. However, sampling device 1720 does not comprise a filter-collection receptacle configured or disposed in a similar manner to filter-collection receptacle 1650. Nevertheless, sampling device 1720 may optionally comprise extraction tube 1718, such as described hereinbelow with reference to FIG. 5E.

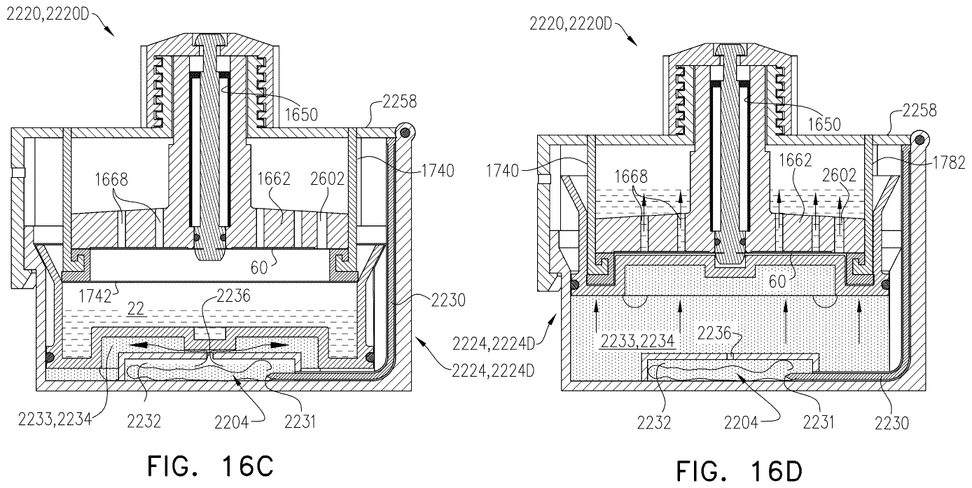

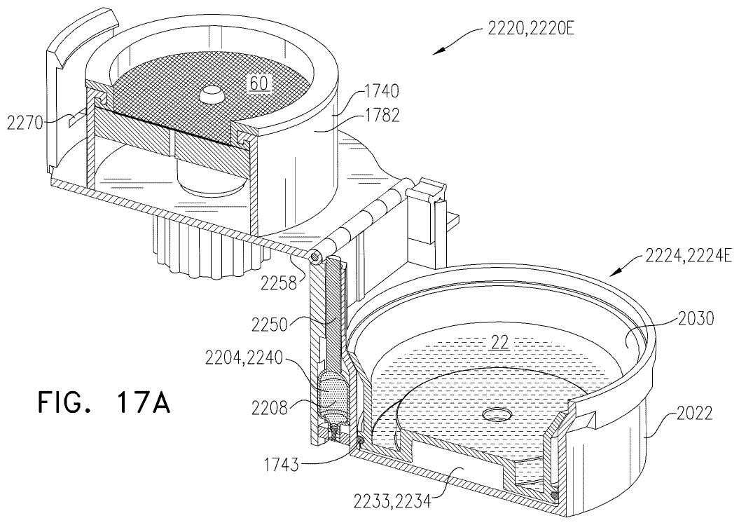

Typically, but not necessarily, after filter-withdrawal shaft 1772 and filter 60 have been removed from filtration assembly 1724, filter 60 and at a portion of filter-withdrawal shaft 1772 are inserted into extraction tube 1718, such as shown in FIG. 5E. As mentioned below, the bunching up of at least a portion of filter 60 may help facilitate this insertion; in some respects, the bunched-up filter may function somewhat analogously to a conventional swab. One or more reagents may also be placed in the extraction tube 1718, before or after insertion of filter 60, as known in the diagnostic testing arts. Optionally, extraction tube 1718 implements all or a portion of the techniques described hereinabove with reference to FIGS. 16A-C in PCT Publication WO 2022/149135 to Feldman et al., mutatis mutandis.

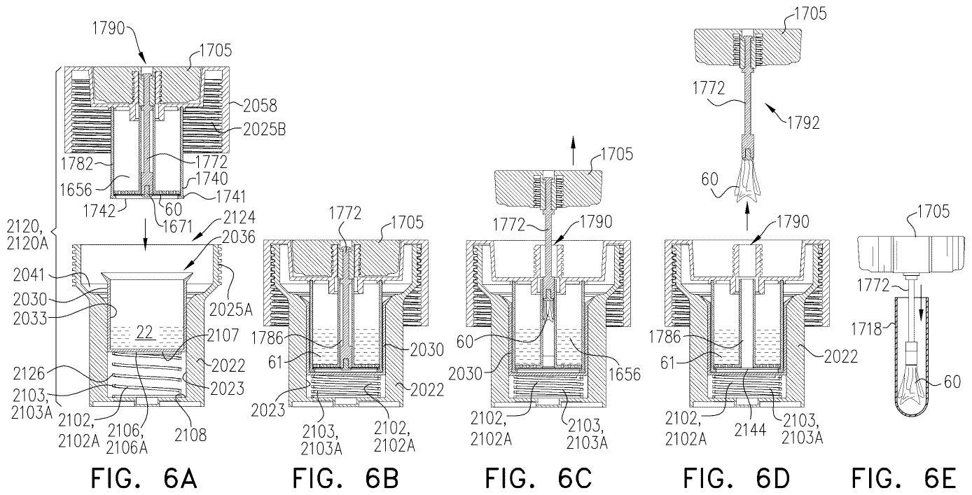

Reference is now made to FIGS. 6A-E, which are schematic cross-sectional illustrations of a sampling device 2120, 2120A for concentrating liquid specimen sample 22 and the method of using sampling device 2120, 2120A, in accordance with respective applications of the present invention.

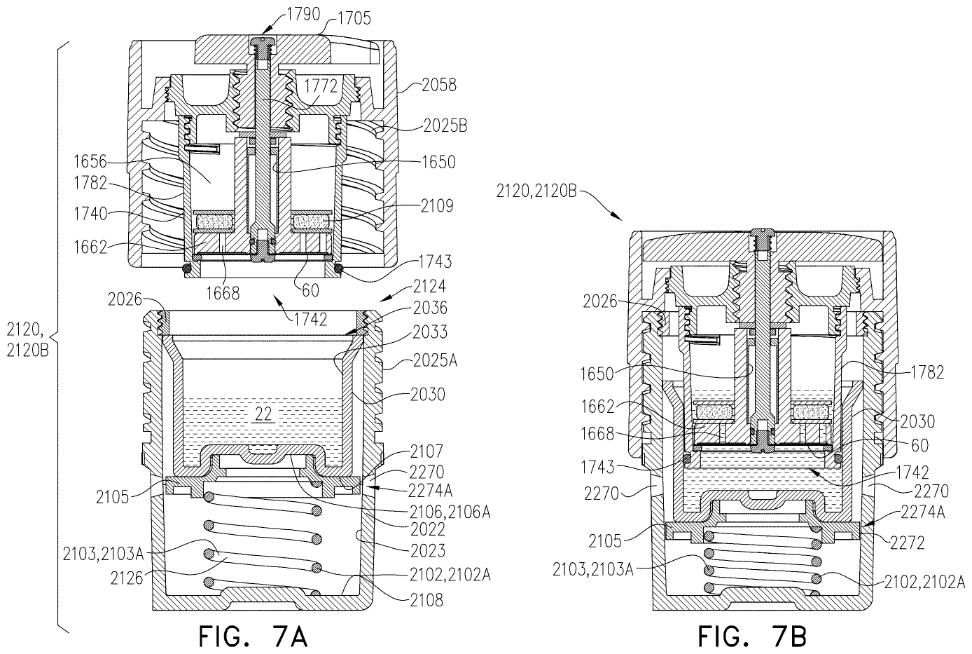

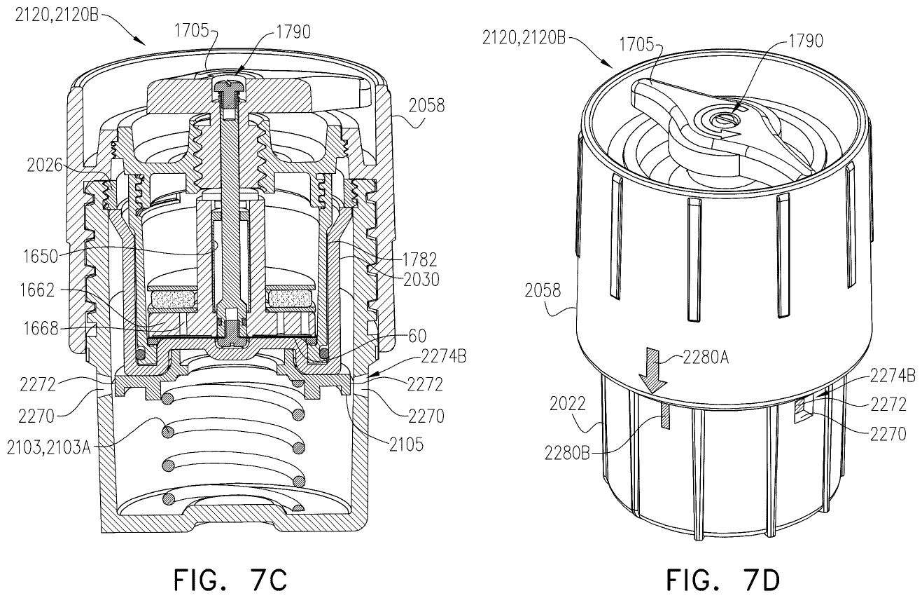

Reference is further made to FIGS. 7A-D, which are schematic illustrations of a sampling device 2120, 2120B and a method of using sampling device 2120, 2120B, in accordance with respective applications of the present invention.

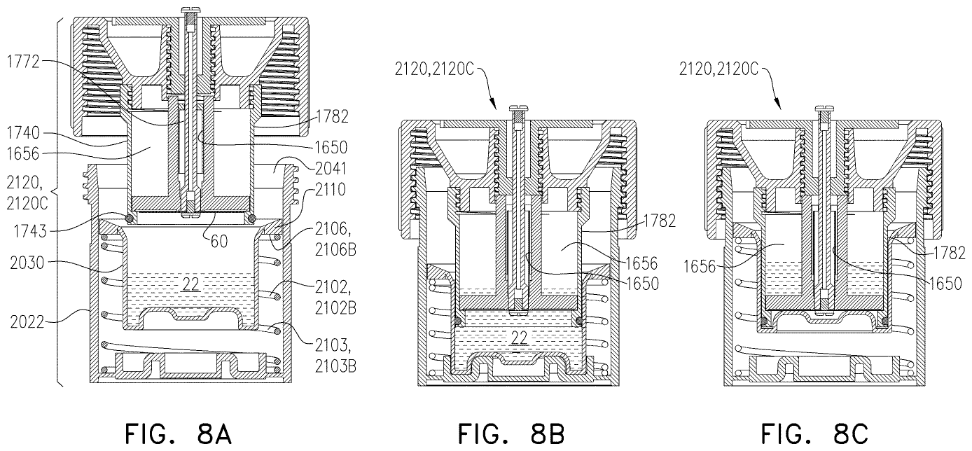

Reference is additionally made to FIGS. 8A-C, which are schematic cross-sectional illustrations of a sampling device 2120, 2120C and a method of using sampling device 2120, 2120C, in accordance with respective applications of the present invention.

Reference is yet additionally made to FIGS. 9A-D, which are schematic cross-sectional illustrations of a sampling device 2120, 2120D and a method of using sampling device 2120, 2120D, in accordance with respective applications of the present invention.

Reference is also made to FIGS. 10A-E, which are schematic cross-sectional illustrations of a sampling device 2120, 2120E and a method of using sampling device 2120, 2120E, in accordance with respective applications of the present invention.

Other than as described hereinbelow, sampling device 2120, in all of the above-mentioned configurations, is generally similar to sampling device 1720 described hereinabove with reference to FIGS. 5A-E, and may implement any of the features thereof, mutatis mutandis. Like reference numerals refer to like parts. Alternatively or additionally, the features of sampling device 2120 may be implemented in combination with any of the other sampling devices described herein, mutatis mutandis, including, but not limited to sampling device 1620, described hereinabove with reference to FIGS. 1A-3D, and/or sampling device 1720, described hereinabove with reference to FIGS. 5A-E. For example, sampling device 2120 may optionally comprise filter-collection receptacle 1650, as shown in FIGS. 7A-C, 8A-C, and 9A-D, and sampling device 2120 may be configured such that filter 60 is advanceable into (e.g., entirely into) filter-collection receptacle 1650 via receptacle opening 1652 while filter-collection receptacle 1650 is disengageably coupled to the filtration assembly, such as described hereinabove with reference to FIGS. 2C and 3C.

Sampling device 2120 comprises a filtration assembly 2124 that comprises a container housing 2022, which is shaped so as to define a cylindrical space 2023 within container housing 2022. Optionally, container housing 2022 is also shaped so as to define one or more first threads 2025A. Typically, the threads are configured to provide 1-2 turns, such as 1-1.5 turns.

Filtration assembly 2124 comprises, instead of tubular container 1630, a tubular container 2030, which is shaped so as to define an inner wall 2033 and a proximal container opening 2036 for receiving liquid specimen sample 22. Inner wall 2033 is typically not threaded, so as to make a good seal with a plunger head 1742; alternatively, the inner wall is threaded. Tubular container 2030 is disposed at least partially within cylindrical space 2023 of container housing 2022. Tubular container 2030 may or may not be rotatable with respect to cylindrical space 2023. Tubular container 2030 may be cylindrical, as shown, or may alternatively have another, non-circular cross-sectional shape.

Filtration assembly 2124 further comprises a plunger support 2058, which is coupled to a proximal portion of plunger 1740, and which is shaped so as to define one or more second threads 2025B, shaped so as to engage the one or more first threads 2025A. The one or more first threads 2025A and/or the one or more second threads 2025B may each be a single entire thread, or a plurality of thread segments that do or do not include complete turns, such as described, for example, in above-mentioned PCT Publication WO 2023/131948 with reference to FIG. 38 thereof. A portion of plunger support 2058 may serve as a handle to enable easy manipulation of plunger 1740, including insertion of plunger 1740 into tubular container 2030. Optionally, the one or more first threads 2025A define 1-2 turns, such as 1-1.5 turns.

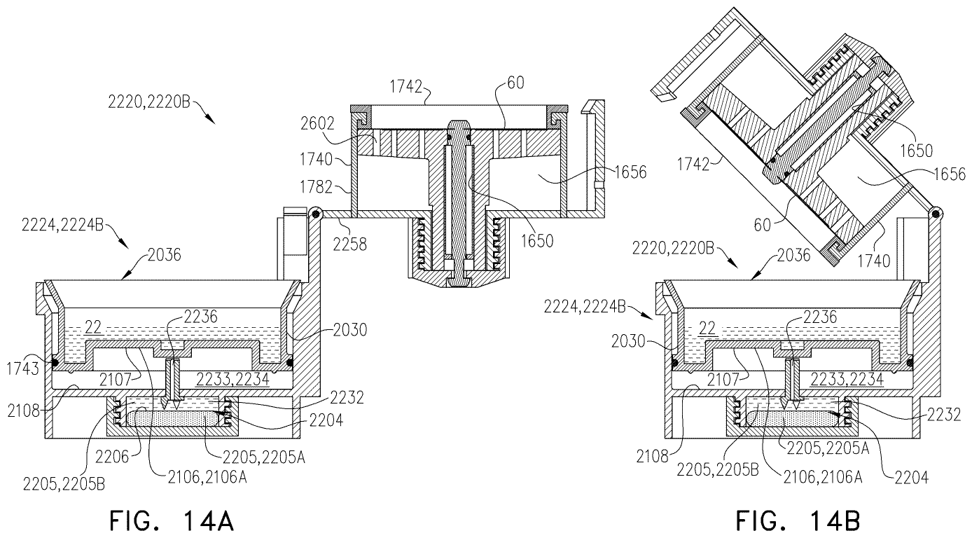

Plunger 1740 is insertable into tubular container 2030 via proximal container opening 2036, such that a lateral surface of plunger head 1742 forms a fluid-tight movable seal with inner wall 2033. To this end, the lateral surface of plunger head 1742 may comprise an elastomeric material, such as natural rubber, synthetic rubber, a thermoplastic elastomer, or a combination thereof, for example at or near a distal end of the lateral surface. For example, plunger head 1742 may be shaped so as to define a radial protrusion 1741 comprising the elastomeric material, such as shown in FIGS. 6A-D and 10A-D, and/or may comprise an O-ring 1743 comprising the elastomeric material, such as shown in FIGS. 7A-C, 8A-D, and 9A-D (and in FIGS. 12A-D, 14A-D, 15A-D, 16A-D, and 17A-C, described hereinbelow).

Plunger 1740 is coupled to plunger support 2058, such that rotation of plunger support 2058 with respect to container housing 2022, when the one or more second threads 2025B are engaged with the one or more first threads 2025A, distally advances plunger support 2058 with respect to container housing 2022 and thus plunger 1740 within tubular container 2030 as tubular container 2030 rotates with respect to container housing 2022.

Filtration assembly 2124 is configured such that movement of plunger head 1742 within tubular container 2030, when liquid specimen sample 22 is contained in tubular container 2030 and filter 60 is disposed in tubular container 2030, pushes at least a portion of liquid specimen sample 22 through filter 60 and into waste liquid receptacle 1656.

For some applications, the one or more first threads 2025A face radially outward, and the one or more second threads 2025B face radially inward, such as show in the figures. For other applications, the one or more first threads 2025A face radially inward, and the one or more second threads 2025B face radially outward (configuration not shown).

Optionally, proximal container opening 2036 is shaped as a funnel, such as shown.

Optionally, container housing 2022 includes a proximal portion 2041 that is proximal to cylindrical space 2023, has a greatest internal diameter that is greater than an internal diameter of cylindrical space 2023, and is shaped so as to define a funnel-shaped portion, such as shown. For example, a distal end of the funnel-shaped portion may be is within 2 cm, such as within 1 cm, of cylindrical space 2023, measured along a central longitudinal axis of cylindrical space 2023.

Sampling device 2120 further comprises an energy storage element 2102. A filtration assembly 2124 of sampling device 2120 is configured such that movement of plunger head 1742 within tubular container 2030, when liquid specimen sample 22 is contained in tubular container 2030 and filter 60 is disposed on support surface 1659 (labeled in FIG. 3A for sampling device 1620):
pushes at least a portion of liquid specimen sample 22 through filter 60 and filtrate-passage openings 1668 and into waste liquid receptacle 1656, and
stores energy in energy storage element 2102.

Energy storage element 2102 may function as a sort of shock absorber in the event that plunger 1740 is advanced within tubular container 2030 more quickly than liquid specimen sample 22 can pass through filter 60. Energy storage element 2102 transiently reduces the pressure that liquid specimen sample 22 is exerting on the filter. Without this technique, the excessive build-up of pressure in liquid specimen sample 22 in tubular container might possibly clog or tear the filter (which may comprise a fine material) and/or liquid specimen sample 22 may escape tubular container 2030 without passing through filter 60 using techniques for fluid escape described herein.

For some applications, the above-described movement of plunger head 1742 within tubular container 2030 that stores energy in energy storage element 2102 may be only minimal movement of plunger head 1742 within tubular container 2030, such as just enough movement for the plunger head to engage the tubular container and slightly move the tubular container.

For some applications, energy storage element 2102 may alternatively or additionally release energy that pushes at least a portion of liquid specimen sample 22 through filter 60 and into waste liquid receptacle 1656, such as shown in FIGS. 7A-C, 8A-C, and 9A-D. In these applications, filtration assembly 2124 is typically configured to push liquid specimen sample 22 through filter 60 at rate that falls within a predetermined range and that is not overly sensitive to the rate at which plunger head 1742 is advanced within tubular container 2030 by the user of the filtration unit.

The energy released by energy storage element 2102 may be:
stored in energy storage element 2102 entirely during advancement of plunger head 1742 within tubular container 2030, such as described hereinbelow with reference to FIGS. 8A-C and 9A-D;
partially pre-stored in energy storage element 2102 prior to advancement of plunger head 1742 within tubular container 2030 and partially stored in energy storage element 2102 during advancement of plunger head 1742 within tubular container 2030, such as described hereinbelow with reference to FIGS. 7A-D; or
entirely pre-stored in energy storage element 2102 prior to advancement of plunger head 1742 within tubular container 2030, such as described hereinbelow with reference to FIGS. 11A-B, 12A-D, 13A-D, 14A-D, 15A-D, 16A-D, and 17A-C with respect to source of gas 2204, mutatis mutandis.

Reference is made to FIGS. 6A-E, 7A-D, 8A-C, 9A-D, and 10A-E. In these configurations, sampling device 2120 further comprises container housing 2022, and tubular container 2030 is disposed at least partially within container housing 2022, such that tubular container 2030 is moveable with respect to container housing 2022, e.g., axially and/or rotationally moveable with respect to container housing 2022. An energy storage element 2102 is disposed within container housing 2022, outside tubular container 2030 and in direct or indirect contact with an external surface 2106 of tubular container 2030, such that movement of plunger head 1742 within tubular container 2030 moves tubular container 2030 with respect to container housing 2022, thereby storing energy in energy storage element 2012. Generally, tubular container 2030 begins to move with respect to container housing 2022 when plunger head 1742 comes in contact with liquid specimen sample 22.

For some applications, energy storage element 2102 comprises a mechanical storage element, which comprises an elastic element 2126, such as a spring 2103 (as shown in FIGS. 6A-E, 7A-D, 8A-C, and 9A-D), a balloon (configuration not shown), or soft beads (e.g., comprising silicone) (configuration not shown), configured to store mechanical energy.

Reference is made to FIGS. 6A-E, 7A-D, 8A-C, and 9A-D. In these configurations, mechanical energy storage element 2102 comprises spring 2103, as follows.

In the configurations shown in FIGS. 6A-E and 7A-D, a mechanical energy storage element 2102, 2102A comprises a spring 2103, 2103A. An external surface 2106, 2106A of tubular container 2030 is defined by a distal end 2107 of tubular container 2030. (Distal end 2107 may be generally flat, such as shown in FIGS. 6A-D, or may have a three-dimensional shape, such as shown in FIGS. 7A-C, 8A-C, 9A-D, 12A-D, 14A-D, 15A-D, 16A-D, and 17A-C.) Spring 2103, 2103A is disposed between external surface 2106, 2106A of tubular container 2030 and a proximally-facing internal surface 2108 of container housing 2022. Spring 2103, 2103A may either directly contact external surface 2106, 2106A, such as shown in FIGS. 6A-E, or indirectly contact external surface 2106, 2106A, such as via a support 2105, such as shown in FIGS. 7A-D. Spring 2103, 2103A may either directly contact proximally-facing internal surface 2108, such as shown in FIGS. 6A-E and 7A-D, or indirectly contact proximally-facing internal surface 2108 (configuration not shown).

For some applications, such as shown in FIG. 7A, mechanical energy storage element 2102, 2102A is pre-loaded, such as slightly pre-loaded, with energy in a pre-insertion state of sampling device 2120, 2120B in which plunger head 1742 is not within tubular container 2030) (and/or before the movement of plunger head 1742 within tubular container 2030 stores energy in the spring). For example, in configurations in which mechanical energy storage element 2102, 2102A comprises spring 2103, 2103A, the spring may comprise a compression spring that is partially compressed before the movement of plunger head 1742 within tubular container 2030. For example, container housing 2022 may comprise a retaining ring 2026 that functions as a stopper to prevent proximal movement of tubular container 2030, thereby holding spring 2103, 2103A partially compressed.

Slightly pre-loading spring 2103, 2103A results in the spring still being somewhat compressed as the spring finishes pushing liquid specimen sample 22 through filter 60. The final stages of pushing liquid specimen sample 22 through filter 60 often require the most pressure, because filter 60 generally becomes progressively more clogged during filtration.

Optionally, sampling device 2120 further comprises an absorbent material 2109, which absorbs the liquid filtrate to inhibit spillage and/or inhibit the liquid filtrate from returning through filter 60. For example, absorbent material 2109 may comprise sodium polyacrylate. Optionally, absorbent material 2109 is sandwiched by two layers of material, such as polyester, that can separate and allow expansion upon absorption of liquid by absorbent material 2109.

In the configuration shown in FIGS. 8A-C, a mechanical energy storage element 2102, 2102B comprises a spring 2103, 2103B, which is disposed encircling at least a longitudinal portion of tubular container 2030. For example, an external surface 2106, 2106B of tubular container 2030 may be defined by a proximal lip 2110 of tubular container 2030, such as shown. Alternatively, tubular container 2030 may be shaped so as to define one or more protrusions that protrude radially outward from a lateral external surface 2106 of tubular container 2030 and engage spring 2103, 2103B, in which case spring 2103, 2103B is in indirect contact with external surface 2106 of tubular container 2030.

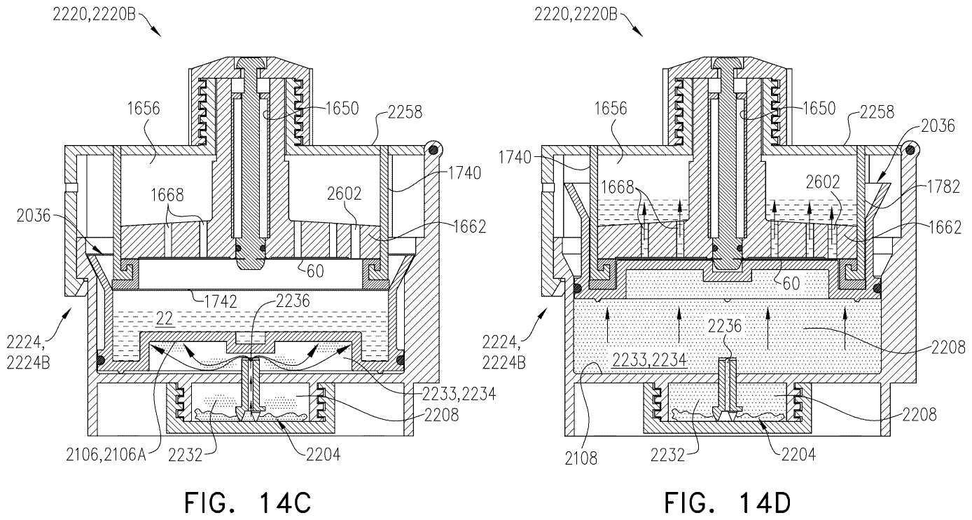

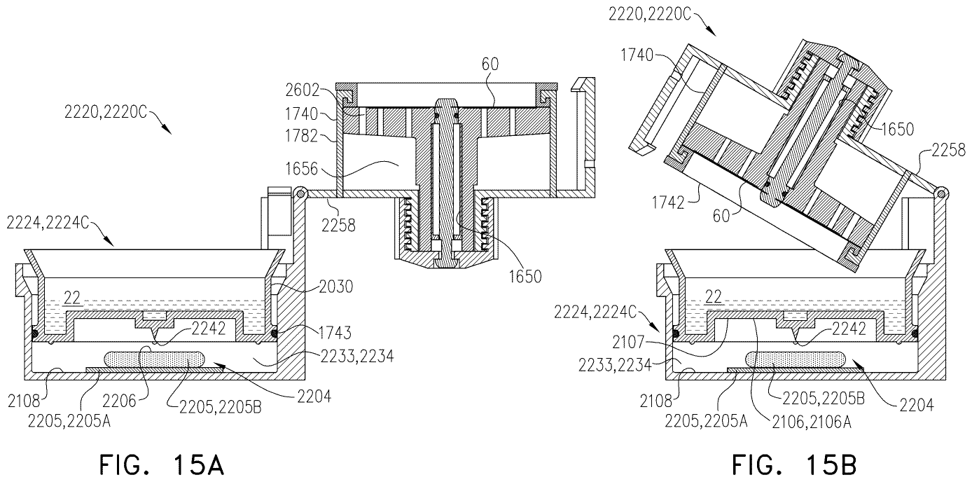

In the configuration shown in FIGS. 13-D, a mechanical energy storage element 2102, 2102C comprises a spring 2103, 2103C, which is disposed alongside at least a longitudinal portion of tubular container 2030. Optionally, mechanical energy storage element 2102, 2102C comprises a plurality of springs 2103, 2103C disposed alongside the at least a longitudinal portion of tubular container 2030, such as shown; alternatively, mechanical energy storage element 2102, 2102C comprises exactly one spring 2103, 2103C disposed alongside the at least a longitudinal portion of tubular container 2030 (configuration not shown). For example, external surface 2106, 2106B of tubular container 2030 may be defined by proximal lip 2110 of tubular container 2030, such as shown. Alternatively, tubular container 2030 may be shaped so as to define one or more protrusions that protrude radially outward from a lateral external surface 2106 of tubular container 2030 and engage spring(s) 2103, 2103C, in which case spring(s) 2103, 2103C is in indirect contact with external surface 2106 of tubular container 2030.

Reference is made to FIGS. 8A-C and 9A-D. As mentioned above, for some applications, energy storage element 2102 may alternatively or additionally release energy that pushes at least a portion of liquid specimen sample 22 through filter 60 and into waste liquid receptacle 1656. In the configurations shown in FIGS. 8A-C and 9A-D, this energy is stored in energy storage element 2102 entirely during advancement of plunger head 1742 within tubular container 2030.

For example, spring 2103 may comprise a compression spring that is in a resting, fully uncompressed state before advancement of plunger head 1742 within tubular container 2030, such as shown in FIGS. 8A and 9A. Advancement of plunger head 1742 within tubular container 2030 compresses spring 2103, thereby storing energy in the spring, such as shown in FIGS. 8B and 9C. The advancement typically also pushes a portion of liquid specimen sample 22 through filter 60 and into waste liquid receptacle 1656. Upon completion of the advancement of plunger head 1742 within tubular container 2030, spring 2103 releases some or all of the stored energy, which proximally moves tubular container 2030 with respect to plunger head 1742 (and typically with respect to container housing 2022), such as shown in FIGS. 8C and 9D. This proximal movement pushes an additional portion of liquid specimen sample 22 through filter 60 and into waste liquid receptacle 1656. As used in the present application, including the claims and Inventive Concepts, the plungers described herein are still considered plungers even if they are held stationary as they plunge and liquid specimen sample 22 is pushed through filter 60 and into waste liquid receptacle 1656, such as by proximal movement of tubular container 2030. This is somewhat analogous to how the plunger of a conventional syringe would still be considered a plunger if the plunger were to be held stationary as the barrel were moved proximally toward the handle of the plunger.

In some applications of the present invention, spring 2103 is disposed elsewhere from the locations described above. For example, spring 2103 may be disposed proximal to proxima1 to tubular container 2030, in which case spring 2103 may comprise an extension spring that stores energy as tubular container 2030 is advanced distally within container housing 2022. Alternatively, spring 2103 may be disposed within or alongside plunger 1740.

Reference is made to FIGS. 10A-E. In this configuration of sampling device 2120, 2120E, an energy storage element 2102, 2102D is disposed within tubular container 2030. For some applications, energy storage element 2102, 2102D comprises a flexible container 2128 containing a gas, such as air. Flexible container 2128 may or may not be elastic. Optionally, flexible container 2128 is coupled to an internal surface of tubular container 2030, such as a bottom thereof, to prevent the flexible container from floating up and contacting filter 60. Optionally, flexible container 2128 bursts at the end of the plunger stroke when the flexible container is squeezed between plunger head 1742 and the bottom of tubular container 2030.

Reference is now made to FIGS. 11A-B, which are schematic illustrations of a sampling device 2220, 2220A and a method of using sampling device 2220, 2220A, in accordance with respective applications of the present invention.

Reference is further made to FIGS. 12A-D, which are schematic cross-sectional illustrations of sampling device 2220, 2220A and the method of using sampling device 2220, 2220A, in accordance with respective applications of the present invention. Sampling device 2220, 2220A comprises a filtration assembly 2224, 2224A.

Reference is still further made to FIGS. 13A-D, which are schematic cross-sectional illustrations of a sampling device 2220, 2220B, 2220C, 2220D and a method of using sampling device 2220, 2220B, 2220C, 2220D, in accordance with respective applications of the present invention.

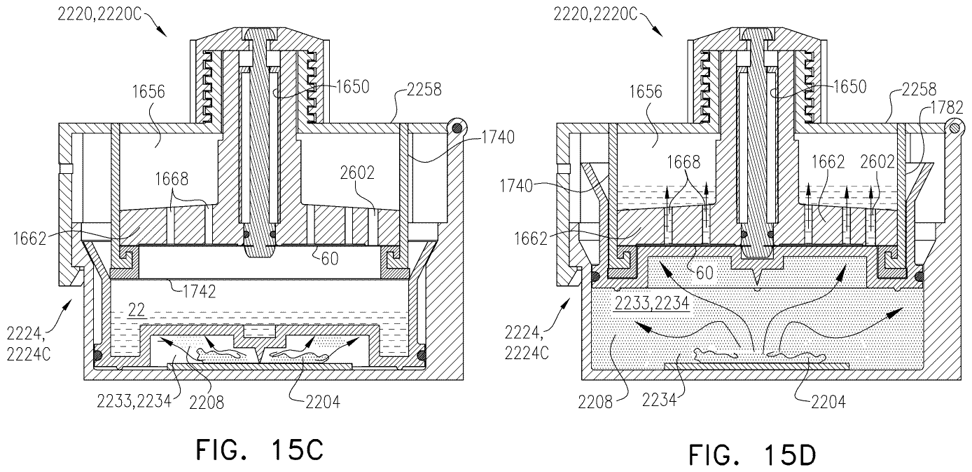

Reference is additionally made to FIGS. 14A-D, which are schematic cross-sectional illustrations of sampling device 2220, 2220B and the method of using sampling device 2220, 2220B, in accordance with respective applications of the present invention. Sampling device 2220, 2220B comprises a filtration assembly 2224, 2224B.

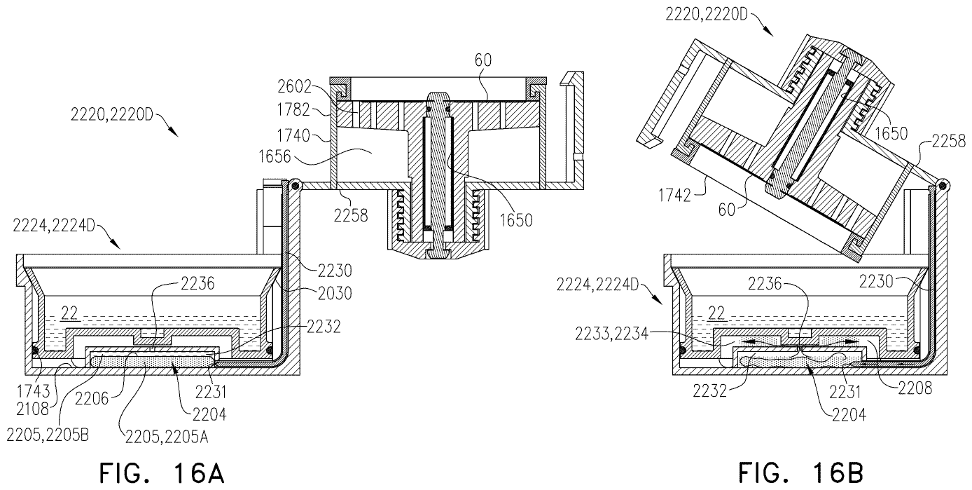

Reference is yet additionally made to FIGS. 15A-D, which are schematic cross-sectional illustrations of sampling device 2220, 2220C and the method of using sampling device 2220, 2220C, in accordance with respective applications of the present invention. Sampling device 2220, 2220C comprises a filtration assembly 2224, 2224C.

Reference is also made to FIGS. 16A-D, which are schematic cross-sectional illustrations of sampling device 2220, 2220D and the method of using sampling device 2220, 2220D, in accordance with respective applications of the present invention. Sampling device 2220, 2220D comprises a filtration assembly 2224, 2224D.

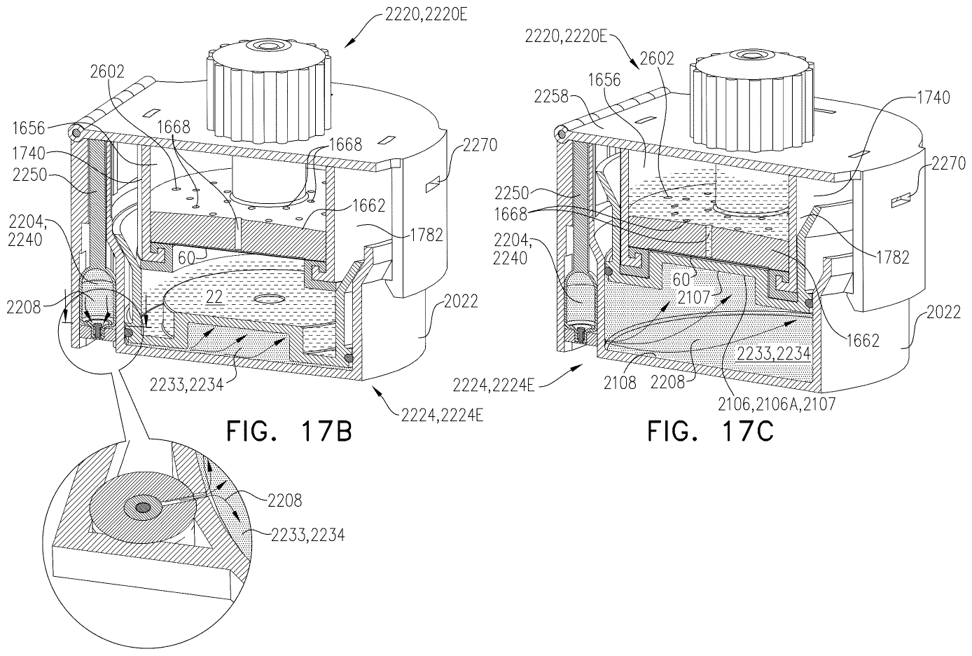

Reference is further made to FIGS. 17A-C, which are schematic cross-sectional illustrations of a sampling device 2220, 2220E and the method of using sampling device 2220, 2220E, in accordance with respective applications of the present invention. Sampling device 2220, 2220E comprises a filtration assembly 2224, 2224E.

Other than as described below, sampling device 2220 and filtration assembly 2224 are generally similar to sampling device 2120 and filtration assembly 2124, respectively, described hereinabove with reference to FIGS. 6A-10E, and like reference numerals refer to like parts. Alternatively or additionally, the features of sampling device 2220 may be implemented in combination with any of the other sampling devices described herein, mutatis mutandis, including, but not limited to sampling device 1620, described hereinabove with reference to FIGS. 1A-3D, and/or sampling device 1720, described hereinabove with reference to FIGS. 5A-E. For example, sampling device 2220 may optionally comprise filter-collection receptacle 1650, as shown in FIGS. 12A-D, 14A-D, 15A-D, and 16A-D (and present in the configuration shown in FIGS. 17A-C, albeit not visible), and sampling device 2220 may be configured such that filter 60 is advanceable into (e.g., entirely into) filter-collection receptacle 1650 via receptacle opening 1652 while filter-collection receptacle 1650 is disengageably coupled to the filtration assembly, such as described hereinabove with reference to FIGS. 2C and 3C.

Sampling device 2220 comprises a source of gas 2204, which is configured to provide gas 2208 into a space 2233 defined within filtration assembly 2224, such as outside tubular container 2030 (i.e., not in fluid communication with an interior of tubular container 2030). Filtration assembly 2224 is configured such that providing of gas 2208 into space 2233, when liquid specimen sample 22 is contained in tubular container 2030 and filter 60 is disposed on the support surface, pushes at least a portion of liquid specimen sample 22 through filter 60 and filtrate-passage openings 1668 and into waste liquid receptacle 1656.

For example, source of gas 2204 may comprise one or more substances 2205 that generate gas 2208, such as when combined with each other and/or with a liquid, such as liquid of liquid specimen sample 22. For some applications, the one or more substances 2205 may comprise a solid substance 2205A and a liquid substance 2205B. For example, solid substance 2205A may comprise sodium bicarbonate and liquid substance 2205B may comprise an acidic solution (e.g., comprising acetic acid or citric acid), which generate carbon dioxide gas 2208 when combined; or solid substance 2205A may comprise sodium bicarbonate and anhydrous citric acid and liquid substance 2205B may comprise water, which generate carbon dioxide gas 2208 when combined. Alternatively, the one or more substance 2205 may comprise one or more substances that are provided in combination, such as sodium bicarbonate and anhydrous citric acid, which generate carbon dioxide gas 2208 when combined with liquid of liquid specimen sample 22 (configuration not shown). Further alternatively, the one or more substance 2205 may comprise two or more liquids. In these configurations, tubular container 2030 typically forms a fluid-tight movable seal with an inner wall of container housing 2022, for example using O-ring 1743. For example, solid substance 2205A may comprise 0.5-2 g of sodium bicarbonate and liquid substance 2205B may comprise 1-5 mL of acetic acid.

Typically, as gas 2208 is released or generated, the resulting pressure gradually increases during filtration. This increase in pressure helps during the final stages of pushing liquid specimen sample 22 through filter 60, which often require the most pressure, because filter 60 generally becomes progressively more clogged during filtration. By contrast, during earlier stages of filtering, before the filter is particularly clogged, lower pressure is desirable, because using lower pressure results in better filtration. Source of gas 2204 thus appropriately applies lower pressure at the beginning of filtration, and gradually increasing pressure throughout filtration, which corresponds to, and helps address, the gradual increase in clogging of filter 60 during filtration.

Source of gas 2204 may comprise at least one container 2206, such as a pouch, in which typically one of the one or more substances 2205 is stored (e.g., either solid substance 2205A or liquid substance 2205B), isolated from the other of the one or more substances 2205 in applications in which two or more substances 2205 are provided and combined with each other.

As mentioned above, source of gas 2204 is configured to provide gas 2208 into space 2233 defined within filtration assembly 2224. For some applications, space 2233 is a space 2234 defined between (a) proximally-facing internal surface 2108 of container housing 2022 and (b) external surface 2106, 2106A of tubular container 2030 that is defined by distal end 2107 of tubular container 2030. Space 2234 is typically airtight. Providing gas 2208 into space 2234 increases the pressure in space 2234, thereby proximally moving tubular container 2030 proximally with respect to plunger head 1742 (and typically with respect to container housing 2022), such as shown in the transitions between FIGS. 12B, 12C, and 12D, between FIGS. 14C and 14D, between FIGS. 15C and 15D, between FIGS. 16C and 16D, and between FIGS. 17B and 17C. This proximal movement of tubular container 2030 pushes a portion of liquid specimen sample 22 through filter 60 and into waste liquid receptacle 1656. This proximal movement of tubular container 2030 also increases the volume of space 2234, which thus defines a variable volume.

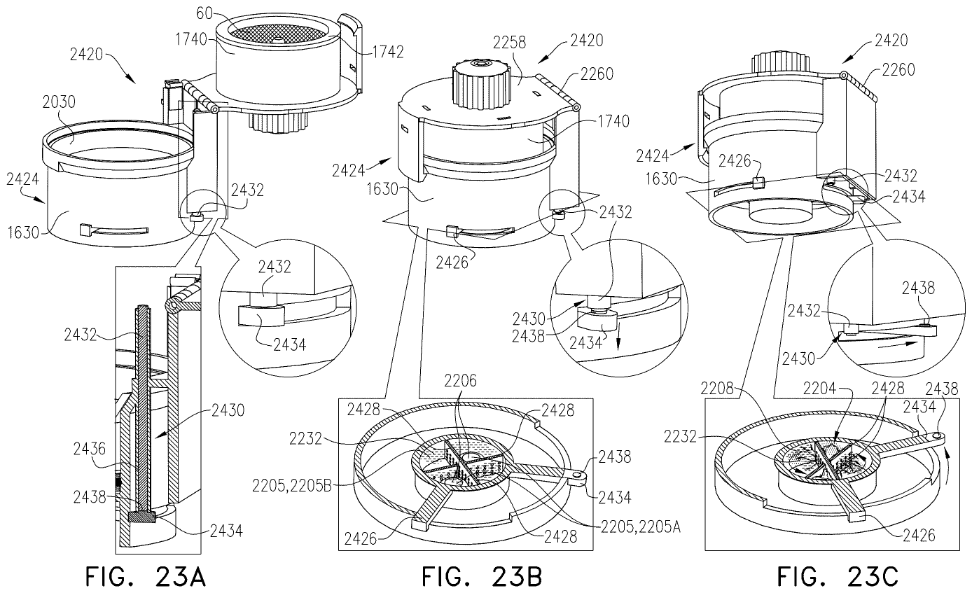

For some applications, such as shown in FIGS. 11A-B, 12A-D, 13A-D, 14A-D, and 15A-D, filtration assembly 2224 is configured such that movement of plunger head 1742 within tubular container 2030 causes source of gas 2204 to provide gas 2208. Typically, in these configurations, the movement of plunger head 1742 within tubular container 2030 is insufficient to push a meaningful portion of liquid specimen sample 22 through filter 60. For other applications, source of gas 2204 is configured to provide gas 2208 upon manual activation of source of gas 2204, such as described hereinbelow with reference to FIGS. 23A-C and 24A-C.

For some of these applications, the movement of plunger head 1742 within tubular container 2030 causes distal movement of tubular container 2030 within container housing 2022. This distal movement of tubular container 2030 within container housing 2022 may open container 2206 of source of gas 2204. For example, this distal movement of tubular container 2030 may open container 2206 by breaching (e.g., rupturing, penetrating, and/or tearing) container 2206, e.g., by pushing one or more spikes 2242 into a wall of container 2206. Optionally, the one or more spikes 2242 are defined by a distal end of a shaft 2238, and the proximal end of shaft 2238 is pushed distally by distal end 2107 of tubular container 2030. Opening of container 2206 causes a reaction that generates gas 2208, such as described above.

In the configurations shown in FIGS. 11A-B and 12A-D, the movement of plunger head 1742 within tubular container 2030 is typically caused by rotation of plunger head 1742 with respect to container housing 2022.

In the configurations shown in FIGS. 13A-D, 14A-D, and 15A-D, the movement of plunger head 1742 within tubular container 2030 is typically caused by non-rotational insertion of plunger head 1742 into tubular container 2030 with respect to container housing 2022. For example, filtration assembly 2224, 2224B, 2224C may further comprise a plunger support 2258, which is coupled to a proximal portion of plunger 1740. Plunger support 2258 may be hingedly attached to container housing 2022 (e.g., by a hinge 2260, labeled in FIGS. 13A-D), typically so as to enable a change in orientation between a central longitudinal axis 1745 of plunger 1740 and a central longitudinal axis 1747 of container housing 2022 (labeled in FIGS. 13A-C). This change in orientation transitions container opening 2036 from an open position to a closed position, in which plunger head 1742 covers container opening 2036. Hinge 2260 may comprise (a) moving components, e.g., may comprise a barrel hinge (such as shown), e.g., comprising two or more knuckles and a pin, or (b) a flexible hinge, e.g., a living hinge (configuration not shown).

For other applications, such as shown in FIGS. 16A-D, filtration assembly 2224 is configured such that movement of plunger head 1742 within tubular container 2030 is not necessary to cause source of gas 2204 to provide gas 2208. For example, tubular container 2030 may already be distally disposed within container housing 2022. Instead, plunger support 2258, upon movement (e.g., hinged movement) with respect to container housing 2022, opens container 2206 of source of gas 2204, such as via an elongate element 2230, e.g., by breaching (e.g., rupturing, penetrating, and/or tearing) container 2206. For example, elongate element 2230 may be shaped so as to define a spike 2231. The movement of plunger support 2258 with respect to container housing 2022 may also transition container opening 2036 from an open position to a closed position, in which plunger head 1742 covers container opening 2036.

For some applications, such as shown for the configuration of FIGS. 12A-D, 14A-D, and 16A-D, filtration assembly 2224, 2224A, 2224B, 2224D is shaped so as to define a gas-release regulation chamber 2232, in which source of gas 2204 is disposed. Gas-release regulation chamber 2232 is nearly entirely isolated from space 2234. Gas-release regulation chamber 2232 is in fluid communication with space 2234 only by one or more narrow openings 2236, e.g., having a total (combined) area of 75-8,000 square microns, e.g., if a single circular narrow opening 2236 is provided, it may have a diameter of 10-100 microns. The one or more narrow openings 2236 may help provide a controlled flow rate of gas 2208 into space 2234. Optionally, the one or more narrow openings 2236 are defined by shaft 2238 that also defines the one or more spikes 2242 for puncturing container 2206 (labeled in FIGS. 12A-B). In the configurations shown in the figures, gas-release regulation chamber 2232 is in fluid communication with space 2234 via exactly one narrow opening 2236.

For other applications, such as shown in FIGS. 15A-D, the filtration assembly is not shaped so as to define a gas-release regulation chamber, and source of gas 2204 is instead disposed in space 2234. For example, the one or more substances 2205 may comprise solid substance 2205A, which may comprise a solid, such as a tablet (as shown) or a powder (not shown), disposed at the bottom of space 2234. Optionally, the configuration of FIGS. 16A-D is implemented in this way (without gas-release regulation chamber 2232), mutatis mutandis.

Reference is made to FIGS. 17A-C. In this configuration, source of gas 2204 comprises a compressed gas container 2240, which stores a gas 2208. Upon opening of compressed gas container 2240, gas 2208 is released into space 2234. For example, as shown in FIGS. 17A-C, plunger support 2258, upon movement (e.g., hinged movement) with respect to container housing 2022, opens compressed gas container 2240, such as via an elongate element 2250. Alternatively, movement of plunger head 1742 within tubular container 2030 opens compressed gas container 2240 (configuration not shown).

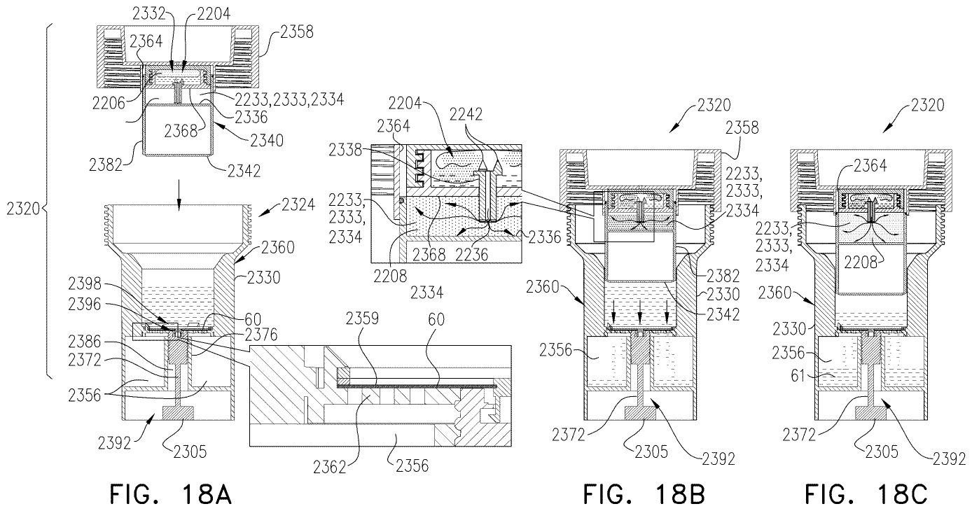

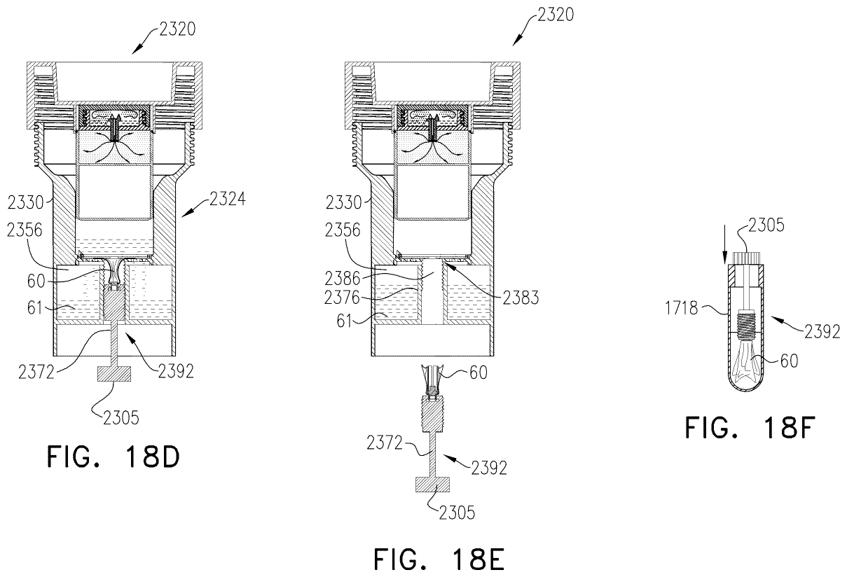

Reference is now made to FIGS. 18A-F, which are schematic cross-sectional illustrations of a sampling device 2320 for concentrating liquid specimen sample 22 and a method of using sampling device 2320, in accordance with respective applications of the present invention.

Other than as described hereinbelow, sampling device 2320 is similar in many respects to sampling device 2220 described hereinabove with reference to FIGS. 11A-17C, and may implement any of the features thereof, mutatis mutandis. Like reference numerals refer to like parts. The techniques of sampling device 2320 may be implemented in combination with the techniques of any of the other sampling devices described herein, mutatis mutandis, including, but not limited to, comprising filter-collection receptacle 1650, described hereinabove with reference to FIGS. 1A-3D, 12A-D, 14A-D, 15A-D, and 16A-D (and present in the configuration shown in FIGS. 17A-C, albeit not visible), and sampling device 2320 may be configured such that filter 60 is advanceable into (e.g., entirely into) filter-collection receptacle 1650 via receptacle opening 1652 while filter-collection receptacle 1650 is disengageably coupled to the filtration assembly, such as described hereinabove with reference to FIGS. 2C and 3C.

Sampling device 2320 comprises a filtration assembly 2324, which may have any of the properties described hereinabove. Filtration assembly 2324 comprises a tubular container 2330 and filter 60, which may have any of the properties described hereinabove with reference to FIGS. 1A-7E. Filtration assembly 2324 further comprises a plunger 2340, which comprises a plunger head 2342 and a plunger rod 2382.

Reference is still made to FIGS. 18A-F. Unlike in sampling device 2220, in sampling device 2320 plunger head 2342 is not shaped so as to define a filter support. Instead, an internal distal bottom surface 2398 of tubular container 2330 comprises (e.g., is shaped so as to define) a filter support 2362. Filter support 2362 is shaped so as to define:
a support surface 2359, which may be perpendicular to a central longitudinal axis of tubular container 2330 (as shown), or may be angled with respect to the central longitudinal axis (configuration not shown),
a plurality of filtrate-passage openings through filter support 2362 into a waste liquid receptacle 2356, which is typically disposed distal to filter support 2362 and internal distal bottom surface 2398 of tubular container 2330, and
optionally, a central opening 2383 (labeled in FIGS. 18D and 18E).

For some applications, filtration assembly 2324 comprises a hollow shaft 2376, which extends distally from tubular container 2330, and is shaped so as to define an internal shaft space 2386 within hollow shaft 2376 (labeled in FIGS. 18A and 18E). Central opening 2383 is open to internal shaft space 2386.

For some applications, sampling device 2320 comprises a withdrawer 2392 comprising a filter-withdrawal shaft 2372, which includes a distal portion that is couplable (directly or indirectly) to filter 60 (for example, as described hereinabove for the other filter-withdrawal shafts described herein, mutatis mutandis). Filter-withdrawal shaft 2372 is disposed passing (a) through a distal opening 2396 defined by internal distal bottom surface 2398 of tubular container 2330 and (b) optionally, in configurations in which filtration assembly 2324 comprises hollow shaft 2376, through internal shaft space 2386.

For some applications, withdrawer 2392 further comprises shaft handle 2305, which is coupled to a proximal portion of filter-withdrawal shaft 2372. Shaft handle 2305 may have any appropriate shape, for example the shape of wingnut (as shown) or a circular shape (configuration not shown).

Filter 60 is (removably) disposed on support surface 2359, typically on an upstream side of support surface 2359 (which, in the configuration of sampling device 2320, is a proximal side of support surface 2359).

Reference is still made to FIGS. 18A-F. Filtration assembly 2324 is configured such that movement (typically distal advancement) of plunger head 2342 within tubular container 2330, when liquid specimen sample 22 is contained in tubular container 2330 and filter 60 is disposed in tubular container 2330, pushes at least a portion of liquid specimen sample 22 through filter 60. Filter 60 is configured to concentrate at least a portion of liquid specimen sample 22 onto filter 60, while allowing filtrate 61 to pass through filter 60. Typically, distal advancement of plunger head 2342 within tubular container 2330 applies pressure to drive (e.g., push) at least a portion of liquid specimen sample 22 contained in tubular container 2330 through filter 60 and the filtrate-passage openings and into waste liquid receptacle 2356, such as shown in the transitions between FIGS. 18B and 18C.

Sampling device 2320 comprises source of gas 2204, described hereinabove with reference to FIGS. 11A-17C. Source of gas 2204 may optionally implement any of the techniques described hereinabove with reference to FIGS. 11A-17C. In this configuration, space 2233 is a space 2333 defined within filtration assembly 2324 outside tubular container 2330 (i.e., not in fluid communication with an interior of tubular container 2030). Filtration assembly 2324 is configured such providing of gas 2208 into space 2333, when liquid specimen sample 22 is contained in tubular container 2330 and filter 60 is disposed on support surface 2359, pushes at least a portion of liquid specimen sample 22 through filter 60 and the filtrate-passage openings and into waste liquid receptacle 2356, such as shown in the transitions between FIGS. 18B and 18C.

For some applications, filtration assembly 2324 further comprises:
a housing 2360, which comprises tubular container 2330; and
a plunger support 2358, which is couplable to housing 2360 (such as by screwing, as described above, mutatis mutandis, e.g., with 1-2 turns, such as 1-1.5 turns), and which comprises a plunger tube 2364, in which plunger rod 2382 is at least partially disposed so as to be axially moveable with respect to plunger tube 2364.

Filtration assembly 2324 is configured such that the providing of gas 2208 into space 2333 distally moves plunger rod 2382 with respect to plunger tube 2364 (which is axially stationary with respect to housing 2360 and tubular container 2330), thereby pushing the at least a portion of liquid specimen sample 22 through filter 60 and the filtrate-passage openings and into waste liquid receptacle 2356.

Reference is still made to FIGS. 18A-F. As mentioned above, source of gas 2204 is configured to provide gas 2208 into space 2333 defined within filtration assembly 2324. For some applications, space 2333 is a space 2334 is defined between (a) a proximal surface 2366 of plunger rod 2382 and (b) a distally-facing internal surface 2368 of plunger support 2358. Filtration assembly 2324 is configured such that providing gas 2208 into space 2334 increases pressure in space 2334, thereby distally moving plunger rod 2382 with respect to plunger tube 2364. In these applications, plunger rod 2382 typically forms a fluid-tight movable seal with an inner wall of plunger tube 2364, for example using an O-ring, such as shown.

For some applications, coupling of plunger support 2358 to housing 2360 causes proximal movement of plunger rod 2382 within plunger support 2358. This proximal movement of plunger rod 2382 within plunger support 2358 may open container 2206 of source of gas 2204. For example, this proximal movement of plunger rod 2382 may open container 2206 by breaching (e.g., rupturing, penetrating, and/or tearing) container 2206, e.g., by pushing one or more spikes 2242 into a wall of container 2206. Optionally, the one or more spikes 2242 are defined by a proximal end of a shaft 2338, and the distal end of shaft 2338 is pushed proximally by proximal surface 2366 of plunger rod 2382. Opening of container 2206 causes a reaction that generates gas 2208, such as described above.

Reference is still made to FIGS. 18A-F. For some applications, filtration assembly 2324 is shaped so as to define a gas-release regulation chamber 2332, in which source of gas 2204 is disposed. Gas-release regulation chamber 2332 is nearly entirely isolated from space 2334. Gas-release regulation chamber 2332 is in fluid communication with space 2334 only by one or more narrow openings 2236, e.g., having a total (combined) area of 75-8,000 square microns, e.g., if a single circular narrow opening 2236 is provided, it may have a diameter of 10-100 microns. The one or more narrow openings 2236 may help provide a controlled flow rate of gas 2208 into space 2334. Optionally, the one or more narrow openings 2236 are defined by shaft 2338 that also defines the one or more spikes 2242 for puncturing container 2206. In the configuration shown in the figures, gas-release regulation chamber 2332 is in fluid communication with space 2334 via exactly one narrow opening 2236. For other applications, filtration assembly 2324 is not shaped so as to define a gas-release regulation chamber, similar to the configuration of filtration assembly 2224, 2224C described hereinabove with reference to FIGS. 15A-D.

For some applications, sampling device 2320 is configured such that distal withdrawal of filter-withdrawal shaft 2372 out of filtration assembly 2324, typically while plunger head 2342 remains within tubular container 2330, pulls filter 60 out of filtration assembly 2324 via distal opening 2396 defined by internal distal bottom surface 2398 of tubular container 2330 (and optionally via central opening 2383 and/or via internal shaft space 2386, in configurations in which filtration assembly 2324 comprises hollow shaft 2376), thereby removing filter-withdrawal shaft 2372 and filter 60 from filtration assembly 2324. At least a portion of filter 60 is typically bunched up, such as into a flower-like arrangement, from the filter's initial flat shape while disposed on filter support 2362.

It is noted that filter-withdrawal shaft 2372 of sampling device 2320 is not an element of filtration assembly 2324, but instead is removable therefrom.

Reference is still made to FIGS. 18A-F. For some applications, filtration assembly 2324 (e.g., distal opening 2396) and withdrawer 2392 (either shaft handle 2305 or filter-withdrawal shaft 2372 thereof) are shaped so as to define corresponding screw threads. Sampling device 2320 is configured such that rotation of withdrawer 2392 and distal opening 2396 with respect to each other causes at least an initial portion of the distal withdrawal of filter-withdrawal shaft 2372 out of filtration assembly 2324. For some applications, the remainder of the proximal withdrawal is performed by simply axially withdrawing withdrawer 2392 once the screw threads have entirely separately (as shown), while for other applications, the screw threads are longer and the remainder of the proximal withdrawal is performed by continuing to rotate withdrawer 2392 (configuration not shown).

For some applications, filtration assembly 2324 is configured such that withdrawer 2392 is removable from the filtration assembly via plunger rod 2382, such as described hereinabove with reference to FIGS. 1A-17C, mutatis mutandis (configuration not shown).

For some applications, filtration assembly 2324 comprises pressure-responsive valve 2552, such as described hereinbelow with reference to FIGS. 24A-C, 25A-B, and/or 26A-C, mutatis mutandis.

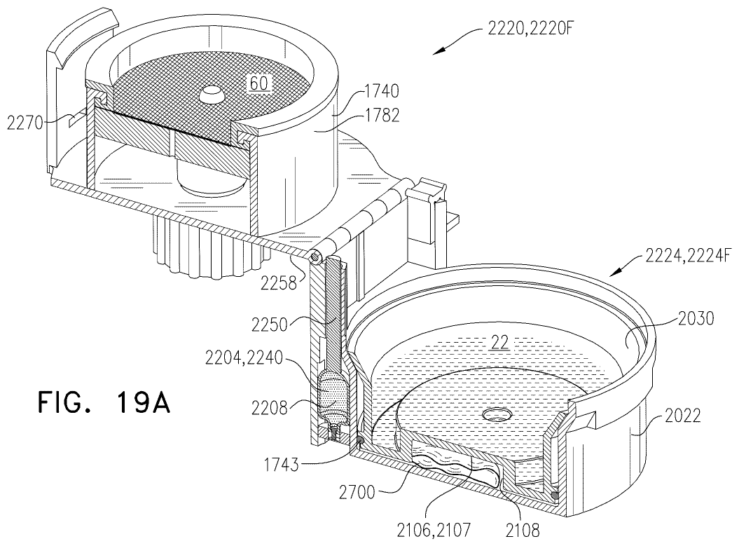

Reference is now made to FIGS. 19A-C, which are schematic cross-sectional illustrations of a sampling device 2220, 2220F for concentrating liquid specimen sample 22 and a method of using sampling device 2220, 2220F, in accordance with respective applications of the present invention. Sampling device 2220, 2220F comprises a filtration assembly 2224, 2224F. Other than as described below, sampling device 2220, 2220F is similar to sampling device 2220, 2220E, described hereinabove with reference to FIGS. 17A-C, and may implement any features thereof, mutatis mutandis. Like reference numerals refer to like parts.

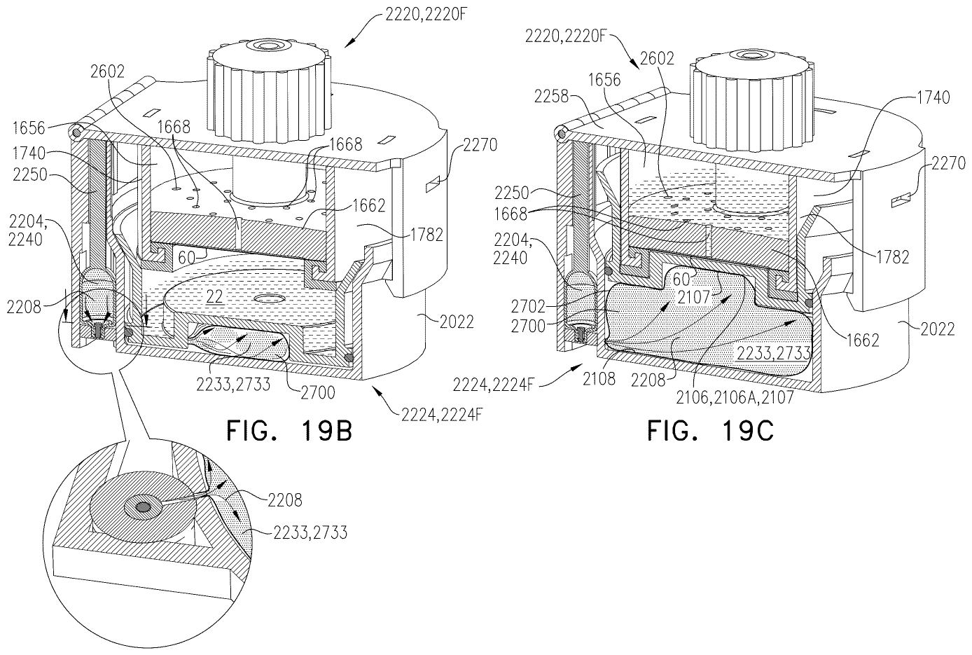

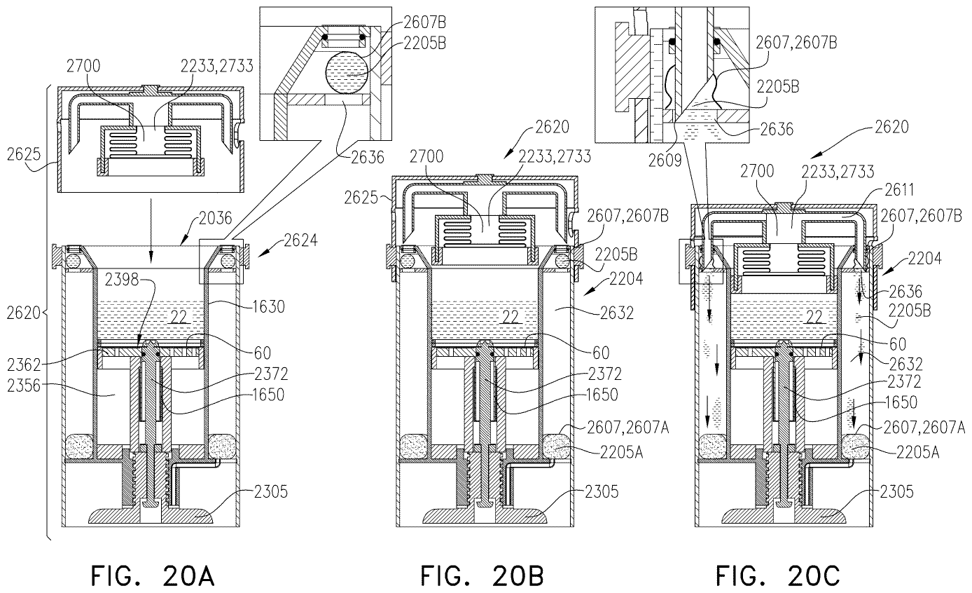

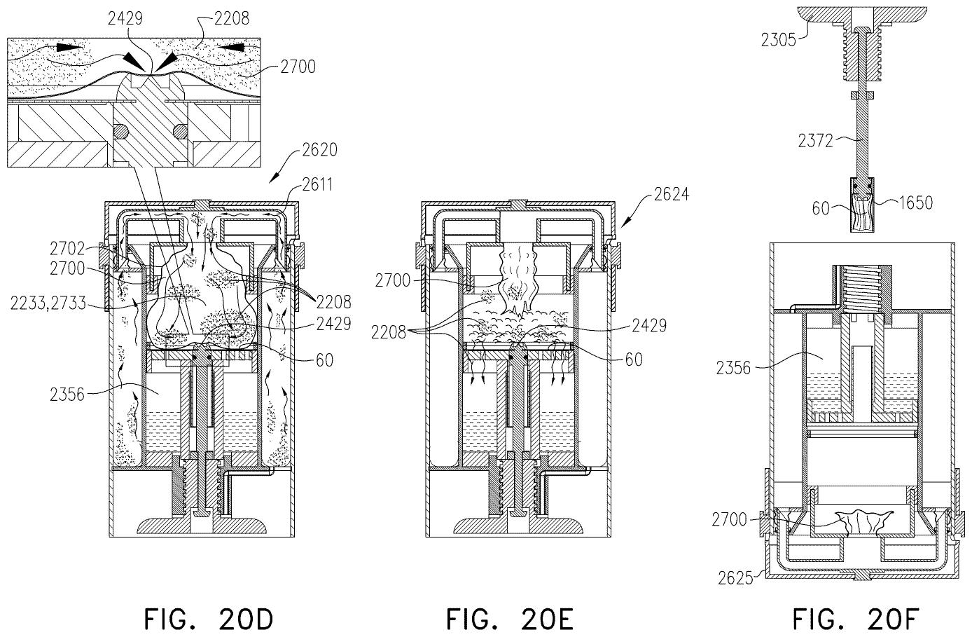

Reference is further made to FIGS. 20A-F, which are schematic cross-sectional illustrations of a sampling device 2620 for concentrating liquid specimen sample 22 and a method of using sampling device 2620, in accordance with respective applications of the present invention. Sampling device 2620 comprises a filtration assembly 2624. Other than as described below, sampling device 2620 is similar to sampling device 2320, described hereinabove with reference to FIGS. 18A-F, and may implement any features thereof, mutatis mutandis. Like reference numerals refer to like parts.

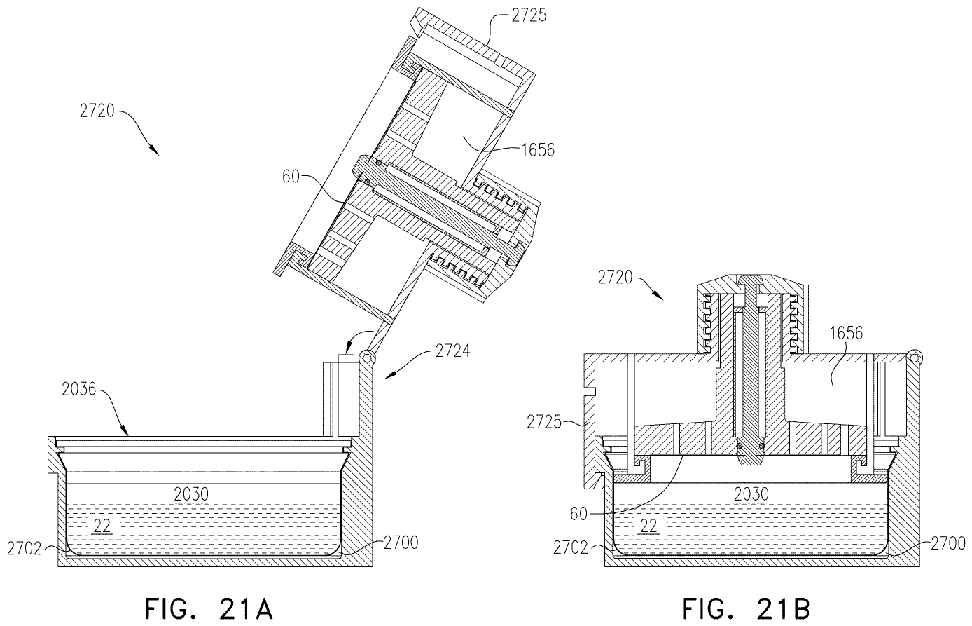

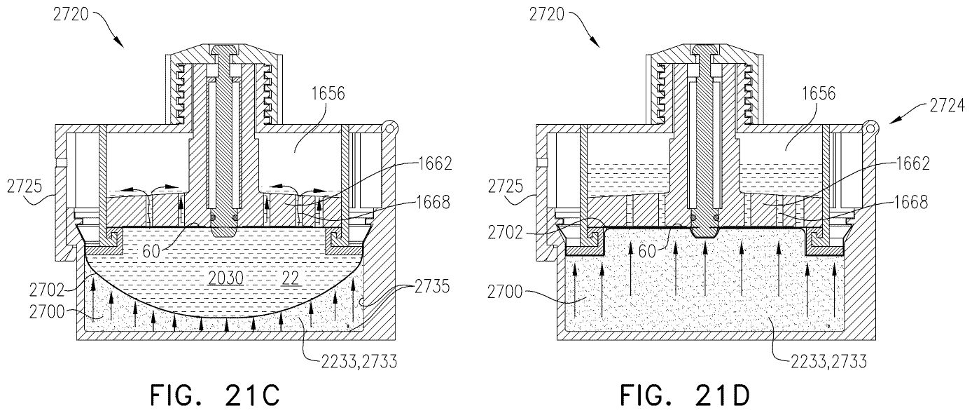

Reference is still further made to FIGS. 21A-D, which are schematic illustrations of a sampling device 2720 for concentrating liquid specimen sample 22 and a method of using sampling device 2720, in accordance with respective applications of the present invention. Sampling device 2720 comprises a filtration assembly 2724. Other than as described below, sampling device 2720 is similar to sampling device 1620, described hereinabove with reference to FIGS. 1A-3D, and sampling device 2220, described hereinabove with reference to FIGS. 13A-17C, and may implement any features thereof, mutatis mutandis. Sampling device 2720 may also implement the features of sampling device 1720, described hereinabove with reference to 5A-E, mutatis mutandis, and/or any of the other sampling devices described herein, mutatis mutandis. Like reference numerals refer to like parts.

In the configurations of the sampling devices illustrated in FIGS. 19A-C, 20A-F, and FIGS. 21A-D, the filtration assembly further comprises an inflatable chamber 2700, which comprises a flexible wall 2702 (labeled in FIGS. 19C, 20F, and 21A-D). In this configuration, space 2233 is a space 2733 defined by an interior of inflatable chamber 2700. Inflatable chamber 2700 may be entirely defined by one or more flexible walls 2702, such as exactly one flexible wall 2702 (as in a conventional balloon), or two or more flexible walls 2702. Alternatively, inflatable chamber 2700 may be defined by one or more flexible walls 2702 and one or more surfaces of the filtration assembly, such as one or more internal surfaces 2735 of the filtration assembly, such as shown in FIGS. 21A-D (in which case the one or more flexible walls 2702 may be similar on some respects to a diaphragm).

The one or more flexible walls 2702 may comprise an elastic material or a non-elastic material. Optionally, inflatable chamber 2700 comprises a balloon. Inflatable chamber 2700 is shown as accordion pleated in FIGS. 20A-C by way of example and not limitation.

Space 2733 has an initial volume, such as shown in FIGS. 19A, 20A, and 21A. The providing of gas 2208 into space 2733 increases the initial volume to an inflated volume, such as shown in FIGS. 19C, 20F, and 21D, so as to push the at least a portion of liquid specimen sample 22 through filter 60 and the filtrate-passage openings and into waste liquid receptacle 1656, 2356.

Reference is made to FIGS. 19A-C. In this configuration, inflatable chamber 2700 is disposed between (a) proximally-facing internal surface 2108 of container housing 2022 and (b) external surface 2106 of tubular container 2030 that is defined by distal end 2107 of tubular container 2030. Filtration assembly 2224, 2224F is configured such that the providing of gas 2208 into space 2733 increases the initial volume to the inflated volume, thereby proximally moving tubular container 2030 with respect to plunger head 2342, thereby pushing the at least a portion of liquid specimen sample 22 through filter 60 and filtrate-passage openings 1668 and into waste liquid receptacle 1656.

Although FIGS. 19A-C show, by way of example, source of gas 2204 as comprising compressed gas container 2240, source of gas 2204 may alternatively comprise one or more substances 2205 that generate gas 2208, such as described hereinabove with reference to FIGS. 11A-12D, 13A-14C, 15A-D, and 16A-D, mutatis mutandis.

Reference is made to FIGS. 20A-F and 21A-D. The providing of gas 2208 into space 2733 expands inflatable chamber 2700 toward filter 60, such as into contact with filter 60. For some applications, inflatable chamber 2700, when space 2733 has the initial volume, is disposed away from filter 60.

For some applications, the providing of gas 2208 into space 2733 increases an area of contact between inflatable chamber 2700 and filter 60, either from no initial contact or from an initial lower level of contact.

Reference is made to FIGS. 20A-F. In this configuration, internal distal bottom surface 2398 of tubular container 2330 comprises (e.g., is shaped so as to define) filter support 2362, which may have any of the features described hereinabove with reference to FIGS. 18A-F. The providing of gas 2208 into space 2733 expands inflatable chamber 2700 toward filter 60 (such as into contact with filter 60) when inflatable chamber 2700 is disposed at least partially in tubular container 2330.

For some applications, a filtration assembly 2424 of filtration assembly 2624 further comprises a proximal cap 2625, which is configured to sealably close proximal container opening 2036. Inflatable chamber 2700 is coupled to proximal cap 2625, such that inflatable chamber 2700 is disposed at least partially in tubular container 2330 when proximal cap 2625 sealably closes proximal container opening 2036.

For some applications, filtration assembly 2424 comprises one or more sharp surfaces 2429 (e.g., spikes), which are positioned to puncture inflatable chamber 2700 upon space 2733 increasing to the inflated volume, such as shown in FIG. 20G. Gas 2208 released from inflatable chamber 2700 may help push any remaining liquid specimen sample 22 through filter 60 and/or help dry filter 60, which may result in less dilution of the trapped particulate when filter 60 is subsequently pathed in liquid 1030, e.g., reagents, such as described herein. Alternatively, filtration assembly 2424 does not comprise the one or more sharp surfaces 2429. Optionally, these puncturing techniques are implemented, mutatis mutandis, in sampling device 2720, described herein with reference to FIGS. 21A-D.

Sampling device 2620 comprises source of gas 2204, which is configured to provide gas 2208 into space 2733.

For some applications, source of gas 2204 comprises at least one container 2607, such as a first container 2607A (which, by way of example and not limitation is shown as annular), in which typically one of the one or more substances 2205 is stored (e.g., either solid substance 2205A, such as shown, or liquid substance 2205B (configuration not shown)), isolated from the other of the one or more substances 2205. For example, liquid substance 2205B may be stored in a second container 2607B, and proximal cap 2625 may comprise a sharp surface 2609, which is configured to pierce second container 2607B and release liquid substance 2205B when proximal cap 2625 sealably closes proximal container opening 2036, as shown in FIG. 20C. Optionally, first container 2607A comprises a water- and gas-permeable wall, and/or a dissolvable wall.

For some applications, filtration assembly 2624 is shaped so as to define a gas-release regulation chamber 2632, in which source of gas 2204 is disposed. Optionally, one of the one or more substances 2205 (e.g., either solid substance 2205A) is disposed directly in gas-release regulation chamber 2632, in which case first container 2607A is not provided. By way of example and not limitation, gas-release regulation chamber 2632 is shown as extending around a periphery of filtration assembly 2624. Alternatively or additionally, gas-release regulation chamber 2632 may be disposed radially outward from tubular container 1630 and/or waste liquid receptacle 2356, also as shown. Gas-release regulation chamber 2632 is nearly entirely isolated from space 2733. Gas-release regulation chamber 2632 is in fluid communication with space 2733 only by one or more narrow openings 2636, which may help provide a controlled flow rate of gas 2208 into space 2733.

Optionally, filtration assembly 2624 comprises one or more tubes 2611, e.g., coupled to proximal cap 2625, which couple space 2733 in fluid communication with gas-release regulation chamber 2632 via the one or more narrow openings 2636.

Alternatively, for some applications, source of gas 2204 of sampling device 2620 comprises gas container 2240, described hereinabove with reference to FIGS. 17A-C. Typically, in this configuration, coupling proximal cap 2625 to proximal container opening 2036 opens compressed gas container 2240, optionally using techniques described hereinabove with reference to FIGS. 17A-C, mutatis mutandis.

Filtration assembly 2624 optionally comprises filter-collection receptacle 1650, such as shown, or does not comprise filter-collection receptacle 1650, such as shown for sampling device 2620, described hereinabove with reference to FIGS. 18A-F.

Reference is made to FIGS. 21A-D. In this configuration, filtration assembly 2724 further comprises a proximal cap 2725, which is configured to sealably close proximal container opening 2036. Proximal cap 2725 is shaped so as to define waste liquid receptacle 1656 within the proximal cap. Proximal cap 2725 comprises filter support 1662. Inflatable chamber 2700 is disposed at least partially in tubular container 2030. (The shape of partially inflated inflatable chamber 2700 is shown highly schematically in FIG. 21C; the actual shape at this stage of inflation may vary based on the particular configuration and shape of the inflatable chamber.)

Filtration assembly 2724 further comprises source of gas 2204. Although not shown in FIGS. 21A-D, source of gas 2204 may comprise compressed gas container 2240, described hereinabove with reference to FIGS. 17A-C, or one or more substances 2205 that generate gas 2208, such as described hereinabove with reference to FIGS. 11A-12D, 13A-14C, 15A-D, 16A-D, and 20A-F, mutatis mutandis.

Optionally, sampling device 2720 may implement any of the features of sampling device 2220, described hereinabove with reference to FIGS. 11A-17C, mutatis mutandis.

Reference is made to FIGS. 19A-C, 20A-F, and 21A-D. In an application of the present invention, sampling device 2220F, 2620, or 2720 does not comprise a waste liquid receptacle and does not necessarily comprise a filter support. There is therefore provided, in accordance with an application of the present invention, a sampling device for concentrating a liquid specimen sample, the sampling device comprising a filtration assembly, which comprises:
a tubular container, which is shaped so as to define an inner wall and a proximal container opening for receiving the liquid specimen sample;
a filter;
an inflatable chamber, which comprises a flexible wall, wherein an interior of the inflatable chamber is shaped so as to define a space having an initial volume; and
a source of gas, configured to provide gas into the space defined by the interior of the inflatable chamber.

The filtration assembly is configured such that providing of the gas into the space, when the liquid specimen sample is contained in the tubular container and the filter is disposed in the filtration assembly, increases the initial volume to an inflated volume, so as to push at least a portion of the liquid specimen sample through the filter.

For some of these applications, the filtration assembly further comprises a filter support, which is shaped so as to define (a) a support surface on which the filter is removably disposed, and (b) a plurality of filtrate-passage openings through the filter support. The filtration assembly is configured such that the providing of the gas into the space, when the liquid specimen sample is contained in the tubular container and the filter is disposed on the support surface, increases the initial volume to an inflated volume, so as to push at least a portion of the liquid specimen sample through the filter and the filtrate-passage openings.

For some of these applications, this configuration is implemented in combination with any of the features described herein, including in Inventive Concepts 2-20.

In an application of the present invention, a method is provided corresponding to the configuration described immediately above that does not comprise a waste liquid receptacle and optionally does not comprise a filter support. For some applications, this configuration is implemented in combination with any of the features described herein, including in Inventive Concepts 22-44.

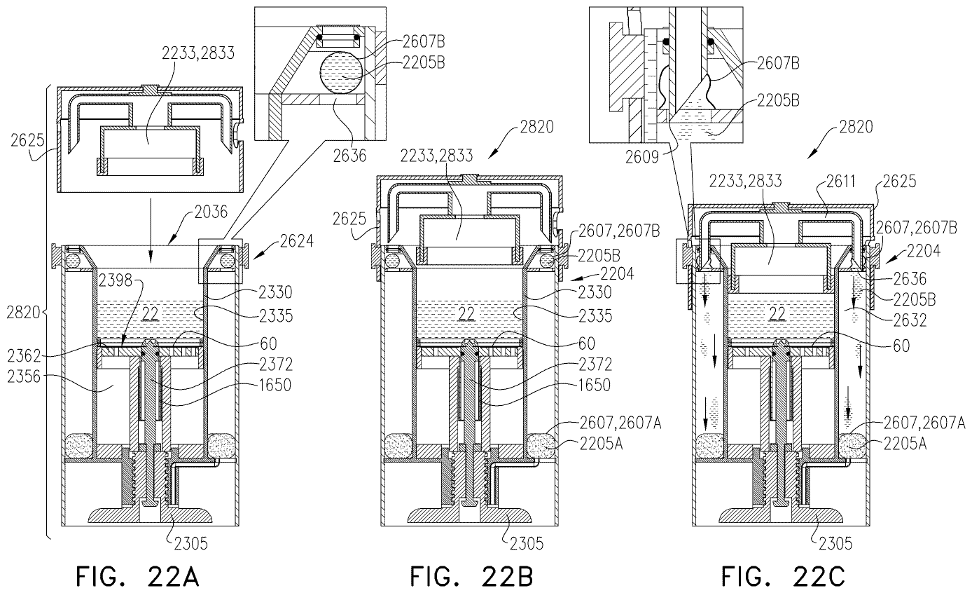

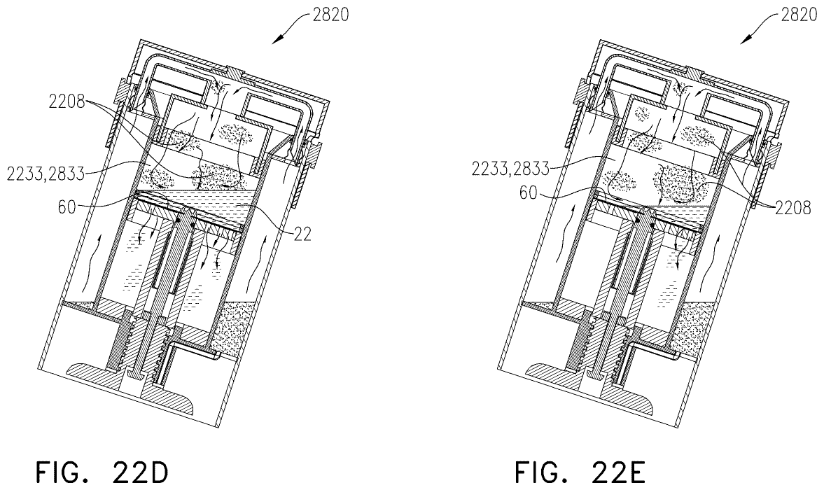

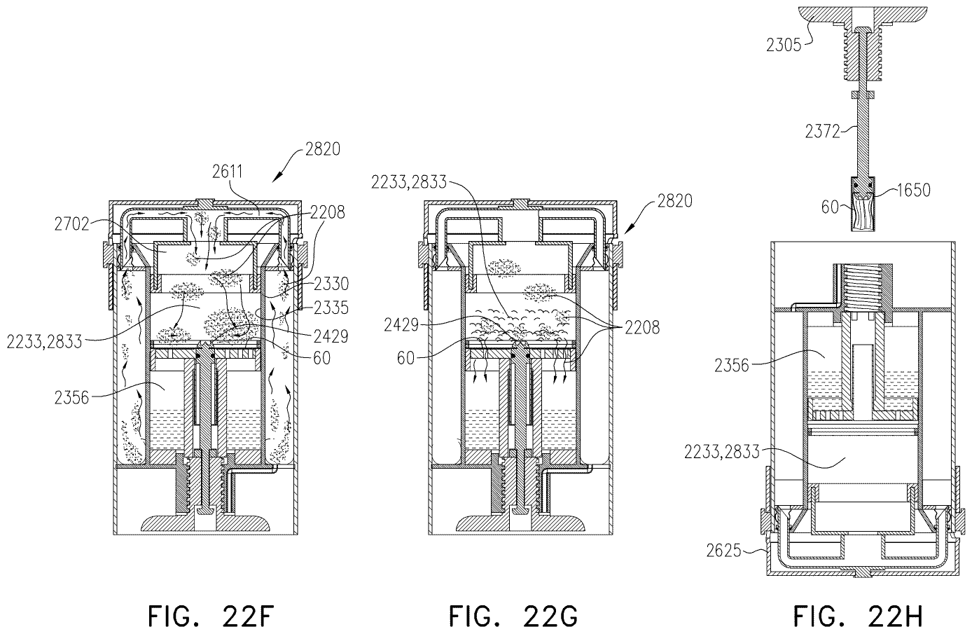

Reference is now made to FIGS. 22A-H, which are schematic illustrations of a sampling device 2820 for concentrating liquid specimen sample 22 and a method of using sampling device 2820, in accordance with respective applications of the present invention. Sampling device 2820 comprises a filtration assembly 2824. Other than as described below, sampling device 2820 is similar to sampling device 2620, described hereinabove with reference to FIGS. 20A-F, and may implement any features thereof, mutatis mutandis. Sampling device 2820 may also implement the features of any of the other sampling devices described herein, mutatis mutandis. Like reference numerals refer to like parts.

In this configuration, space 2233 is a space 2833 defined within tubular container 2330 at least partially by an inner wall 2335 of tubular container 2330. (Thus, filtration assembly 2824 does not comprise inflatable chamber 2700, described hereinabove with reference to FIGS. 19A-21C.).

Filtration assembly 2824 is configured such that providing of gas 2208 into space 2833, by source of gas 2204, when liquid specimen sample 22 is contained in tubular container 2330 and filter 60 is disposed on the support surface, pushes at least a portion of liquid specimen sample 22 through filter 60 and the filtrate-passage openings and into the waste liquid receptacle.

In some applications of this configuration, internal distal bottom surface 2398 of tubular container 2330 comprises (e.g., is shaped so as to define) filter support 2362, optionally implementing the techniques described hereinabove with reference to FIGS. 18A-F. Filtration assembly 2824 further comprises a proximal cap 2825, which is configured to sealably close the proximal container opening, and partially defines space 2333.

During use of filtration assembly 2824, a user may inadvertently tilt filtration assembly 2824 (even if instructed not to do so), such as shown in FIGS. 22D-E. In such a case, at some points during filtration, liquid specimen sample 22 may not entirely cover filter 60, such as shown in FIG. 22E. In order to address this possibility, for some applications filtration assembly 2824 is configured such that filter 60 is generally impermeable to gas 2208. For example, filter 60 may be configured to have a bubble point that is high enough to prevent passage of gas 2208 at the pressure of gas 2208 at this stage of filtration.

Reference is now made to FIGS. 23A-C, which are schematic cross-sectional illustrations of a sampling device 2420 and a method of using sampling device 2420, in accordance with an application of the present invention. Sampling device 2420 comprises a filtration assembly 2424. Other than as described below, sampling device 2420 and filtration assembly 2424 are generally similar to sampling device 2220, 2220B and filtration assembly 2224, 2224B, respectively, described hereinabove with reference to FIGS. 13A-14D, and like reference numerals refer to like parts. Alternatively or additionally, the features of sampling device 2420 may be implemented in combination with any of the other sampling devices described herein, mutatis mutandis, including, but not limited to sampling device 2220, 2220A, described hereinabove with reference to FIGS. 11A-12D.

As described hereinabove with reference to FIGS. 11A-B, 12A-D, 13A-D, 14A-D, and 15A-D, for some applications filtration assembly 2224 is configured such that movement of plunger head 1742 within tubular container 2030 causes source of gas 2204 to provide gas 2208. Unlike in these configurations, in filtration assembly 2424, source of gas 2204 is configured to provide gas 2208 upon manual activation of source of gas 2204. Thus, the transition from the open state of filtration assembly 2224 shown in FIG. 23A to the closed state of filtration assembly 2224 shown in FIG. 23B does not cause source of gas 2204 to provide gas 2208, even though this transition moves plunger head 1742 within tubular container 2030.

For some applications, filtration assembly 2424 comprises a user control 2426, which is configured, upon actuation thereof, to manually activate source of gas 2204 to provide gas 2208. FIGS. 23B and 23C show filtration assembly 2424 before and after manual activation of source of gas 2204, respectively.

For some applications, source of gas 2204 comprises at least one container 2206, such as a pouch, in which typically one of the one or more substances 2205 is stored (e.g., either solid substance 2205A or liquid substance 2205B), isolated from the other of the one or more substances 2205 in applications in which two or more substances 2205 are provided and combined with each other. Filtration assembly 2424 is configured such that manual activation of source of gas 2204 opens the at least one container 2206, for example by breaching (e.g., rupturing) the at least one container, such as shown in the transition between FIG. 23B and FIG. 23C.

For example, the actuation of user control 2426 may mechanically (as shown) and/or electrically (e.g., using a motor) (configuration not shown) move one or more dividers 2428 that crush and rupture the at least one container 2206. Optionally, the one or more dividers 2428 are shaped so as to define holes to allow passage of liquid substance 2205B, such as shown.

For some applications, filtration assembly 2424 comprises a safety 2430, which prevents the manual activation of source of gas 2204 prior to a threshold amount of movement of plunger head 1742 within tubular container 2030. For example, safety 2430 may comprise a tubular channel 2436 that an engages an arm 2434 prior to the threshold amount of movement of the plunger head within the tubular container. Arm 2434, when engaged, prevents actuation of user control 2426. For example, a protrusion 2438 on arm 2434 may engage tubular channel 2436. Tubular channel 2436 becomes disengaged from arm 2434 upon distal advancement of a shaft 2432 within tubular channel 2436 upon the threshold amount of movement of the plunger head within the tubular container, such as upon closing of the filtration assembly, either hingedly, as shown, or by inserting the plunger into the container such as shown in FIGS. 11A and 12A. For example, the distal advancement of shaft 2432 within tubular channel 2436 may push protrusion 2438 out of a distal end of tubular channel 2436, such that the protrusion no longer engages the tubular channel.

Reference is now made to FIGS. 24A-C, which are schematic cross-sectional illustrations of a sampling device 2520, 2520A and a method of using sampling device 2520, 2520A in accordance with an application of the present invention. Sampling device 2520, 2520A comprises a filtration assembly 2524, 2524A. Other than as described below, sampling device 2520, 2520A and filtration assembly 2524, 2524A are generally similar to sampling device 2420 and filtration assembly 2424, respectively, described hereinabove with reference to FIGS. 23A-C, and like reference numerals refer to like parts. Alternatively or additionally, the features of sampling device 2520, 2520A may be implemented in combination with any of the other sampling devices described herein, mutatis mutandis, including, but not limited to sampling device 2220, 2220A, described hereinabove with reference to FIGS. 11A-12D, and/or sampling device 2220, 2220D, described hereinabove with reference to FIGS. 16A-D.

Reference is additionally made to FIGS. 25A-B, which are schematic cross-sectional illustrations of a sampling device 2520, 2520B and a method of using sampling device 2520, 2520B in accordance with an application of the present invention. Sampling device 2520, 2520B comprises a filtration assembly 2524, 2524B. Other than as described below, sampling device 2520, 2520B and filtration assembly 2524, 2524B are generally similar to sampling device 2220, 2220B and filtration assembly 2224, 2224B, respectively, described hereinabove with reference to FIGS. 13A-14D, and like reference numerals refer to like parts. Alternatively or additionally, the features of sampling device 2520, 2520B may be implemented in combination with any of the other sampling devices described herein, mutatis mutandis, including, but not limited to sampling device 2220, 2220A, described hereinabove with reference to FIGS. 11A-12D, and/or sampling device 2220, 2220D, described hereinabove with reference to FIGS. 16A-D.

Reference is yet additionally made to FIGS. 26A-C, which are schematic cross-sectional illustrations of a sampling device 2520, 2520C and a method of using sampling device 2520, 2520C, in accordance with an application of the present invention. Sampling device 2520, 2520C comprises a filtration assembly 2524, 2524C. Other than as described below, sampling device 2520, 2520C and filtration assembly 2524, 2524C are generally similar to sampling device 2220, 2220E and filtration assembly 2224, 2224E, respectively, described hereinabove with reference to FIGS. 17A-C, and like reference numerals refer to like parts. Alternatively or additionally, the features of sampling device 2520, 2520C may be implemented in combination with any of the other sampling devices described herein, mutatis mutandis.

Reference is yet additionally made to FIGS. 27A-B, which are schematic cross-sectional illustrations of a sampling device 2520, 2520D and a method of using sampling device 2520, 2520D, in accordance with an application of the present invention. Sampling device 2520, 2520D comprises a filtration assembly 2524, 2524D. Other than as described below, sampling device 2520, 2520D and filtration assembly 2524, 2524D are generally similar to sampling device 2220, 2220A and filtration assembly 2224, 2224A, respectively, described hereinabove with reference to FIGS. 11A-12D, and like reference numerals refer to like parts. Alternatively or additionally, the features of sampling device 2520, 2520D may be implemented in combination with any of the other sampling devices described herein, mutatis mutandis, including, but limited to filtration assembly 2224, 2224C, described hereinabove with reference to FIGS. 15A-D (which is not shaped so as to define a gas-release regulation chamber).

As described hereinabove for the filtration assemblies illustrated in FIGS. 11A-B, 12A-D, 13A-D, 14A-D, and 15A-D, filtration assembly 2524 comprises source of gas 2204, which is configured to provide gas 2208 into space 2233 defined within filtration assembly 2224. For some applications, space 2233 is space 2234 defined between (a) proximally-facing internal surface 2108 of container housing 2022 and (b) external surface 2106, 2106A of tubular container 2030 that is defined by distal end 2107 of tubular container 2030.

For some applications, such as shown in FIGS. 24A-C, in filtration assembly 2524, 2524A, source of gas 2204 is configured to provide gas 2208 upon manual activation of source of gas 2204, for example as described hereinabove with reference to FIGS. 23A-C. FIGS. 24A and 24B show filtration assembly 2524, 2524A before and after manual activation of source of gas 2204, respectively.

For other applications, such as shown in FIGS. 25A-B, 26A-C, and 27A-B, filtration assembly 2524, 2524B, 2524C, 2524D implements features of filtration assembly 2224, and is configured such that movement of plunger head 1742 within tubular container 2030 causes source of gas 2204 to provide gas 2208, such as described hereinabove with reference to FIGS. 11A-B, 12A-D, 13A-D, 14A-D, 15A-D, 16A-D, and 17A-C.

Reference is still made to FIGS. 24A-C, 25A-B, 26A-C, and 27A-B. Filtration assembly 2524 further comprises a pressure-responsive valve 2552 that is configured to limit a pressure within space 2233 (e.g., space 2234). Limiting the pressure may be beneficial if filter 60 becomes overly clogged during an early portion of the filtration, such as if liquid specimen sample 22 is more viscous than typical samples. For example, for applications in which liquid specimen sample 22 is gargled fluid, the sample may include more mucus than typical gargled fluid samples. If filter 60 becomes overly clogged during the early portion of the filtration, the pressure within space 2233 (e.g., space 2234) may exceed desired values, because gas 2208 builds up as source of gas 2204 continuously provides more gas into space 2233, and the gas has reduced ability to push the at least a portion of liquid specimen sample 22 through filter 60 and the filtrate-passage openings and into waste liquid receptacle 1656. The excessive pressure may undesirably force liquid specimen sample 22 through the clogged filter (e.g., exceeding the operating pressure of the filter), resulting in tearing of the filter and/or an increased rate of undesired passage of biological particulate through the filter, rather than the filter trapping the biological particulate. The limiting of the pressure within space 2233 by pressure-responsive valve 2552 prevents the pressure within space 2233 from increasing undesirably, thereby solving this problem.

Pressure-responsive valve 2552 may be responsive to the pressure within space 2233 by closing or opening, or closing or opening to a greater or lesser extent, based on the pressure within space 2233. Optionally, pressure-responsive valve 2552 is configured to constrain the pressure within space 2233; to set a maximum value of the pressure within space 2233; and/or to set a maximum pressure differential between the pressure within space 2233 and the pressure at a location outside space 2233. For example, the location outside space 2233 may be gas-release regulation chamber 2232 (in configurations in which gas-release regulation chamber 2232 is provided), compressed gas container 2240 (in configurations in which compressed gas container 2240 is provided), or the atmosphere outside the filtration assembly, depending on the particular configuration of the filtration assembly and the pressure-responsive valve.

For some applications, such as shown in FIGS. 24A-C, 25A-B, and 26A-C, pressure-responsive valve 2552 is configured to limit the pressure in space 2233 (e.g., space 2234) by blocking flow of gas 2208 into the space responsively to the pressure in the space. FIGS. 24B, 25A, and 26B show pressure-responsive valve 2552 in an open state, in which the valve does not block the flow of gas 2208 into the space, while FIGS. 24C, 25B, and 27C show pressure-responsive valve 2552 in a closed state, in which the valve blocks flow of gas 2208 into the space.

For some of these applications, such as shown in FIGS. 24A-C and 25A-B, filtration assembly 2524, 2524A, 2524B is shaped so as to define gas-release regulation chamber 2232, and filtration assembly 2524, 2524A, 2524B may implement any of the configurations of gas-release regulation chamber 2232 described hereinabove with reference to FIGS. 11A-12D, 13A-14D, and 16A-D. Gas-release regulation chamber 2232 is in fluid communication with space 2233 (e.g., space 2234) only by one or more openings 2536. The one or more openings 2536 may optionally implement any of the features (such as dimensions) of the one or more narrow openings 2236 described hereinabove with reference to FIG. 12A-D, 14A-D, and 16A-D; alternatively, the one or more openings 2536 may not be narrow and/or may have different dimensions from the one or more narrow openings 2236 described hereinabove.

For some of these applications, such as shown in FIGS. 24A-C and 25A-B, source of gas 2204 is disposed in fluid communication with (e.g., in) gas-release regulation chamber 2232, and pressure-responsive valve 2552 is configured to block the flow of gas 2208 into space 2233 (e.g., space 2234) by blocking the one or more openings 2536.

In the configurations shown in FIGS. 24A-C and 25A-B, pressure-responsive valve 2552 comprises a deflectable or displaceable surface exposed on one side thereof to space 2233 (e.g., space 2234), and a blocking element (e.g., a plug) coupled to the other side of the deflectable or displaceable surface, as described immediately hereinbelow regarding the specific exemplary implementations of the deflectable or displaceable surface shown in FIGS. 24A-C and 25A-B, respectively.

In the configuration shown in FIGS. 24A-C, pressure-responsive valve 2552 comprises a pressure-responsive valve 2552A, which comprises a diaphragm 2570 exposed on one side thereof to space 2233 (e.g., space 2234), and a blocking element 2572 (e.g., a plug) coupled to the other side of the diaphragm. When the pressure in the space increases beyond a threshold pressure (or a pressure differential across the diaphragm increases beyond a threshold pressure differential), the diaphragm is deflected away from the space, and, as a result, moves and causes blocking element 2572 to block the one or more openings 2536, such as shown in FIG. 24C. FIG. 24B shows diaphragm 2570 prior to deflection thereof, such that blocking element 2572 does not block the one or more openings 2536. Optionally, pressure-responsive valve 2552A further comprises a spring 2574, which is arranged to resist the deflection of the diaphragm away from the space.

Although pressure-responsive valve 2552A is shown in FIGS. 24A-C as implemented in combination with manual activation of source of gas 2204, pressure-responsive valve 2552A may also be implemented in configurations in which movement of plunger head 1742 within tubular container 2030 causes source of gas 2204 to provide gas 2208, such as described hereinabove, for example with reference to FIGS. 16A-D.

In the configuration shown in FIGS. 25A-B, pressure-responsive valve 2552 comprises a pressure-responsive valve 2552B, which comprises a piston 2580 exposed on one side thereof to space 2233 (e.g., space 2234), and a blocking element 2582 (e.g., plug) coupled to the other side of the piston. When the pressure in the space increases beyond a threshold pressure (or a pressure differential across the diaphragm increases beyond a threshold pressure differential), the piston is displaced away from the space, and, as a result, moves and causes blocking element 2582 to block the one or more openings 2536, such as shown in FIG. 18B. FIG. 25A shows piston 2580 prior to displacement thereof, such that blocking element 2582 does not block the one or more openings 2536. Optionally, pressure-responsive valve 2552B further comprises a spring 2584, which is arranged to resist the displacement of the diaphragm away from the space.

Alternatively or additionally, for some of these applications, such as shown in FIGS. 26A-C, source of gas 2204 comprises compressed gas container 2240 containing gas 2208 and defining an opening 2554 in fluid communication with space 2233 (e.g., space 2234). Pressure-responsive valve 2552 comprises a pressure-responsive valve 2552C that is configured to block the flow of gas 2208 into the space by blocking opening 2554, such as shown in FIG. 26C.

FIG. 26A shows pressure-responsive valve 2552C in a closed state, prior to activation of source of gas 2204, as described hereinabove with reference to FIGS. 17A-C. FIG. 26B shows pressure-responsive valve 2552C in an open state, when the pressure within space 2233 (e.g., space 2234) is below a threshold pressure. FIG. 26C shows pressure-responsive valve 2552C in a closed state, when the pressure within space 2233 (e.g., space 2234) increases beyond the threshold pressure.

For example, compressed gas container 2240 may be axially moveable, and spring biased downward by a spring 2590, such as shown in FIG. 26B. Filtration assembly 2524, 2524C may be shaped so as to define a compartment 2592 below compressed gas container 2240, in fluid communication with space 2233 (e.g., space 2234). Pressure in the space is communicated to compartment 2592, which pushes compressed gas container 2240 upward when the pressure exerts a force greater than a force applied by spring 2590, such as shown in FIG. 26C. The upward movement of compressed gas container 2240 causes a blocking element 2594 (e.g., a plug) to occlude opening 2554 of compressed gas container 2240.

For some applications, such as shown in FIGS. 27A-B, pressure-responsive valve 2552 comprises a pressure relief valve 2556, which is configured to release a portion of gas 2208 from space 2233 (e.g., space 2234) when the pressure within the space exceeds a threshold pressure. For example, pressure relief valve 2556 may be configured to release the portion of gas 2208 from the space to the atmosphere 2564 outside the filtration assembly 2524, 2524D, such as shown. Typically, the threshold is generally pre-determined, although it might vary slightly based on the pressure outside the space, e.g., atmospheric pressure. FIG. 27A shows pressure relief valve 2556 in a closed state, in which the valve blocks flow of gas 2208 from the space, while FIG. 27B shows pressure relief valve 2556 in an open state, in which the valve releases gas 2208 from the space.

By way of example and not limitation, pressure relief valve 2556 is illustrated as comprising a moveable blocking element 2558 (e.g., plug) and a spring 2560 arranged to dispose blocking element 2558 occluding an opening 2562 between space 2233 (e.g., space 2234) and outside the space when the pressure is below the threshold pressure, and to allow the pressure to push the blocking element 2558 away from occluding opening 2562 when the pressure within the space exceeds the threshold pressure. Alternatively, pressure relief valve 2556 may comprise another type of pressure relief valve known in the valve art.

Reference is now made to FIG. 7B-D. In some applications of the present invention, an outer wall of the container housing 2022 is shaped so as to define an optical window 2270. Filtration assembly 2124 further comprises a visual indicator 2272. Filtration assembly 2124 is configured such that visual indicator 2272 is:
not visible through optical window 2270 when tubular container 2030 is at a plurality of first distal axial locations 2274A within filtration assembly 2124, at which location visual indicator 2272 is not axially aligned with optical window 2270 (and thus is typically obscured by the wall of container housing 2022), as shown in FIG. 7B, and
visible through optical window 2270 when tubular container 2030 is at a second proximal axial location 2274B within filtration assembly 2124, at which location visual indicator 2272 is axially aligned with optical window 2270, as shown in FIGS. 7C and 7D.

When tubular container 2030 is at the plurality of first distal axial locations 2274A within filtration assembly 2124, tubular container 2030 has not completed its proximal movement with respect to plunger head 1742, and thus has not completed pushing the additional portion of liquid specimen sample 22 through filter 60 and into waste liquid receptacle 1656.

Optionally, a radially outward facing surface of support 2105, described hereinabove with reference to FIGS. 6A-E and 7A-D, comprises visual indicator 2272.

When tubular container 2030 is at second proximal axial location 2274B within filtration assembly 2124, tubular container 2030 has completed its proximal movement with respect to plunger head 1742, and thus completed pushing the additional portion of liquid specimen sample 22 through filter 60 and into waste liquid receptacle 1656. The visibility of visual indicator 2272 through optical window 2270 provides an indication to the user that the filtration of liquid specimen sample 22 is complete, and thus, for example, filter 60 may be removed from filtration assembly 2124, for example as described hereinabove with reference to FIGS. 2C-D and 3C-D; 5C-D; or FIGS. 9C-D and 6C-D.

Optical window 2270 is optionally air-tight, e.g., comprises a transparent or translucent covering; alternatively, optical window 2270 is not air-tight, e.g., is defined by an opening through the outer wall of container housing 2022.

In some applications, an external surface of plunger support 2058 comprises a first rotational indicator 2280A, and an external surface of container housing 2022 comprises a second rotational indicator 2280B. The rotational indicators are disposed such that rotational alignment of the rotational indicators with each other indicates.

Any of the configurations described above with reference to FIG. 7A-D may implemented, mutatis mutandis, in combination with the features of sampling device 2120, 2102A, described hereinabove with reference to FIGS. 6A-E; sampling device 2120, 2120C, described hereinabove with reference to FIGS. 8A-C; sampling device 2120, 2120D, described hereinabove with reference to FIGS. 9A-D; sampling device 2220, 2220A, described hereinabove with reference to FIGS. 12A-D; sampling device 2220, 2220B, described hereinabove with reference to FIGS. 13A-14D; sampling device 2220, 2220C, described hereinabove with reference to FIGS. 15A-D; sampling device 2220, 2220D, described hereinabove with reference to FIGS. 16A-D; and sampling device 2220, 2220E, described hereinabove with reference to FIGS. 17A-C.

Reference is now made to FIGS. 28A-B, which are schematic isometric and cross-sectional illustrations of a sampling device 2920, 2920A for concentrating liquid specimen sample 22, in accordance with respective applications of the present invention.

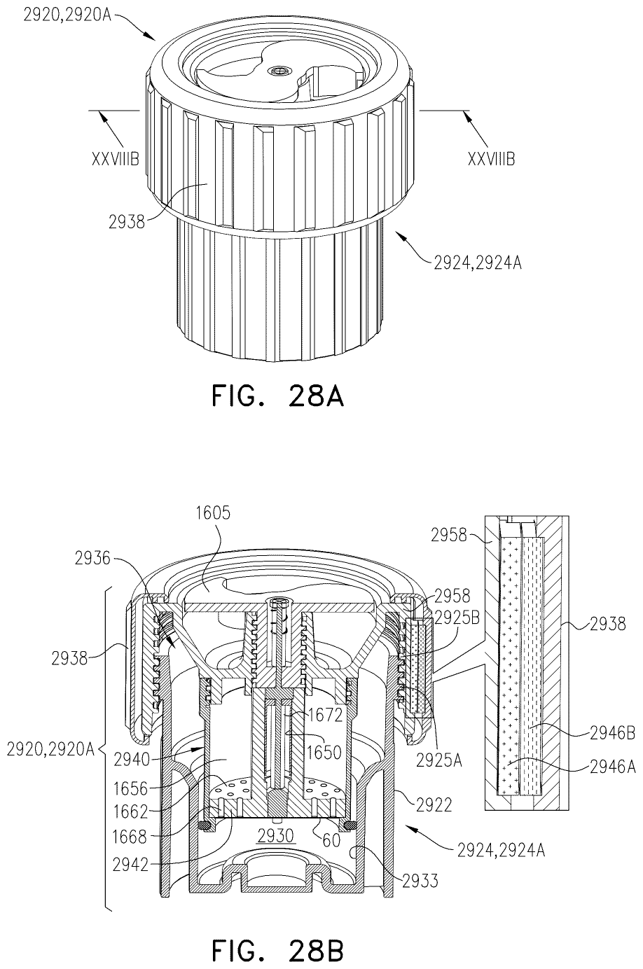

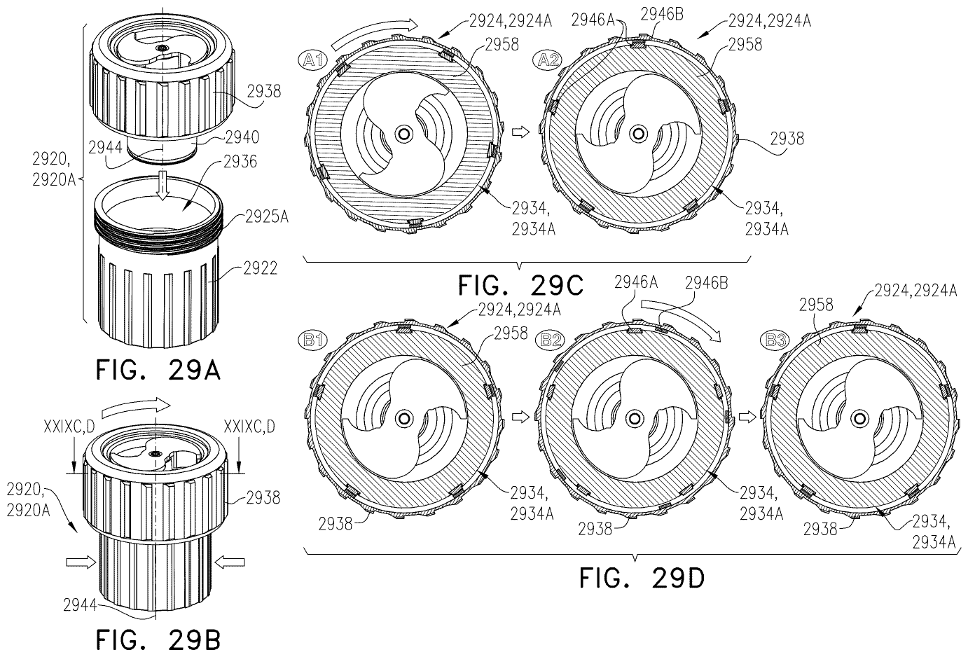

Reference is further made to FIGS. 29A-D, which are schematic illustrations of a method of using sampling device 2920, 2920A, in accordance with an application of the present invention.

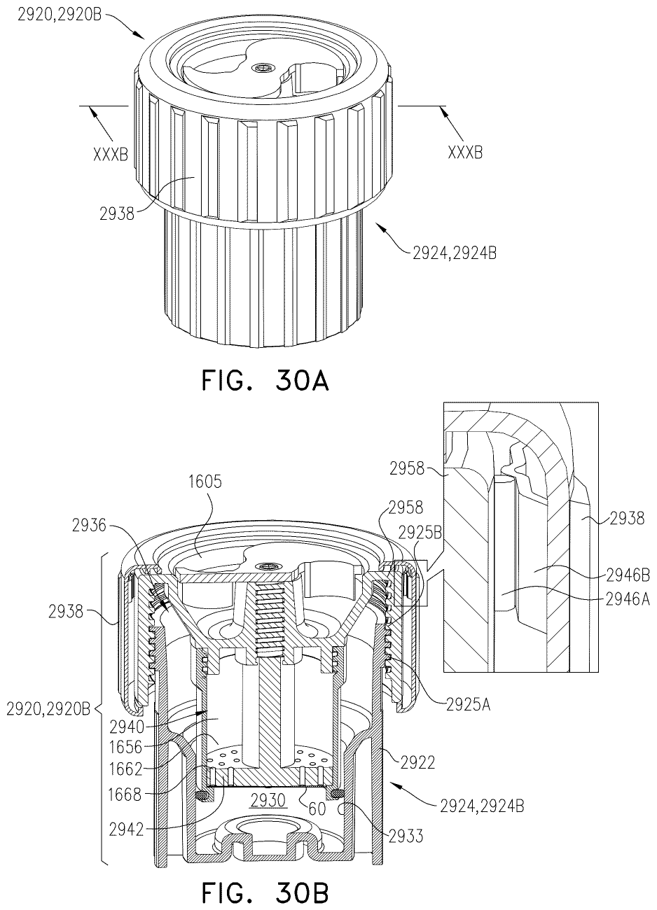

Reference is still further made to FIGS. 30A-B, which are schematic isometric and cross-sectional illustrations of a sampling device 2920, 2920B, in accordance with respective applications of the present invention.

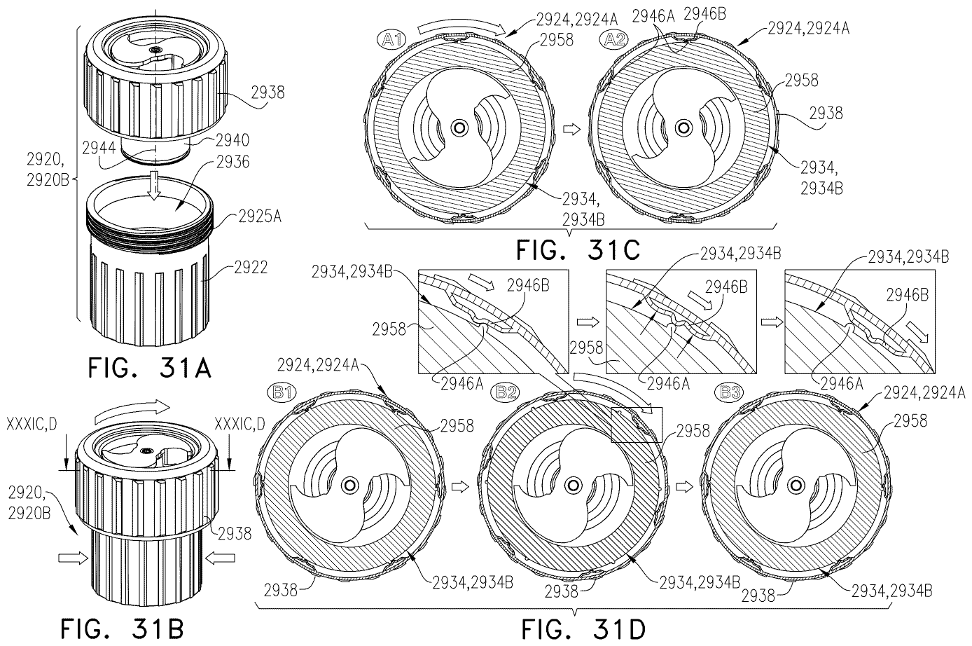

Reference is further made to FIGS. 31A-D, which are schematic illustrations of a method of using sampling device 2920, 2920B, in accordance with an application of the present invention.

Other than as described hereinbelow, sampling device 2920 is generally similar to sampling device 1620 described hereinabove with reference to FIGS. 1A-3D, and may implement any of the features thereof, mutatis mutandis. Like reference numerals refer to like parts. Alternatively or additionally, the features of sampling device 2920 may be implemented in combination with any of the other sampling devices described herein, mutatis mutandis. Sampling device 2920, 2920A comprises a filtration assembly 2924, 2924A, and sampling device 2920, 2920B comprises a filtration assembly 2924, 2924B.

Filtration assembly 2924 comprises:
a container housing 2922, which (a) is shaped so as to define one or more first threads 2925A, and (b) comprises a tubular container 2930, which is shaped so as to define an inner wall 2933 and a proximal container opening 2936 for receiving liquid specimen sample 22;
a plunger support 2958, which is shaped so as to define one or more second threads 2925B, shaped so as to engage the one or more first threads 2925A;
a plunger 2940, which (a) comprises a plunger head 2942, (b) is insertable into tubular container 2930 via proximal container opening 2936, such that a lateral surface of plunger head 2942 forms a fluid-tight movable seal with inner wall 2933; and
filter 60.

Plunger 2940 is coupled to plunger support 2958, such that rotation of plunger support 2958 with respect to container housing 2922, when the one or more second threads 2925B are engaged with the one or more first threads 2925A, distally advances plunger support 2958 with respect to container housing 2922 and thus plunger 2940 within tubular container 2930.

Filtration assembly 2924 is configured such that movement of plunger head 2942 within tubular container 2930, when liquid specimen sample 22 is contained in tubular container 2930 and filter 60 is disposed in tubular container 2930, pushes at least a portion of liquid specimen sample 22 through filter 60.

Filtration assembly 2924 further comprises a torque-limiting clutch 2934 (also known in the mechanical arts as an overload clutch), e.g., a slip clutch. Filtration assembly 2924 still further comprises a control knob 2938, which is rotatable about a central axis 2944 of plunger 2940 (labeled in FIGS. 29A and 31A). Control knob 2938 is coupled to plunger support 2958 by torque-limiting clutch 2934, such that rotation of control knob 2938 by application of:
a torque less than a threshold value rotates plunger support 2958, thereby rotating plunger support 2958 with respect to container housing 2922, such as shown in FIGS. 29C and 31C, and
a torque equal to the threshold value causes control knob 2938 to slip with respect to plunger support 2958, such as shown in View B2 in FIGS. 29D and 31D.

Typically, after control knob 2938 slips with respect to plunger support 2958, control knob 2938, upon further rotation thereof, reengages plunger support 2958, such as shown in View B3 in FIGS. 29D and 31D. This slipping and reengaging typically repeats until the applied torque is less than the threshold value, or the user stops rotating control knob 2938.

Torque-limiting clutch 2934 thus may function as a sort of shock absorber in the event that plunger 2940 is advanced within tubular container 2930 more quickly than liquid specimen sample 22 can pass through filter 60 with effective filtration of liquid specimen sample 22.

Typically, during manufacture, the threshold torque is set based on factors such as the type of filter 60 (and of additional filters, if provided) and its properties, such as its pore size and/or bubble point; and/or a pitch of the screw threads.

For some applications, the one or more first threads 2925A of container housing 2922 face radially outward, away from central axis 2944 of plunger 2940, and the one or more second threads 2925B of plunger support 2958 face radially inward, toward central axis 2944 of plunger 2940.

For some applications, such as shown, at least a first axial portion of control knob 2938 surrounds at least a second axial portion of plunger support 2958. For other applications, control knob 2938 is non-axially overlapping with plunger support 2958 (configuration not shown).

Reference is made to FIGS. 28A-B and 29A-D. In this configuration, torque-limiting clutch 2934 comprises a magnetic torque-limiting clutch 2934, 2934A, which comprises:
a first set of one or more magnets 2946A (typically permanent magnets), which are coupled to plunger support 2958, typically a radial outward surface of plunger support 2958; and
a second set of one or more magnets 2946B (typically permanent magnets), which are coupled to control knob 2938, typically a radially inward surface of control knob 2938.

The first and the seconds sets 2946A and 2946B typically comprise the same number of magnets. The magnets of the first and the seconds sets 2946A and 2946B are arranged with opposite facing poles.

The magnets of the first set 2946A magnetically engage the magnets of the second set 2946B so long as the applied torque is less than the threshold value; when the applied torque reaches the threshold value, the magnets of second set 2946B disengage from the magnets of first set 2946A, allowing control knob 2938 to rotate without causing corresponding rotation of plunger support 2958.

Reference is made to FIGS. 30A-B and 31A-D. In this configuration, torque-limiting clutch 2934 comprises a mechanical torque-limiting clutch 2934, 2934B, which comprises a first set of one or more engagement elements 2948A (e.g., one or more springs), and a second set of one or more engagement elements 2948B (e.g., protrusions). The first set of the one or more engagement elements 2948A are coupled to either (a) to plunger support 2958, typically a radial outward surface of plunger support 2958, or (b) control knob 2938, typically a radially inward surface of control knob 2938. The second set of the one or more engagement elements 2948B are coupled to the other of the plunger support 2958 and control knob 2938. Optionally, some of the first engagement elements 2948A and some of the second engagement elements 2948B are coupled to plunger support 2958, some of the first engagement elements 2948A and some of the second engagement elements 2948B are coupled to control knob 2938.

The first and the seconds sets 2948A and 2948B typically comprise the same number of elements.

The first engagement elements 2948A and the second engagement elements 2948B mechanically engage one another so long as the applied torque is less than the threshold value; when the applied torque reaches the threshold value, the first engagement elements 2948A and the second engagement elements 2948B become disengaged from one another so as to allow the first engagement elements 2948 to rotate past the second engagement elements 2948B, and thereby allow control knob 2938 to rotate without causing corresponding rotation of plunger support 2958. For example, when the applied torque reaches the threshold value, springs 2948A may elastically deform so as to allow protrusions 2948B to rotate past springs 2948A.

In addition to the configurations described above with reference to FIGS. 28A-29D and 30A-31D, torque-limiting clutch 2934 may comprise any type of torque-limiting clutch known in the mechanical arts, such a ball detent clutch or a pawl and spring clutch.

Reference is made to FIGS. 28A-29D and 30A-31D. For some applications, sampling device 2920 further comprises waste liquid receptacle 1656, described hereinabove, and filter support 1662, also described hereinabove. Filtration assembly 2924 is configured such that movement of plunger head 2942 within tubular container 2930, when liquid specimen sample 22 is contained in tubular container 2930 and filter 60 is removably disposed on filter support 1662, pushes the at least a portion of liquid specimen sample 22 through filter 60 and the filtrate-passage openings 1668 and into waste liquid receptacle 1656.

Reference is still made to FIGS. 28A-29D and 30A-31D. For some applications, sampling device 2920 is implemented in combination with some or all of the features of sampling device 2120 described hereinabove with reference to FIGS. 6A-E, 7A-D, 8A-C, 9A-D, and/or 10A-E, mutatis mutandis. For example, container housing 2922 may be shaped so as to define cylindrical space 2023 within container housing 2922, and tubular container 2930 may be disposed at least partially within cylindrical space 2023 of container housing 2922, such that tubular container 2930 is rotatable with respect to cylindrical space 2023. Sampling device 2920 may be configured such that the rotation of plunger support 2958 with respect to container housing 2922, when the one or more second threads 2925B are engaged with the one or more first threads 2925A, distally advances plunger support 2958 with respect to container housing 2922 and thus plunger 2940 within tubular container 2930 as tubular container 2930 rotates with respect to container housing 2922.

Reference is still made to FIGS. 28A-29D and 30A-31D. For some applications, sampling device 2920 is implemented in combination with some or all of the features of sampling device 2320 described hereinabove with reference to FIGS. 18A-F, mutatis mutandis. For example, sampling device 2920 may comprise filter-withdrawal shaft 2372, which is disposed passing (a) through a distal opening 2396 defined by internal distal bottom surface 2398 of tubular container 2930 and (b) optionally, in configurations in which filtration assembly 2924 comprises hollow shaft 2376, through internal shaft space 2386.

Reference is made to FIGS. 6A-31D. Although the filtration assemblies shown and described with reference to these figures as comprising filter-collection receptacle 1650, the filtrations assemblies alternatively do not comprise filter-collection receptacle 1650, such as shown for filtrations assemblies 1724 and 2124 in FIGS. 5A-E and 6A-E, respectively.

For some applications, the techniques described herein are implemented in combination with kit 1000 and/or testing kit 1100, described in above-mentioned PCT Publication WO 2023/131948 with reference to FIG. 30 and FIG. 31 thereof, respectively, mutatis mutandis.

In an embodiment, the techniques and apparatus described herein are combined with techniques and apparatus described in one or more of the following patent applications, which are assigned to the assignee of the present application and are incorporated herein by reference:
US Patent Application Publication 2019/0381498 to Fruchter et al.;
U.S. Provisional Application 62/727,268, filed Sep. 5, 2018;
PCT Publication WO 2020/049566 to Fruchter et al.;
US Patent Application Publication 2021/0215585 to Fruchter et al.;
U.S. Provisional Application 62/988,145, filed Mar. 11, 2020;
U.S. Provisional Application 62/988,259, filed Mar. 11, 2020;
U.S. Provisional Applications 63/020,723, filed May 6, 2020; 63/037,707, filed Jun. 11, 2020; 63/067,535, filed Aug. 19, 2020; 63/117,294, filed Nov. 23, 2020; 63/156,843, filed Mar. 4, 2021; 63/158,005, filed Mar. 8, 2021; 63/166,378, filed Mar. 26, 2021; and 63/176,565, filed Apr. 19, 2021;
U.S. Provisional Application 63/071,529, filed Aug. 28, 2020;
PCT Publication WO 2021/044417 to Holtz et al.;
US Patent Application Publication 2021/0102876 to Fruchter et al.;
PCT Publication WO 2021/181338 to Fruchter et al., and US Patent Application Publication 2023/0098151 in the US national stage thereof;
PCT Publication WO 2021/181339 to Feldman et al., and US Patent Application Publication 2023/0096409 in the US national stage thereof;
PCT Publication WO 2021/224925 to Levitz et al., and U.S. application Ser. No. 17/921,672 in the national stage thereof;
PCT Publication WO 2022/044002 to Levitz et al., and U.S. application Ser. No. 18/023,607 in the national stage thereof;
U.S. Provisional Application 63/134,282, filed Jan. 6, 2021;
PCT Publication WO 2022/149135 to Feldman et al.;
U.S. Provisional Application 63/388,851, filed Jul. 13, 2022, and U.S. Provisional Application 63/432,231, filed Dec. 13, 2022;
US Patent Application Publication 2023/0061094 to Levitz et al.;
US Patent Application Publication 2023/0152192 to Feldman et al.;
PCT Publication WO 2023/095146 to Levitz et al;
PCT Publication WO 2023/131948 to Levitz et al., and U.S. application Ser. No. 18/763,483 in the national stage thereof;
PCT Publication WO 2024/013747 to Feldman et al.;
US Patent Application Publication 2023/0400459 to Levitz; and
U.S. Provisional Application 63/621,875, filed Jan. 17, 2024.

In an embodiment, the techniques and apparatus described herein are combined with techniques and apparatus described in PCT Publication WO 2022/149135 to Feldman et al., with reference to FIGS. 1A-35B thereof.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A sampling device for concentrating a liquid specimen sample, the sampling device comprising a filtration assembly, which comprises:
a tubular container, which is shaped so as to define an inner wall and a proximal container opening for receiving the liquid specimen sample;
a waste liquid receptacle;
a filter;
a filter support, which is shaped so as to define (a) a support surface on which the filter is removably disposed, and (b) a plurality of filtrate-passage openings through the filter support into the waste liquid receptacle;
an inflatable chamber, which comprises a flexible wall, wherein an interior of the inflatable chamber is shaped so as to define a space having an initial volume; and
a source of gas, configured to provide gas into the space defined by the interior of the inflatable chamber,
wherein the filtration assembly is configured such that providing of the gas into the space, when the liquid specimen sample is contained in the tubular container and the filter is disposed on the support surface, increases the initial volume to an inflated volume, so as to push at least a portion of the liquid specimen sample through the filter and the filtrate-passage openings and into the waste liquid receptacle.

2. The sampling device according to claim 1, wherein the source of gas comprises one or more substances that generate the gas.

3. The sampling device according to claim 1, wherein the source of gas comprises a compressed gas container containing the gas.

4. The sampling device according to claim 1, wherein the source of gas is configured to provide the gas upon manual activation of the source of gas.

5. The sampling device according to claim 4, wherein the filtration assembly comprises a user control, which is configured, upon actuation thereof, to manually activate the source of gas to provide the gas.

6. The sampling device according to claim 1, wherein the providing of the gas into the space expands the inflatable chamber toward the filter.

7. The sampling device according to claim 6, wherein the providing of the gas into the space expands the inflatable chamber into contact with the filter.

8. The sampling device according to claim 6, wherein the inflatable chamber, when the space has the initial volume, is disposed away from the filter.

9. The sampling device according to claim 1, wherein the providing of the gas into the space increases an area of contact between the inflatable chamber and the filter.

10. The sampling device according to any one of claims 1-9,
wherein an internal distal bottom surface of the tubular container comprises the filter support, and
wherein the providing of the gas into the space expands the inflatable chamber when the inflatable chamber is disposed at least partially in the tubular container.

11. The sampling device according to claim 10,
wherein the filtration assembly further comprises a proximal cap, which is configured to sealably close the proximal container opening, and
wherein the inflatable chamber is coupled to the proximal cap, such that the inflatable chamber is disposed at least partially in the tubular container when the proximal cap sealably closes the proximal container opening.

12. The sampling device according to any one of claims 1-9,
wherein the filtration assembly further comprises a proximal cap, which is configured to sealably close the proximal container opening,
wherein the proximal cap is shaped so as to define the waste liquid receptacle within the proximal cap,
wherein the proximal cap comprises the filter support, and
wherein the inflatable chamber is disposed at least partially in the tubular container.

13. The sampling device according to any one of claims 1-9,
wherein the filtration assembly further comprises a plunger, which (i) comprises a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container,
wherein the plunger rod is shaped so as to define the waste liquid receptacle within the plunger rod,
wherein the plunger head comprises the filter support,
wherein the sampling device further comprises a container housing,
wherein the tubular container is disposed at least partially within the container housing, such that the tubular container is moveable with respect to the container housing,
wherein the inflatable chamber is disposed between (a) a proximally-facing internal surface of the container housing and (b) an external surface of the tubular container that is defined by a distal end of the tubular container, and
wherein the filtration assembly is configured such that the providing of the gas into the space increases the initial volume to the inflated volume, thereby proximally moving the tubular container with respect to the plunger head, thereby pushing the at least a portion of the liquid specimen sample through the filter and the filtrate-passage openings and into the waste liquid receptacle.

14. The sampling device according to any one of claims 1-9, wherein the filtration assembly comprises one or more sharp surfaces, which are positioned to puncture the inflatable chamber upon the space increasing to the inflated volume.

15. The sampling device according to any one of claims 1-9, wherein the filtration assembly further comprises a pressure-responsive valve that is configured to limit a pressure within the space.

16. The sampling device according to claim 15, wherein the pressure-responsive valve is configured to limit the pressure in the space by blocking flow of the gas into the space responsively to the pressure in the space.

17. The sampling device according to claim 16,
wherein the filtration assembly is shaped so as to define a gas-release regulation chamber, which is in fluid communication with the space only by one or more openings,
wherein the source of gas is disposed in fluid communication with the gas-release regulation chamber, and
wherein the pressure-responsive valve is configured to block the flow of the gas into the space by blocking the one or more openings.

18. The sampling device according to claim 16,
wherein the source of gas comprises a compressed gas container containing the gas and defining an opening in fluid communication with the space, and
wherein the pressure-responsive valve is configured to block the flow of the gas into the space by blocking the opening.

19. The sampling device according to claim 15, wherein the pressure-responsive valve comprises a pressure relief valve, which is configured to release a portion of the gas from the space when the pressure within the space exceeds a threshold pressure.

20. The sampling device according to claim 19, wherein the pressure relief valve is located so as to release the portion of the gas from the space to the atmosphere outside the filtration assembly when the pressure within the space exceeds the threshold pressure.

21. A method for concentrating a liquid specimen sample, the method comprising:
placing, via a proximal container opening, the liquid specimen sample in a tubular container of a filtration assembly of a sampling device, wherein the filtration assembly further comprises an inflatable chamber, which comprises a flexible wall, wherein an interior of the inflatable chamber is shaped so as to define a space having an initial volume and
causing a source of gas of the filtration assembly to provide gas into the space defined by the interior of the inflatable chamber, so as to increase the initial volume to an inflated volume, so as to push at least a portion of the liquid specimen sample through a filter removably disposed in the tubular container on a support surface of a filter support, wherein the filter support is shaped so as to define a plurality of filtrate-passage openings through the filter support into a waste liquid receptacle of the filtration assembly.

22. The method according to claim 21, wherein the source of gas comprises one or more substances that generate the gas.

23. The method according to claim 21, wherein the source of gas comprises a compressed gas container containing the gas.

24. The method according to claim 21, wherein causing the source of gas to provide the gas comprises manually activating the source of gas.

25. The method according to claim 24, wherein the filtration assembly comprises a user control, and wherein manually activating the source of gas comprises actuating the user control.

26. The method according to claim 21, wherein causing the source of gas to provide the gas into the space expands the inflatable chamber toward the filter.

27. The method according to claim 26, wherein causing the source of gas to provide the gas into the space expands the inflatable chamber into contact with the filter.

28. The method according to claim 26, wherein the inflatable chamber, when the space has the initial volume, is disposed away from the filter.

29. The method according to claim 21, wherein causing the source of gas to provide the gas into the space increases an area of contact between the inflatable chamber and the filter.

30. The method according to any one of claims 21-29,
wherein an internal distal bottom surface of the tubular container comprises the filter support, and
wherein causing the source of gas to provide the gas into the space comprises disposing the inflatable chamber at least partially in the tubular container.

31. The method according to claim 30,
wherein the inflatable chamber is coupled to a proximal cap of the filtration assembly, and
wherein the method further comprises sealably closing the proximal container opening with the proximal cap, such that the inflatable chamber is disposed at least partially in the tubular container.

32. The method according to any one of claims 21-29,
further comprising sealably closing the proximal container opening with a proximal cap of the filtration assembly,
wherein the proximal cap is shaped so as to define the waste liquid receptacle within the proximal cap,
wherein the proximal cap comprises the filter support, and
wherein the inflatable chamber is disposed at least partially in the tubular container.

33. The method according to any one of claims 21-29,
further comprising inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further comprises a plunger rod, which (a) has a distal end portion to which the plunger head is coupled, and (b) is shaped so as to define the waste liquid receptacle within the plunger rod,
wherein the plunger head comprises the filter support,
wherein the sampling device further comprises a container housing,
wherein the tubular container is disposed at least partially within the container housing, such that the tubular container is moveable with respect to the container housing,
wherein the inflatable chamber is disposed between (a) a proximally-facing internal surface of the container housing and (b) an external surface of the tubular container that is defined by a distal end of the tubular container, and
wherein causing the source of gas to provide the gas into the space increases the initial volume to the inflated volume, thereby proximally moving the tubular container with respect to the plunger head, thereby pushing the at least a portion of the liquid specimen sample through the filter and the filtrate-passage openings and into the waste liquid receptacle.

34. The method according to any one of claims 21-29, wherein the filtration assembly comprises one or more sharp surfaces, which are positioned to puncture the inflatable chamber upon the space increasing to the inflated volume.

35. The method according to any one of claims 21-29, wherein the filtration assembly further comprises a pressure-responsive valve that is configured to limit a pressure within the space.

36. The method according to claim 35, wherein the pressure-responsive valve is configured to limit the pressure in the space by blocking flow of the gas into the space responsively to the pressure in the space.

37. The method according to claim 36,
wherein the filtration assembly is shaped so as to define a gas-release regulation chamber, which is in fluid communication with the space only by one or more openings,
wherein the source of gas is disposed in fluid communication with the gas-release regulation chamber, and
wherein the pressure-responsive valve is configured to block the flow of the gas into the space by blocking the one or more openings.

38. The method according to claim 36,
wherein the source of gas comprises a compressed gas container containing the gas and defining an opening in fluid communication with the space, and
wherein the pressure-responsive valve is configured to block the flow of the gas into the space by blocking the opening.

39. The method according to claim 35, wherein the pressure-responsive valve comprises a pressure relief valve, which is configured to release a portion of the gas from the space when the pressure within the space exceeds a threshold pressure.

40. The method according to claim 39, wherein the pressure relief valve is located so as to release the portion of the gas from the space to the atmosphere outside the filtration assembly when the pressure within the space exceeds the threshold pressure.

41. The method according to any one of claims 21-29, further comprising, after the filter has been removed from the tubular container, detecting the presence of a biological particulate trapped by the filter.

42. The method according to claim 41, wherein detecting the presence of the biological particulate trapped by the filter comprising using a lateral flow test strip to detect the presence of the biological particulate trapped by the filter.

43. The method according to claim 41, wherein the biological particulate is selected from the group consisting of: a virus, a bacterium, a microorganism, a fungus, a spore, a mite, a biological cell, a biological antigen, a protein, a protein antigen, and a carbohydrate antigen.

44. The method according to any one of claims 21-29, wherein the liquid specimen sample includes gargled fluid.

45. A sampling device for concentrating a liquid specimen sample, the sampling device comprising a filtration assembly, which comprises:
a tubular container, which is shaped so as to define an inner wall and a proximal container opening for receiving the liquid specimen sample;
a plunger, which (i) comprises a plunger head and a plunger rod, which has a distal end portion to which the plunger head is coupled, and (ii) is insertable into the tubular container via the proximal container opening, such that a lateral surface of the plunger head forms a fluid-tight movable seal with the inner wall of the tubular container;
a waste liquid receptacle;
a filter;
a filter support, which is shaped so as to define (a) a support surface on which the filter is removably disposed, and (b) a plurality of filtrate-passage openings through the filter support into the waste liquid receptacle;
a container housing; and
a plunger support, which is (a) coupled to a proximal portion of the plunger, and (b) hingedly attached to the container, so as to enable a change in orientation between a central longitudinal axis of the plunger and a central longitudinal axis of the container housing,
wherein the plunger, the plunger support, and the container housing are arranged such that the change in orientation transitions the proximal container opening from an open position to a closed position, in which the plunger head covers the proximal container opening.

46. The sampling device according to claim 45,
wherein the plunger rod is shaped so as to define the waste liquid receptacle within the plunger rod, and
wherein the plunger head comprises the filter support.

47. The sampling device according to claim 46,
wherein the tubular container is disposed at least partially within the container housing, such that the tubular container is moveable with respect to the container housing, and
wherein the filtration assembly is configured such that the tubular container is proximally moveable with respect to the plunger head, thereby pushing at least a portion of the liquid specimen sample through the filter and the filtrate-passage openings and into the waste liquid receptacle.

48. The sampling device according to claim 47,
wherein the sampling device further comprises a source of gas, which is configured to provide gas into a space by releasing or generating the gas, the space defined between (a) a proximally-facing internal surface of the container housing and (b) an external surface of the tubular container that is defined by a distal end of the tubular container, and
wherein the filtration assembly is configured such that providing the gas into the space increases pressure in the space, thereby proximally moving the tubular container with respect to the plunger head.

49. The sampling device according to claim 45, wherein an internal distal bottom surface of the tubular container comprises the filter support.

50. The sampling device according to claim 49,
wherein the container housing comprises the tubular container, and
wherein the plunger comprises a plunger tube, in which the plunger rod is at least partially disposed so as to be axially moveable with respect to the plunger tube.

51. A method for concentrating a liquid specimen sample, the method comprising:
placing, via a proximal container opening while the proximal container opening is in an open position, the liquid specimen sample in a tubular container of a filtration assembly of a sampling device, wherein the sampling device further includes (i) a container housing, (ii) a waste liquid receptacle, (iii) a filter, and (iv) a filter support, which is shaped so as to define (a) a support surface on which the filter is removably disposed, and (b) a plurality of filtrate-passage openings through the filter support into the waste liquid receptacle;
thereafter, transitioning the proximal container opening from the open position to a closed position, in which a plunger head of a plunger of the filtration assembly covers the proximal container opening and a lateral surface of the plunger head forms a fluid-tight movable seal with an inner wall of the tubular container, wherein the plunger further comprises a plunger rod, which has a distal end portion to which the plunger head is coupled; and
pushing at least a portion of the liquid specimen sample through the filter and the filtrate-passage openings and into the waste liquid receptacle,
wherein transitioning comprises changing an orientation between a central longitudinal axis of the plunger and a central longitudinal axis of the container housing by moving a plunger support, which is (a) coupled to a proximal portion of the plunger, and (b) hingedly attached to the container so as to enable the change in the orientation.

52. The method according to claim 51,
wherein the plunger rod is shaped so as to define the waste liquid receptacle within the plunger rod, and
wherein the plunger head comprises the filter support.

53. The method according to claim 52,
wherein the tubular container is disposed at least partially within the container housing, such that the tubular container is moveable with respect to the container housing, and
wherein pushing at least a portion of the liquid specimen sample through the filter comprises proximally moving the tubular container with respect to the plunger head.

54. The method according to claim 53,
wherein the sampling device further comprises a source of gas, which is configured to provide gas into a space by releasing or generating the gas, the space defined between (a) a proximally-facing internal surface of the container housing and (b) an external surface of the tubular container that is defined by a distal end of the tubular container, and
wherein proximally moving the tubular container with respect to the plunger head comprises causing the source of gas to provide the gas into the space to as to increases pressure in the space.

55. The method according to claim 51, wherein an internal distal bottom surface of the tubular container comprises the filter support.

56. The method according to claim 55,
wherein the container housing comprises the tubular container, and
wherein the plunger comprises a plunger tube, in which the plunger rod is at least partially disposed so as to be axially moveable with respect to the plunger tube.

57. A sampling device for concentrating a liquid specimen sample, the sampling device comprising a filtration assembly, which comprises:
a container housing, which (a) is shaped so as to define one or more first threads, and (b) comprises a tubular container, which is shaped so as to define an inner wall and a proximal container opening for receiving the liquid specimen sample;
a plunger support, which is shaped so as to define one or more second threads, shaped so as to engage the one or more first threads;
a plunger, which (a) comprises a plunger head, (b) is insertable into the tubular container via the proximal container opening, such that a lateral surface of the plunger head forms a fluid-tight movable seal with the inner wall, and (c) is coupled to the plunger support, such that rotation of the plunger support with respect to the container housing, when the one or more second threads are engaged with the one or more first threads, distally advances the plunger support with respect to the container housing and thus the plunger within the tubular container;
a filter, wherein the filtration assembly is configured such that movement of the plunger head within the tubular container, when the liquid specimen sample is contained in the tubular container and the filter is disposed in the tubular container, pushes at least a portion of the liquid specimen sample through the filter;
a torque-limiting clutch; and
a control knob, which is rotatable about a central axis of the plunger, and which is coupled to the plunger support by the torque-limiting clutch, such that rotation of the control knob by application of:
a torque less than a threshold value rotates the plunger support, thereby rotating the plunger support with respect to the container housing, and
a torque equal to the threshold value causes the control knob to slip with respect to the plunger support.

58. The sampling device according to claim 57, wherein the torque-limiting clutch comprises:
a first set of one or more magnets, which are coupled to the plunger support; and
a second set of one or more magnets, which are coupled to the control knob.

59. The sampling device according to claim 57, wherein the torque-limiting clutch comprises:
a first set of one or more engagement elements, which are coupled to the plunger support; and
a second set of one or more engagement elements, which are coupled to the control knob.

60. The sampling device according to claim 59, wherein either:
the engagement members of the first set comprise springs, and the engagement members of the second set comprise protrusions, or
the engagement members of the first set comprise protrusions, and the engagement members of the second set comprise springs.

61. The sampling device according to claim 57, wherein at least a first axial portion of the control knob surrounds at least a second axial portion of the plunger support.

62. The sampling device according to claim 57, wherein the one or more first threads of the container housing face radially outward, away from a central axis of the plunger, and the one or more second threads of the plunger support face radially inward, toward the central axis of the plunger.

63. The sampling device according to claim 57,
wherein the container housing is shaped so as to define a cylindrical space within the container housing, and the tubular container is disposed at least partially within the cylindrical space of the container housing, such that the tubular container is rotatable with respect to the cylindrical space, and
wherein the sampling device is configured such that the rotation of the plunger support with respect to the container housing, when the one or more second threads are engaged with the one or more first threads, distally advances the plunger support with respect to the container housing and thus the plunger within the tubular container as the tubular container rotates with respect to the container housing.

64. The sampling device according to claim 57,
wherein the sampling device further comprises:
a waste liquid receptacle; and
a filter support, which is shaped so as to define (a) a support surface on which the filter is removably disposed, and (b) a plurality of filtrate-passage openings through the filter support into the waste liquid receptacle, and
wherein the filtration assembly is configured such that movement of the plunger head within the tubular container, when the liquid specimen sample is contained in the tubular container and the filter is removably disposed on the filter support, pushes the at least a portion of the liquid specimen sample through the filter and the filtrate-passage openings and into the waste liquid receptacle.

65. A method for concentrating a liquid specimen sample, the method comprising:
placing, via a proximal container opening, the liquid specimen sample in a tubular container of a container housing of a filtration assembly of a sampling device, wherein the container housing is shaped so as to define one or more first threads;
inserting a plunger head of a plunger of the filtration assembly into the tubular container via the proximal container opening of the tubular container, such that a lateral surface of the plunger head forms a fluid-tight movable seal with an inner wall of the tubular container, wherein the plunger further comprises a plunger rod, which has a distal end portion to which the plunger head is coupled;
engaging the one or more first threads with one or more second threads defined by a plunger support coupled to the plunger; and
rotating, about a central axis of the plunger, a control knob that is coupled to the plunger support by a torque-limiting clutch, such that rotation of the control knob by application of:
a torque less than a threshold value rotates the plunger support, thereby rotating the plunger support with respect to the container housing and advancing the plunger support with respect to the container housing and thus the plunger within the tubular container, so as to push at least a portion of the liquid specimen sample through a filter disposed in the tubular container, and
a torque equal to the threshold value causes the control knob to slip with respect to the plunger support.

66. The method according to claim 65, wherein the torque-limiting clutch comprises:
a first set of one or more magnets, which are coupled to the plunger support; and
a second set of one or more magnets, which are coupled to the control knob.

67. The method according to claim 65, wherein the torque-limiting clutch comprises:
a first set of one or more engagement elements, which are coupled to the plunger support; and
a second set of one or more engagement elements, which are coupled to the control knob.

68. The method according to claim 67, wherein either:
the engagement members of the first set comprise springs, and the engagement members of the second set comprise protrusions, or
the engagement members of the first set comprise protrusions, and the engagement members of the second set comprise springs.

69. The method according to claim 65, wherein at least a first axial portion of the control knob surrounds at least a second axial portion of the plunger support.

70. The method according to claim 65, wherein the one or more first threads of the container housing face radially outward, away from a central axis of the plunger, and the one or more second threads of the plunger support face radially inward, toward the central axis of the plunger.

71. The method according to claim 65,
wherein the container housing is shaped so as to define a cylindrical space within the container housing, and the tubular container is disposed at least partially within the cylindrical space of the container housing, such that the tubular container is rotatable with respect to the cylindrical space, and
wherein rotating the control knob by application of the torque less than the threshold value rotates the plunger support, thereby rotating the plunger support with respect to the container housing and advancing the plunger support with respect to the container housing and thus the plunger within the tubular container as the tubular container rotates with respect to the container housing, so as to push the at least a portion of the liquid specimen sample through the filter.

72. The method according to claim 65,
wherein the sampling device further comprises (i) a waste liquid receptacle and (ii) a filter support, which is shaped so as to define (a) a support surface on which the filter is removably disposed, and (b) a plurality of filtrate-passage openings through the filter support into the waste liquid receptacle, and
wherein rotating the control knob by application of the torque less than the threshold value rotates the plunger support, thereby rotating the plunger support with respect to the container housing and advancing the plunger support with respect to the container housing and thus the plunger within the tubular container, so as to push the at least a portion of the liquid specimen sample through the filter and the filtrate-passage openings and into the waste liquid receptacle.
